(19) United States
(12) Patent Application Publication
(10) Pub. No.: US 2011/0061045 A1
(43) Pub. Date: Mar. 10, 2011

(54) Operating Systems in a Layerd Virtual Workspace

(75) Inventor: Robert Phillips, Westford, MA (US)

(73) Assignee: VIRTUAL COMPUTER, INC., Westford, MA (US)

(21) Appl. No.: 12/944,300

(22) Filed: Nov. 11, 2010

Related U.S. Application Data
(63) Continuation of application No. 12/858,059, filed on Aug. 17, 2010.
Application No. 12/858,059 is a continuation-in-part of application No. 12/338,452, filed on Dec. 18, 2008.
Application No. 12/338,452 is a continuation-in-part of application No. 12/604,704, filed on Oct. 23, 2009.
Application No. 12/604,704 is a continuation-in-part of application No. 12/603,669, filed on Oct. 22, 2009.
Application No. 12/603,669 is a continuation-in-part of application No. 12/582,297, filed on Oct. 20, 2009.
Application No. 12/582,297 is a continuation-in-part of application No. 12/582,364, filed on Oct. 20, 2009.
Application No. 12/582,364 is a continuation-in-part of application No. 12/604,662, filed on Oct. 23, 2009.
Application No. 12/604,662 is a continuation-in-part of application No. 12/435,625, filed on May 5, 2009.
Application No. 12/435,625 is a continuation-in-part of application No. 12/435,685, filed on May 5, 2009.
Application No. 12/435,685 is a continuation of application No. 12/435,775, filed on May 5, 2009.
(60) Provisional application No. 61/234,447, filed on Aug. 17, 2009.
(60) Provisional application No. 61/015,281, filed on Dec. 20, 2007.

(30) Foreign Application Priority Data
Dec. 18, 2008 (EP) 08868119.2
Dec. 18, 2008 (WO) PCTUS2008087469

(51) Int. Cl. G06F 9/44; G06F 9/455

(52) U.S. Cl. 717/173; 718/1

(57) ABSTRACT

A virtual workspace can include an active instance of a layered virtual file system namespace. A layered virtual file system namespace is referred to by the virtual workspace and includes a collection of system data (e.g. layered virtual file system base layer), user data (e.g. layered virtual file system user layer), and virtualized applications (e.g. virtual app layer), metadata and policies (e.g. layered virtual file system layer scope). Because a virtual workspace can include software such as an operating system and one or more applications in addition to user data, a virtual workspace can be aligned with a namespace so that an operating system of the virtual workspace may be located at a “base layer”, one or more applications executing on the operating system may be located at an upper “virtual app” layer, and user data in a virtual workspace may be found at any layer at or above the user layer.

### CROSS-REFERENCE TO RELATED APPLICATIONS

This application is a continuation of U.S. patent application Ser. No. 12/858,059, filed Aug. 17, 2010 which claims the benefit of U.S. Provisional Application Ser. No. 61/234,447, filed Aug. 17, 2009 each of which is hereby incorporated by reference in its entirety.

This application is a continuation-in-part of the following U.S. patent applications, each of which is incorporated by reference in its entirety: U.S. patent application Ser. No. 12/338,452, filed Dec. 18, 2008; U.S. patent application Ser. No. 12/604,704; filed Oct. 23, 2009; U.S. patent application Ser. No. 12/603,669, Oct. 22, 2009; U.S. patent application Ser. No. 12/582,297, filed Oct. 20, 2009; U.S. patent application Ser. No. 12/582,364, filed Oct. 20, 2009; U.S. patent application Ser. No. 12/604,662, filed Oct. 23, 2009; U.S. patent application Ser. No. 12/435,625, filed May 5, 2009; U.S. patent application Ser. No. 12/435,685, filed May 5, 2009; U.S. patent application Ser. No. 12/435,775, filed May 5, 2009. Each of forgoing claims the benefit of U.S. Provisional Patent Application Ser. No. 61/015,281, filed Dec. 20, 2007.

This application claims the benefit of the following International Application No. PCT/US2008/087469, filed Dec. 18, 2008 and European Patent Application No. 08868119.2, filed Dec. 18, 2008 which is incorporated by reference herein in its entirety.

### BACKGROUND OF THE INVENTION

1. Field of the Invention

This patent application relates to the field of computing and more particularly to the field of virtualized computing management.

2. Description of Related Art

Personal computers run instances of operating systems within which instances of applications execute. In some personal computers, virtualization facilities enable substantially concurrent yet isolated operation of a plurality of operating systems, each of which runs on a virtual machine. The virtualization facilities can include virtualization software, hardware-based virtualization, a combination of the foregoing, and so on.

Tasks like managing and updating the operating systems and applications necessarily occur at each of the personal computers. Updating occurs via software updates that are distributed and applied to each of the personal computers. Managing is performed by users/administrators who configure security settings or other preferences at each of the personal computers.

As a result of the distributed nature of managing and updating operating systems and applications, software conflicts or configuration errors also occur in a distributed fashion.

There remains a need for systems and methods that employ centrally managed and centrally updated virtual machine images that are distributed to and executed on personal computers.

### SUMMARY OF THE INVENTION

Embodiments of the present invention contain systems and methods that employ centrally managed and centrally updated virtual machine images that are distributed to and executed on personal computers.

In an aspect of the invention, a method of providing a virtualized workspace for a computing facility may include configuring a physical workspace of the computing facility into a plurality of virtual layers, wherein the plurality of virtual layers include at least one of a base layer and a user layer, and where the base layer is configured as the bottom most layer of the plurality of virtual layers. The aspect may also include providing each of the plurality of virtual layers with its own file system hierarchy. The aspect may also further include overlaying the file system hierarchy of each of the plurality of virtual layers such that a file system hierarchy in a first virtual layer is configured above a file system hierarchy in a second virtual layer and has priority. The aspect may furthermore include merging the plurality of virtual layers to provide a merged view file system to a user of the computing facility such that the presence of the plurality of virtual layers and overlaid prioritized file system hierarchy is transparent to the user.

This aspect may also further include enabling the creation of additional virtual layers.

In the aspect, the creation of additional virtual layers is provided by the user. Alternatively, the creation of additional virtual layers is provided by an administrator. In the aspect, the additional virtual layer is a virtual application layer. In the aspect, the virtual file system improves lifecycle management for the computer facility. In the aspect, the physical workspace is a data storage facility of the computing facility.

In an aspect of the invention, the base layer includes an operating system for the computing facility. In the aspect, the base layer includes applications installed by an administrator. In the aspect, the base layer includes utilities installed by an administrator.

In another aspect of the invention, the user layer includes documents installed by the user. In the aspect, the user layer includes settings installed by the user. In the aspect, the user layer includes applications installed by a user that the user determines to be a part of the user layer. In the aspect, the user layer includes customizations installed by the user that the user determines to be a part of the user layer.

In yet another aspect, a virtual layer is subsequently merged with another virtual layer. In the aspect, a virtual layer is frozen. In the aspect, a virtual layer is assigned a global unique identifier (GUID). In the aspect, the system hierarchy of a virtual layer includes changes to a file that exists in a lower virtual layer. In the aspect, the file system hierarchy includes a hierarchy of keys and values. In the aspect, priority allows for files in the first virtual layer to have priority over files with the same path name in the second virtual layer. In the aspect, priority applies from the top most virtual layer down through to the base layer.

In an aspect of the invention, the creation of an addition virtual layer is to partition the contents of the additional virtual layer from existing virtual layers. In one aspect, the partitioning protects the existing virtual layers from the additional virtual layer. In another aspect, the partitioning improves the ease with which the contents of the additional virtual layer are deleted.

In the aspect, the partitioning packages the contents of the additional virtual layer.

In an aspect of the invention, the virtual application layer is created when the application is installed on the computing facility. In the aspect, the virtual application layer is subsequently merged into an existing virtual layer.

In an aspect of the invention, a virtual layer has a scope that bounds how the virtual layer can be modified. In this aspect, the bound is file space. In one aspect, the bound is name space. In another aspect, the bound is the ability to add folders. In yet another aspect, the scope is frozen.

In an aspect of the invention, the system hierarchy of a virtual layer includes at least one file. In the aspect, deleting a file results in the file being deleted when the file data that is visible in the merged view resides in the virtual layer. In the aspect, a file is logically deleted when the file exists within the virtualized workspace but is not visible to the user in the merged view. In the aspect, a file is obscured such that the user cannot see a file in a lower layer if there is a deleted file with the same name in a higher layer.

In another aspect of the invention, a method for updating an operating system of a client computer may include installing a computer operating system into a new base layer that is suitable for use as a base layer in a layered virtual file system and storing the new base layer in a memory accessible to a data management server. The aspect may also include transmitting the new base layer from the data management server to a client computer to be stored in a memory accessible to the client computer. The aspect may also further include directing an instance of the layered virtual file system that is resident on the client computer to use the new base layer.

In the aspect, directing includes logically positioning the new base layer above an existing base layer of the instance of the layered virtual file system. Alternatively, directing includes replacing references to an existing base layer in the layered virtual file system with references to the new base layer. In the aspect, transmitting includes transmitting an instance of the layered virtual file system from the server to the client. The aspect may also further include creating a check point associated with the instance of the layered virtual file system that facilitates restoring an existing base layer.

In yet another aspect of the invention, a method of providing access to files in a virtual file system for a computing facility may include providing each of a plurality of virtual layers with its own file system hierarchy, wherein the file system hierarchy of a first virtual layer has priority over the file system hierarchy of a second virtual layer. The aspect may also include merging the plurality of virtual layers to provide access to files in a merged-view that contains a file system hierarchy that comprises files from each of the plurality of virtual layers based on the priority of each of the plurality of virtual layers.

In the aspect, only one of identically named files in each of the first and second virtual layers will be accessible in the merged view. In an aspect of the invention, the only one of the identically named files is stored in the file system hierarchy of the first virtual layer. In the aspect, the identically named file stored in the file system hierarchy of the second virtual layer is obscured from the merged view.

In still another aspect of the invention, the presence of the plurality of virtual layers and prioritized file system hierarchies is transparent to the user.

In still yet another aspect of the invention, method for deploying a virtualized operating system for use by a plurality of users may include providing a base layer of a layered virtual file system that facilitates access to an operating system. The aspect may also include storing the base layer in a memory accessible to a central data management server. The aspect may also further include receiving a request to provide a virtualized workspace on any one of a plurality of client computing facilities. The aspect may furthermore include deploying the base layer from the server to the one of the plurality of client computing facilities for use as a bottom most layer in a layered virtual file system that comprises a plurality of virtual layers in the virtualized workspace. The aspect may also include providing a merged view of the plurality of layers in the virtualized workspace for accessing the operating system in the deployed base layer.

In still another aspect of the invention, a method for configuring an instance of virtual file system on a client computer may include receiving at a central data management server a virtual file system request that includes a namespace identifier. The aspect may also include accessing user data in a data repository, the user data associated with one or more layers of a layered virtual file system that is identified by the namespace identifier. The aspect may also further include transmitting at least a portion of the user data and virtual file system layer information associated with the portion to the client computer for configuring an instance of the one or more layers of the virtual file system on the client computer.

In still yet another aspect of the invention, a method of software application installation in a virtual workspace may include providing an instance of a virtual workspace comprising a layered virtual file system comprising a plurality of virtual layers, wherein the plurality of virtual layers include at least one of a base layer and a user layer, and where the base layer is configured as the bottom most layer of the plurality of virtual layers on a computing facility. The aspect may also include installing a software application through the virtualized workspace into a dedicated virtual application layer of the layered virtual file system, wherein the dedicated virtual application layer contains user and system data required to configure and execute the software application. The aspect may also further include configuring the dedicated virtual application layer as the top most layer of the plurality of virtual layers thereby facilitating software application access to data in the user layer and the base layer, wherein the dedicated virtual application layer can be removed from the instance of the virtual workspace without affecting data in the user layer and the base layer.

In this aspect, the layered virtual file system is deployed from a central data management server over a network to a client computer.

In still another aspect of the invention, a method of managing changes to operating system data in an instance of a virtual workspace may include providing a layered virtual file system comprising a plurality of virtual layers that include at least one of a base layer and a user layer, and where the base layer is configured as the bottom most layer of the plurality of virtual layers. The aspect may also include providing each of the plurality of virtual layers with its own file system hierarchy, wherein the file system hierarchy of the plurality of virtual layers is transparently overlaid such that a file system hierarchy in the user layer is configured above the base layer and has priority. The aspect may also further include configuring the operating system and associated data in the file system hierarchy of the base layer. The aspect may furthermore include recording changes to operating system data in the file system hierarchy of the user layer, wherein the changed operating system data is visible in a merged view of the user layer and base layer file system hierarchies yet the base layer file system hierarchy data is unchanged.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The invention and the following detailed description of certain embodiments thereof may be understood by reference to the following figures:

FIG. 1 depicts virtual workspaces management architecture.

FIG. 2 depicts a virtual workspace specification.

FIG. 3 depicts a user interface of a workspaces execution engine.

FIG. 4 depicts a user interface of a workspaces execution engine.

FIG. 5 depicts data volumes and a trusted boot sequence.

FIG. 6 depicts a set of platform configuration registers.

FIG. 7 depicts a key hierarchy.

FIG. 8 depicts workspace execution engine architecture.

FIG. 9 depicts a method of providing a virtualized workspace.

FIG. 10 depicts a method of delivering a virtualized workspace.

FIG. 11 depicts a method of providing security for virtualized workspaces.

FIG. 12 depicts a method of embodying a virtualized workspace.

FIG. 13 depicts a method of embodying a virtualized workspace.

FIG. 14 depicts a method of providing a virtualized workspace.

FIG. 15 depicts a method of providing a virtualized workspace.

FIG. 16 depicts a method of providing a virtualized workspace.

FIG. 17 depicts a method of updating a plurality of virtualized workspaces.

FIG. 18 depicts a method of providing a virtualized workspace.

FIG. 19 depicts a method of updating a virtualized workspace.

FIG. 20 depicts a method of delivering a virtualized workspace.

FIG. 21 depicts a method of providing a virtualized workspace.

FIG. 22 depicts a method of personalizing a master root disk image.

FIG. 23 depicts a system that provides a virtualized workspace.

FIG. 24 depicts components of a virtual workspace within a computing facility.

FIG. 25 depicts a method of providing a virtual workspace.

FIGS. 26A through 26C depict merged views of folders and files in an inventive virtual file system.

FIG. 27 depicts layers of the inventive virtual file system.

FIG. 28 depicts a base layer of the inventive virtual file system.

FIG. 29 depicts a user layer of the inventive virtual file system.

FIG. 30 depicts an initial condition of a data management server and a client.

FIG. 31 depicts a client-based instance of the inventive virtual file system.

FIG. 32 depicts a result of changes to the virtual file system instance of FIG. 31 applied to a data management server.

FIG. 33 depicts an embodiment of layers of the inventive virtual file system within a namespace corresponding to a computing facility.

FIG. 34 depicts exemplary storage of different virtual file system layers in one or more data storage units.

FIG. 35 depicts a client-server interaction for synchronizing instances of a virtual machine on multiple computing facilities.

FIG. 36 depicts interaction between a client and a Virtual Desktop Interface (VDI) connection broker.

FIG. 37 depicts a VDI connection broker and a server enabling configuration of a local virtual machine on a computing facility.

FIG. 38 depicts an update routine of user metadata on a server for maintaining synchronization.

### DETAILED DESCRIPTION OF THE INVENTION

A layered virtual file system may operate cooperatively with virtualization. A virtual workspace may be an active instance of a layered virtual file system namespace. A virtual workspace may invoke a namespace upon activation of the virtual workspace. A namespace may be referred to by the virtual workspace and may include a collection of system data (e.g. layered virtual file system base layer), user data (e.g. layered virtual file system user layer), and virtualized applications (e.g. virtual app layer), metadata and policies (e.g. layered virtual file system layer scope). Because a virtual workspace can include software such as an operating system and one or more applications in addition to user data, a virtual workspace may be aligned with a namespace so that an operating system of the virtual workspace may be located at a “base layer”, one or more applications executing on the operating system may be located at an upper “virtual app” layer, and user data in a virtual workspace may be found at any layer at or above the user layer. Alternative relationships among virtual workspaces, operating systems, applications, user data, and a layered virtual file system file system elements (e.g. base layer, user layer, virtual app layer, unmanaged data, a Workspace Execution Engine and the like) can be appreciated and are included herein.

The layered virtual file system may manage access to a base layer data to ensure proper use of the data in the base layer. In a way that may be similar to how a hypervisor may manage access to underlying computing facility resources such as hardware to ensure proper operation of the hardware by users and applications in a plurality of virtual workspaces, the base layer may be virtualized across a plurality of namespaces and virtual layers.

The base layer may be pertinent to the proper interoperation of the user layers and virtual application layers so protecting it via the policies of a layered virtual file system may ensure that changes made by a user or application do not affect any other namespace.

Alternatively, the layered virtual file system may work cooperatively with virtual workspaces in many different ways. A virtual workspace may be an embodiment of a virtual application layer, a user layer, a base layer, and the like. A virtual workspace may exist for each of the base, user, and each virtual layer. Each virtual workspace may use the layered virtual file system to resolve access to data so that virtual workspaces that are aligned within a namespace access data according to certain layered virtual file system rules and policies. At least in this way, a layered virtual file system may allow virtual workspaces to share data.

Although a layered virtual file system may include unmanaged namespaces, a hypervisor may manage these namespaces or portions thereof, such as paging files, registry hives, layered virtual file system metadata and control information, and the like. Alternatively, a hypervisor may provide a virtual workspace in which an instance of the layered virtual file system may operate.

An instance of a layered virtual file system may be associated with an instance of a virtual operating system as described herein to provide file and registry management and access for the various users and applications executing within the virtual operating system. In this way, a namespace may be associated with each user of the operating system, with each application that starts automatically when the operating system starts, print drivers, communication drivers, and the like.

Embodiments deliver an operating system and software applications to a personal computer. The operating system and software applications may be managed and configured at a central location prior to delivery. User data or a system disk image that is created or modified on the personal computer by the operating system or applications may, from time to time, be stored at the central location. When a user switches from one personal computer to another, the user's data may be transferred from the central location to the user's current computer. Additionally, the user's current computer may receive suitable versions of the operating system and applications from the central location. In any case, the operating system and software applications may run with a domain of execution that is provided by a hypervisor. Thus, the operating system and software applications may operate within a virtualized machine, perhaps alongside and in isolation from other operating systems and software applications.

Throughout this disclosure, a “workspace” or “virtual workspace” may refer to a collection of system data, user data, and virtualized applications, metadata and policies. In some cases, the workspace or virtual workspace may be characterized by an environment definition (that is, an execution environment meeting software requirements of a user) and a resource allocation that includes CPU, memory, and network bandwidth allocation parameters. In embodiments the workspace or virtual workspace may include software such as an operating system and one or more applications, in addition to user data, any number of policies, and so on. In embodiments, the operating systems may be configured for use and fully updated with patches, bug fixes, and the like. Since the workspace may contain a pre-installed operating system, execution of the workspace on a personal computer may proceed without performing an operating system installation process on the personal computer. In embodiments, the policies may be pre-configured and may include security policies, usage policies, application and system preferences, and the like. In some embodiments, the operating system may include any and all versions of the following operating systems, including without limitation equivalents or derivatives thereof: Microsoft Windows, Unix, Linux, Mac OS X, and so on.

When a copy of a workspace is run on a suitable personal computer, that copy of the workspace may produce a user experience. In some embodiments, the user experience may be a substantially conventional user experience. For example, the user experience may be one in which a user runs the applications within a windowed, graphical user interface that is provided by the operating system. For another example, the user experience may be one in which a user runs applications from a command-line or console within a textual user interface that is provided by the operating system.

The suitable personal computer (herein, “personal computer”) may be a computer having within it a virtualization software framework, which includes a hypervisor and a privileged virtual machine that runs a Workspaces Execution Engine (WEE). In embodiments, the WEE may download, cache, and run a copy of a workspace in addition to backing up copies of the workspace's user data or system disk image to a network repository or the like. The privileged virtual machine may run within privileged domain of execution, which may be variously referred to in the art as a “control domain” or “DOM zero.”

In some embodiments, the WEE may utilize what is known in the art as a Trusted Platform Module (TPM) or the like to attest to the security or authenticity of the WEE software, of the workspace, and so on.

In some embodiments the WEE may provide a suite of management functions including, without limitation, disk imaging, machine lockdown, software updates, backups, systems and data recovery, mobile computing functions (e.g., for energy saver functions, network roaming functions, and so on), caching, pre-fetching, streaming, and so on. Additional management functions may be described herein, and still others will be appreciated. All such management functions are within the scope of the present disclosure.

It should be understood that the hypervisor may manage the execution of the privileged domain and any number of non-privileged domains (referred to in the art as “guest domains”). It should also be understood that the hypervisor may provide total isolation between the domains while also providing each domain with access to common underlying resource. Without limitation such resources may include disk, CPU, network, and so on. In some embodiments, all or part of the hypervisor may be implemented in hardware, or may rely on built-in hardware virtualization functions. In some embodiments the hypervisor may be software-based and may depend upon some or all of the operating systems being patched to support virtualization. It will be understood that a variety of embodiments of the hypervisor are possible. All such embodiments are within the scope of the present disclosure.

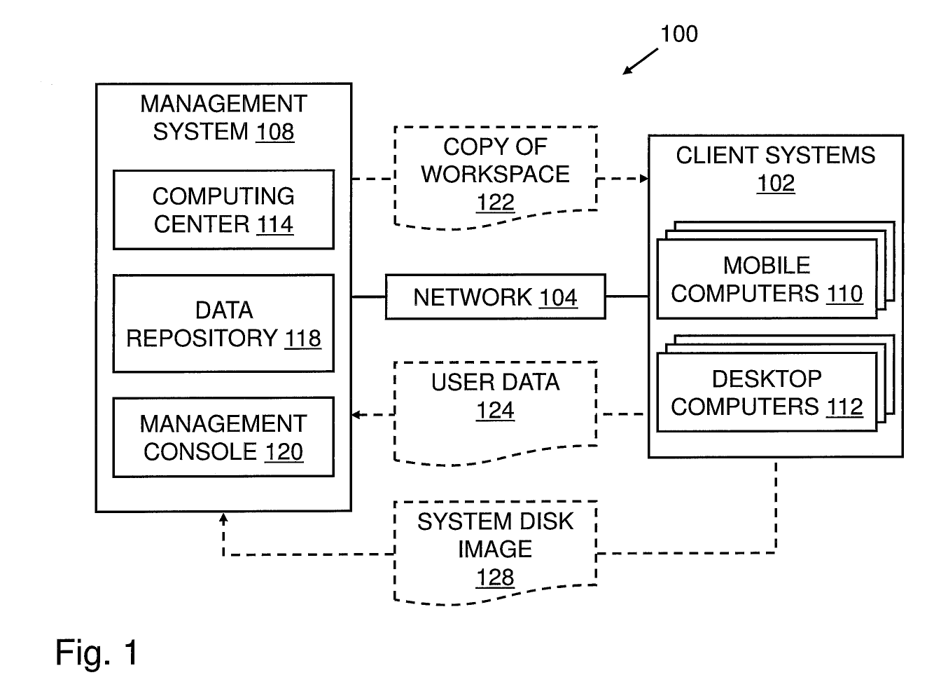

FIG. 1 depicts virtual workspace management architecture. The architecture 100 includes client systems 102, a network 104, and a management system 108. The client systems 102 include a plurality of mobile computers 110 and a plurality of desktop computers 112. The management system 108 includes a computing center 114 and a data repository 118. The computing center 114 provides a web-based management console 120, a command-line interface, or the like.

The client systems 102 may from time to time communicate with the management system 108 via the network 104. In embodiments, the clients systems 102 may have constant, intermittent, or no connectivity to the network 104. It will be understood that a variety of systems and methods for providing this connectivity are possible. In any case, this connectivity may enable communications between the client systems 102 and the management system 108.

Each of the client systems 102 may include a suitable personal computer or the like running a WEE. Communications between the client systems 102 and the management system 108 may enable certain operations of the WEE. For example and without limitation, the communications may include downloading a copy of a workspace 122 from the management system 108, uploading user data 124 to the management system 108, uploading a system disk image 128 to the management system 108, and so on. A variety of other such communications will be understood. All such communications are within the scope of the present disclosure.

In embodiments, the client systems 102 may execute the copy of the workspace 122 within a virtual machine. Thus, in embodiments each of the client systems 102 may include multiple workspaces running sequentially or concurrently on a single personal computer. As described herein and elsewhere, the workspaces (including any and all applications and data therein) may be securely delivered to the client systems 102.

It will be understood from the present disclosure that the client systems 102 may include integrated security while running multiple workspaces. This integrated security may be provided by an integrated security facility that provides central management and enforcement of security policies across a plurality of workspaces, applications, and so on. In embodiments, the integrated security facility may include any and all software or hardware elements that are involved in enabling authentication, validation, isolation, attestation, or the like. A variety of such elements are described herein and still others will be appreciated.

In some embodiments, the client systems 102 may include hardware that supports Intel VT or AMD-V and 64-bit addressing. In some embodiments, the client systems 102 may not support such technologies and may have 8-bit, 16-bit, 64-bit, 128-bit, 256-bit, or any other number of bits of addressing.

In some embodiments, the client systems 102 may act as so-called “fixed-function devices,” each of which runs a WEE. Each of the client systems 102 may be capable of running a user-visible workspace, a system workspace, and a bare-metal virtualization. Each of the client systems 102 may run services partitions that are hidden from a user. It should be understood that the phrase “bare-metal” may refer to software that runs directly on underlying hardware without substantial intermediating operating system software or drivers between. In some embodiments, bare-metal virtualization may rely on BIOS, microcode, programmable interrupts, or other relatively low-level software functions that are substantially built into the client systems 102.

Throughout this disclosure and elsewhere, the terms “computer” and “personal computer” may be used interchangeably to refer to one of the client systems 102.

The network 104 may include any number of networks arranged so as to provide data communications between the client systems 102 and the management system 108. As depicted, these communications may without limitation include a copy of a workspace 122, user data 124, or system disk image 128. In embodiments, the data communications may be provided according to what are known in the art as Internet Protocol v4, Internet Protocol v6, or the like. In embodiments, the network 104 may include the Internet, a local area network, a metropolitan area network, a wide are network, a personal area network, a cellular network, a storage area network, and so on. In some embodiments, the network 104 may include a shared storage system that is accessible to both the management system 108 and the client systems 102. It will be understood that a variety of embodiments of the network 104 are possible.

The management system 108 may communicate with the client systems 102 via the network 104.

The management system 108 may provide a copy of a workspace 122 to each of the client systems 102. In embodiments, each of these copies of the workspaces 122 may be communicated from the management system 108 to the client systems 102 via the network 104. Such communication may involve a file download, a data stream, or the like.

The management system 108 may receive and archive, from the client systems 102, a workspace's user data 124, a workspace's system disk image 128, and so on. In embodiments, the management system 108 may receive this user data 124 or system disk image 128 from the client systems 102 via the network 104. This may enable full or incremental backups of the workspace 122, including without limitation the user data 124 or system disk image 128 therein. Additionally or alternatively, this may enable the user data 124 or system disk image 128 in the copy of the workspace 122 to be substantially mirrored at the management system 108. As described hereinabove and elsewhere, the network 104 may include a shared storage system and so the management system 108 may be said to receive the user data 124 or system disk image 128 when the client systems 102 write to this shared storage system.

The management system 108 may enable an administrator to manage and configure the workspaces. Managing and configuring a workspace may include creating, modifying, or deleting the workspace. Without limitation, modifying the workspace may include adding, removing, or updating an aspect of the workspace, this aspect including an operating system image, an application, user data 124, a policy, or the like. In embodiments, this managing and configuring may take place via a command-line interface, via the web-based management console 120 (which is described in detail hereinafter), or the like.

In embodiments, the management system 108 may be operated by a business entity or the like that provides services to the client systems 102 on a fee-for-service basis. For example and without limitation, an operator of the management system 108 may impose a fee for communications between the client systems 102 and the management system 108. For another example and also without limitation, the operator may impose a fee for storing user data 124, for storing more than a certain amount of user data 124, for storing the system disk image 128, and so on. It will be understood that the operator may impose a variety of fees for services that are enabled by or enhanced by the management system 108. Impositions of all such fees are within the scope of the present disclosure.

The mobile computers 110 are personal computers and may include any and all forms of mobile computer. For example and without limitation, the mobile computers 110 may include laptop computers, handheld computers, palm-top computers, so-called smart phones, cell phones, and so on. It will be understood that a variety of embodiments of the mobile computers 110 are possible.

The desktop computers 112 are personal computers and may include any and all forms of desktop computer. For example and without limitation, the desktop computers may include workstations, home computers, or the like. It will be understood that a variety of embodiments of the desktop computers 112 are possible.

The computing center 114 may provide application logic and data processing capabilities to the management system 108. This may enable the management system 108 to carry out its activities, which are described hereinabove and elsewhere. In embodiments, the computing center 114 may include any number of server-class computers or the like arranged in one or more data centers. In embodiments, the computing center 114 may include any number of switches, hubs, firewalls, load balancers, or other suitable networking equipment. This networking equipment may provide communications between the components of the management system 108 and, as appropriate, may provide communications between those components and the network 104. It will be understood that a variety of embodiments of the computing center 114 are possible.

The data repository 118 may provide data storage capabilities to the management system 108. This may enable the management system 108 to store workspaces, to store aspects of workspaces (operating system images, applications, user data 124, policies, and so on), and so forth. In embodiments, the data repository 118 may include any number of hard drives, tape storage devices, solid-state storage devices, or the like, any and all of which may be arranged in an array. In some embodiments, this array may be arranged and managed according to what is known in the art as hardware or software RAID. The data repository 118 may be operatively coupled to the computing center 114. In embodiments, this operative coupling may include an Internet Protocol network path, which may traverse any and all of the networking equipment of the computing center 114. In some embodiments the data repository 118 may exist in more than one data center, or in a data center that does not entirely contain the computing center 114. In such embodiments, the data path of the operative coupling may traverse the network 104 as well. It will be understood that a variety of embodiments of the data repository 118 are possible.

In some embodiments, any and all of the data in the data repository 118 may be subject to access controls. Without limitation, these access controls may be provided via one or more forms of encryption of data in the data repository 118, network security policies that limit communications between the data repository 118 and other computers, and so on. In some embodiments, the encryption may rely upon what is known in the art as a public key infrastructure. In any case, a variety access controls will be appreciated, and all such access controls are within the scope of the present disclosure.

For example and without limitation, in embodiments a user may have an account, which is used to perform access control. The user account may be logically associated with a virtual computing profile, which may exist in the data repository 118. In embodiments, the virtual computing profile may exist at least in part as a plain text file, a binary file, an ASCII file, an XML file, a database record or entry, an Active Directory record, an LDAP record, or the like. In any case, the virtual computing profile may list a number of virtual workspaces to which the user has access.

A subscription may be created in the virtual computing profile when the user first runs a virtual workspace. This subscription may store a system disk image 128 that is logically associated with that virtual workspace. Updates to the system disk image 128 may be reflected in the subscription. When the user later accesses the virtual workspace, the subscription and the system disk image 128 may be retrieved.

In some embodiments, each and every workspace may be stored in the data repository 118. Updates to a workspace may be published in the data repository 118 as new versions of the workspace. In some embodiments, any and all versions of the workspace may be immutable. In some embodiments, the data repository 118 may employ copy-on-write disks (sometimes referred to as differencing disks) to express the differences between the versions.

The web-based management console 120 may provide a user interface through which an administrator or the like operates the computing center 114. In embodiments, the web-based management console 120 may include one or more websites, application user interfaces, or the like. In some embodiments, the web-based management console 120 may be delivered to an administrator or the like via a web browser. In any case, the web-based management console 120 may be delivered to an administrator or the like via a web page on a computer (desktop, laptop, palmtop, or otherwise), via a text message to a cell phone, via an instant message to an instant messenger, and so on. In embodiments, input to the web-based management console 120 may include mouse input, keyboard or keypad input, voice input, or the like. It will be understood that a variety of embodiments of the web-based management console 120 are possible.

Access to the web-based management console 120 may be limited by a security measure. In embodiments, the security measure may involve a username and password, a challenge and response, a physical security token (such as a dongle, security card, or the like), a biometric scan, or the like. It will be understood that a variety of embodiments of the security measures are possible.

In some embodiments, an end user (i.e., a user of one of the client systems 102) may have access to the web-based management console 120. In such embodiments the end user may create or manage a workspace for himself via the web-based management console 120.

In some embodiments, any and all of the capabilities of the web-based management console 120 may be provided by a command-line interface, a scripting interface, or the like. In such embodiments, the web-based management console 120 may or may not be present.

The copy of the workspace 122 may reflect a workspace that was created by a corporate administrator, a workspace that was created by the end user or another user, and so on. In some embodiments, the copy of the workspace 122 may co-exist and execute substantially concurrently with another copy of another workspace 122 on one of the client systems 102. It will be understood that the hypervisor of the WEE may enable such concurrency while maintaining substantially full isolation of one workspace from the other workspace.

In some embodiments, the copy of the workspace 122 may reflect a specialized workspace, the execution of which may not be visible to or accessible by the end user. A trusted third party, an operator of the management system 108, or the like may create such a specialized workspace. The specialized workspace may include a PC-monitoring application, a backup application, an anti-virus application, a root-kit detection application, or the like. In any case, execution of the specialized workspace on one of the client systems 102 may create a system management environment that can be remotely controlled and managed over the network 104 by an administrator.

At times, the copy of the workspace 122 may be packaged and encapsulated as a virtual machine that is communicated in a portable virtual machine format. One such format may include the Open Virtual Machine Format (OVF). A variety of other such formats will be appreciated. In any case, it will be understood that the copy of the workspace 122 may be packaged and encapsulated in many ways, all of which are within the scope of the present disclosure.

In some embodiments, the copy of the workspace 122 may be delivered to one of the client systems 102 via a physical medium such as a CD, DVD, external hard drive, Bluetooth device, and so on.

The copy of the workspace 122 may include a virtual hard disk image. In some embodiments, the virtual hard disk image may be built and stored in the management system 108, to be delivered to one of the client systems 102 as needed. In some embodiments, the virtual hard disk image may be built and delivered substantially on demand or as needed. In some embodiments, the virtual hard disk image may be built directly in one of the client systems 102. In some embodiments, virtual hard disk images may be individually accessible from the data repository 118 (which may be referred to herein and elsewhere as a “virtual disk repository”).

The user data 124 may include files, directories, database tables, or other data created or modified by a user. In embodiments, the user data 124 may include data that is designated as belonging to a particular user or group of users. The user data 124 may include a variety of permissions, file types, status bits, dates and times of data creation or modification, and other such metadata. A variety of such metadata will be understood.

The system disk image 128 may include files, directories, or the like that include an installation of an operating system and applications. It should be appreciated that the installation may include executables, scripts, libraries, character devices, block devices, pseudo-devices, data files, or the like. It will be understood that the contents of the system disk image 128 may vary, and that a variety of embodiments of the system disk image 128 are possible.

Communications over the network 104 may be encrypted, compressed, or otherwise encapsulated. Thus, the user data 124, the system disk image 128, and so on may be encrypted, compressed, or otherwise encapsulated for communication over the network 104.

In some embodiments, the copy of the workspace 122 does not include a so-called “personality,” which is to say that it lacks personal definitions such as a computer name, a user account identifier, a system identifier, so-called “hard variables” of an operating system, and the like. In such embodiments, one of the client systems 102 may inject the personality into the copy of the workspace 122. This personality may be customized for an end-user, for the one of the clients systems 102, and so on. In this way, embodiments of the present invention may provide customized environments for each of a relatively large number of end users and client systems 102 while maintaining a relatively small number of workspaces at the management system 108.

For example and without limitation, an administrator may create a master image (or “root disk image”) of a workspace from scratch or by cloning an existing image of workspace. Then, the administrator may apply patches to the master image, install new applications into the master image, and so on. Having completed such modifications to the master image, the administrator may publish the master image to a plurality of users. This act of publishing may pull out any temporary personalization that might have been put into the master image, leaving a so-called “clean” master image (that is, one without personalization). The clean master image may be communicated to the client systems 102 as the copy of the workspace 122. After the copy of the workspace 122 arrives at one of the client systems 102, that one of the client systems 102 may inject a personality into the copy of the workspace 122.

More generally, a master image may be created, personalized, depersonalized, re-personalized. The creation, personalization, depersonalization, and re-personalization of the master image (or a copy 122 thereof) may take place at the management system 108, at the client systems 102, under the control of an administrator, under the control of a user, and so on.

In some embodiments, an end user may access a particular copy of the workspace 122 from any of a number of the client systems 102. In such embodiments, the end user may enter login information or other credentials into one of the client systems 102. Upon verification of this information or these credentials, this one of the client systems 102 may retrieve the particular copy of the workspace 122 from the management system 108 and then run it. In embodiments, this copy of the workspace 122 may be a copy of the newest version of the workspace 122.

When a user is running an out-of-date version of the workspace 122, the WEE may inform the user that a newer version is available. This may encourage the user to reboot the workspace's virtual machine, at which time the WEE may run the newer version of the workspace in place of the out-of-date version. In some embodiments, from the user's perspective, this upgrading from the out-of-date version to the newer version may require no work beyond rebooting the workspace's virtual machine. In any case, the WEE may download the newer version from the management system 108.

Similarly, the WEE may update itself by downloading a new version of its own privileged virtual workspace from the management system 108. In some embodiments, the personal computer on which the WEE is running may need to reboot in order to bring online the privileged virtual workspace.

The management system 108 may build on demand any and all aspects of the copy of the workspace 122. A copy of the workspace 122 that is built in this manner may be tailored for an end user and in a manner that is suitable for running on the particular one of the clients systems 102 that the end user is utilizing. For example and without limitation, when the end user accesses the copy of the workspace 122 on an Apple PowerBook G4 then the copy of the workspace 122 may be built to include a PowerPC-native version of Apple's OS X operating system. However, when the same end user access the copy of the workspace 122 on a MacBook Pro then the copy of the workspace 122 may be built to include an Intel-native version of Apple's OS X operating system. In both cases the copy of the workspace 122 may include the substantially the same user data 124. Moreover, in both cases the copy of the workspace 122 may include substantially the same applications, especially if the applications are universal-type applications that can run on PowerPC or Intel architectures; if an emulator is included in the operating system or in an application, the emulator allowing applications for one architecture to be run on another architecture; and so on. Alternatively, substitute or architecture-specific versions of the applications may be included in the copy of the workspace 122. A variety of other such examples will be appreciated.

In some embodiments a “locked-down” copy of the workspace 122 may be configured to disallow or not support network access. For example and without limitation, the copy of the workspace 122 may not include requisite network drivers for accessing the network 104. For another example and also without limitation, the copy of the workspace 122 may include a firewall or other application that is pre-configured to prevent network access. It should be appreciated that the WEE and other copies of other workspaces 122, all of which may be running substantially concurrently with the locked-down copy of the workspace 122, may be able to access the network 104 even though the locked-down copy cannot.

The WEE may include or may utilize a disposal facility. As its name suggests, the disposal facility may dispose all or part of a workspace. Disposing of all or part of a workspace may include deleting some or all of a workspace's data or otherwise rendering such data substantially unusable. In some embodiments, the disposal facility may include a multi-pass disk deletion utility or the like. In some embodiments, the disposal facility may delete one or more keys that are necessary to access an aspect of the workspace. In some embodiments, the disposal facility may include a hardware register or component that is reset or otherwise altered so as to prevent all or part of a workspace from being authenticated, attested, unsealed, decrypted, or otherwise made ready for use. In view of the present disclosure, it will be appreciated that a variety of embodiments of the disposal facility are possible.

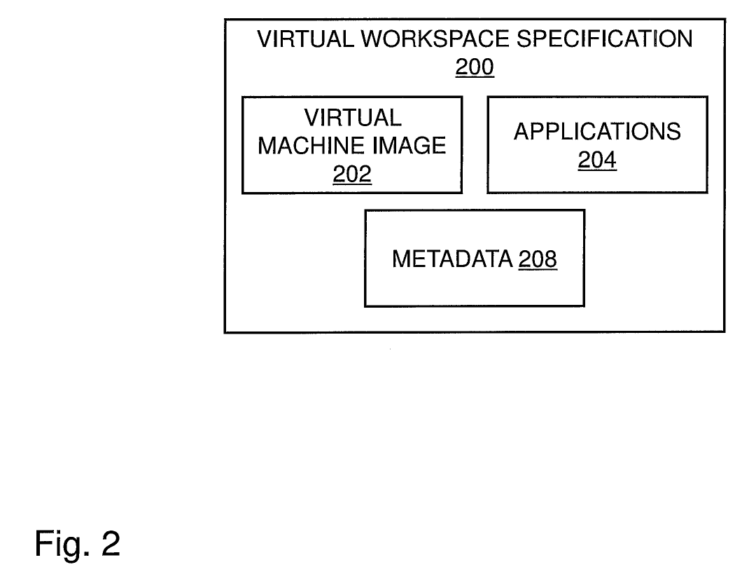

FIG. 2 depicts a virtual workspace specification. The virtual workspace specification 200 includes a virtual machine image 202, applications 204, and metadata 208.

The virtual workspace specification 200 may embody the copy of the virtual workspace 122. In embodiments, the virtual workspace specification 200 may be provided as one or more data files, each of which may be compressed, encrypted, and so on.

In embodiments, the virtual machine image 202 may include at least one virtual disk image. A virtual disk image of the virtual machine image 202 may include a functional operating system and various applications. This virtual disk image may be referred to as a “system virtual disk.” Another virtual disk image of the virtual machine image 202 may include substantially persistent user data 124, such as files, settings, and the like. This virtual disk image may be referred to as a “user virtual disk.” Yet another virtual disk image of the virtual machine image 202 may include substantially transient user data 124. This virtual disk image may be referred to as a “transient virtual disk.” The virtual machine image 202 may also include a so-called “memory image” that holds a suspended virtual machine's state.

Any and all aspects of the virtual machine image 202 may be accessed and updated by the WEE. For example and without limitation, the WEE may write to the memory image as a virtual machine is entering a suspended state; read from the memory image as a virtual machine is exiting a suspended state; read or write from a copy of a subscription within the virtual machine image 202; and so on. Also for example and without limitation, prior to running a virtual workspace, the WEE may create a copy-on-write copy of the virtual machine image 202 or aspects thereof. In yet another example, the WEE may instantiate a transient disk when a virtual workspace requires but does not already have one. Still other such examples will be appreciated.

The applications 204 may include any and all applications that are part of a virtual workspace according to the virtual workspace specification 200. In embodiments, the applications 204 may be encoded as one or more virtual disk images, or as part of one or more virtual disk images. The applications 204 may include a set of virtualized applications that reside outside of the virtual machine image 202 and are encapsulated in their own individual containers. In some embodiments, the WEE may dynamically or statically load such applications 204 into a virtual machine.

Generally, a virtualized application may be an application that is run on top of an operating-system virtualization layer. In some embodiments, the application may be adapted to run on top of an operating system, but not specially adapted to run on top of an operating-system virtualization later. In some embodiments, the application may be specially adapted to run on top of an operating-system virtualization layer. For example and without limitation, the application may be compiled to run on the operating-system virtualization layer, may include a dynamically linked library that allows the application to run on said layer, and so on.

The operating-system virtualization layer may provide to the virtual application any and all services of an operating system. For example and without limitation, this layer may provide the virtual application with access to operating system services that relate to processes, threads, memory, secondary storage, peripherals, graphics, interprocess communications, network communications, and so on. Still other operating system services will be appreciated.

The metadata 208 may include any and all of the system data or user data 124 described hereinabove and elsewhere. In embodiments, the metadata 208 may include policies or the like so on. In some embodiments the metadata 208 may be encoded in XML, although many suitable data formats will be appreciated.

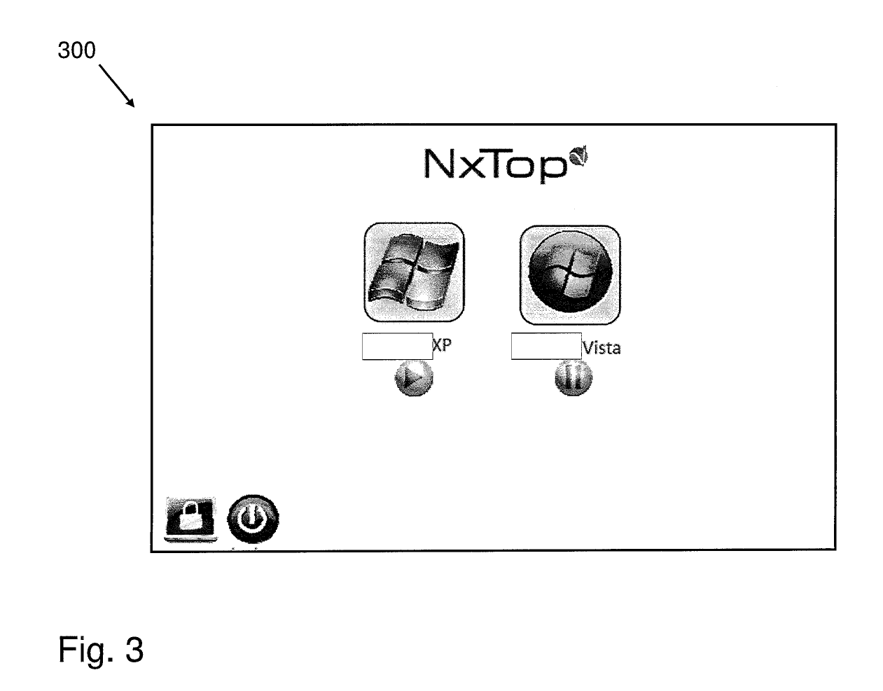

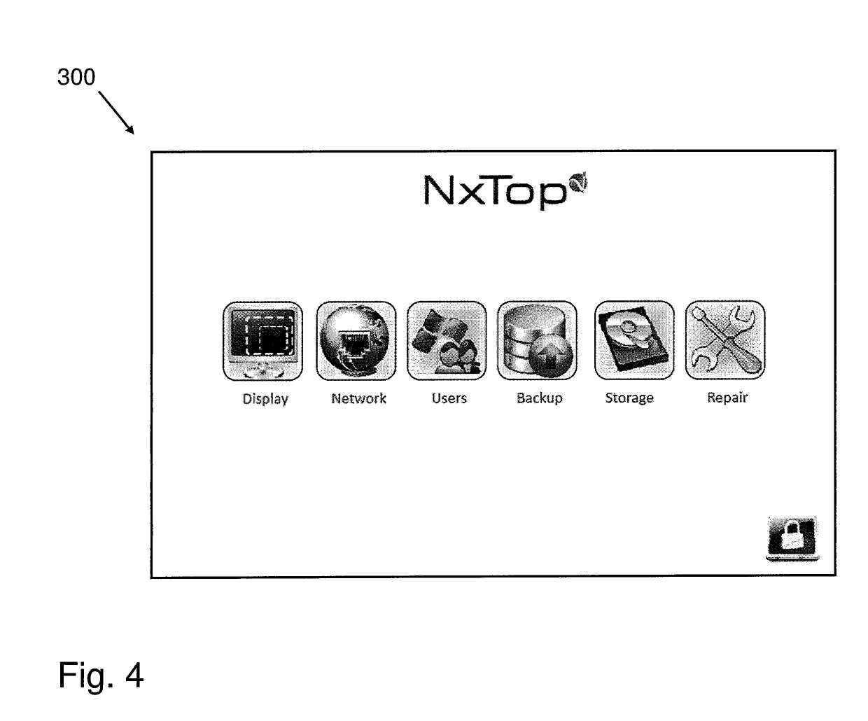

FIG. 3 and FIG. 4 depict a user interface of a WEE. These figures include icons, many of which have labels, and all of which are discussed in detail hereinafter. It should be appreciated that the labels in FIG. 3 and FIG. 4 are intended to be illustrative and not limiting.

Before going into detail, however, it should be understood that FIG. 3 and FIG. 4 are provided for the purpose of illustration and not limitation. In particular, it should be appreciated that embodiments of the user interface of the WEE may include any number of icons that are presented in any arrangement. Such an arrangement may include a hierarchy of icons, multiple pages of icons, and so on. Generally, the icons may represent users, groups, workspaces, a hierarchy of any and all of the foregoing, or the like. In some embodiments, the user interface of the WEE may include an aspect that is available to an administrator, an aspect that is available to an end user, and so on. In some embodiments, the administrator may be a remote (or centrally located) administrator and the user interface may be made available to the administrator, by the WEE, and via the network 104.

In all, the WEE's user interface and the like may provide a user interface that allows the WEE to authenticate a user and support a variety of user interactions. Without limitation, the user interactions may include starting a workspace, stopping a workspace; suspending a workspace to a memory image; resetting a workspace to destroy transient disks and memory images while keeping a user's disk; deleting a workspace to remove the user's subscription and user's virtual disk; undoing a change to a virtual disk, thus providing a previous snapshot (or version) of the virtual disk; and so on.

The user interface 300 of the WEE may be employed to authenticate a user and allow the user to perform a number of operations on a virtual workspace. For example and without limitation, after a personal computer boots up the WEE may present a login window into which a user enters a user name and password. Upon verification of the user name and password, the WEE may present the user with a list of virtual workspaces to which the user has access (as in FIG. 3). Once the user chooses one of the virtual workspaces from the list, the WEE may present a number of operations relating to it. When the user chooses one of these operations, the WEE may execute it. Additionally or alternatively, the user interface 300 of the WEE may present a number of the WEE's management functions (as in FIG. 4).

Referring now to FIG. 3, two relatively large icons each represent a distinct virtual workspace. From left to right, these icons are labeled “DSL,” and “XP-SP2.” When a user selects one of these relatively large icons, the corresponding virtual workspace may be activated or brought into the foreground.

Toward the lower left of the user interface there are two, relatively small icons. From left to right, these icons depict a padlock (“the padlock icon”) and a power on/off symbol (“the power icon”).

In some embodiments, selecting the padlock icon in order to lock or unlock the user interface.

In some embodiments, selecting the padlock icon may lock down any and all virtual disks, creating new copy-on-write versions of the virtual disks prior to booting a virtual workspace and then discarding the virtual disks on shutdown of the virtual workspace. This may, for example and without limitation, prevent a user from installing software that persists between instantiations of the virtual workspace.

In some embodiments, selecting the power icon in order to power down, put to sleep, or suspend the personal computer on which the WEE is running. It will be understood that a variety of other such icons are possible.

Toward the lower right of the user interface in FIG. 3 is a trademark. In some embodiments, selecting the trademark may bring up system information that relates to the personal computer on which the WEE is running. Such system information may without limitation include the WEE's software version; high-level hardware statistics such as total RAM, CPU type and speed, and the like; and so on. Alternatively, selecting the trademark may bring up system information that relates to the virtual computer in which the user's virtual workspace will run. Such system information may without limitation include the virtual computer's total RAM, the virtual computer's CPU type (emulated or actual) and effective speed, the virtual computer's BIOS version, and so on. The system information may include an amount of data to be backed up, a wireless networking configuration, a configuration parameter, a status indicator, and so on.

Starting a virtual workspace may boot the latest version of the virtual workspace or resume the virtual workspace from a suspended state. Stopping a virtual workspace may shut down the virtual workspace. Suspending the virtual workspace may suspend the virtual workspace to a memory image. Resetting the virtual workspace may destroy all transient images and the memory image of the virtual workspace, while keeping all user virtual disks of the virtual workspace. Deleting the virtual workspace may destroy the user's subscription to the virtual workspace, including the user virtual disks of the virtual workspace. Undoing the virtual workspace may allow a user to go back to a previous snapshot of his user virtual disk. Publishing the virtual workspace may allow an administrator to create a new version of the virtual workspace that includes a current system virtual disk. Backing up the virtual workspace may include performing a complete backup of the user virtual disk.

In cases where insufficient network bandwidth between a personal computer and the management system 108 prevents immediate backup of the virtual workspace, copy-on-write snapshots of the virtual workspace may accumulate on the personal computer for later transfer to the management system 108. In some embodiments, the WEE may respond to excessive accumulation of such snapshots by reducing the frequency of snapshots, collapsing multiple snapshots together, and so on.

Upon starting a virtual workspace on a personal computer, the virtual workspace may, in some embodiments, “own” a keyboard, mouse, and screen of the personal computer. By pressing a hot key combination, the user may return to the user interface 300 that hast the list of virtual workspaces. In embodiments, this hot key combination may be Ctrl-Alt-Tab, Ctrl-̂, Ctrl-v, or the like.

Referring now to FIG. 4, a number of relatively large icons each represent a management function. From left to right, these icons are labeled “Display,” “Network,” “Users,” “Backup,” “Storage,” and “Repair.” In all, these management functions may enable a user to configure a display, configure or monitor a network, configure one or more users or user accounts, monitor or initiate a backup of virtual workspace, monitor usage of local or remote storage, repair virtual workspace or an aspect thereof, and so on.

Referring now to the client systems 102 of FIG. 1, embodiments of the client systems 102 may include TPMs and may support a process known as “measured and verified launch” or “trusted boot.” Generally, as one of the client systems 102 undergoes a trusted boot the client system's 102 TPM measures and reports the running state of hardware and software. In some embodiments, the TPM may have a plurality of so-called Platform Configuration Registers (PCRs) embedded with it. These PCRs, the contents of which may be under the control of the TPM, may contain the running state. For example and without limitation, the running state may be encoded as a number of 160-bit hash values, each of which may be stored in one of the PCRs. In some embodiments, the trusted boot may be implemented using an open source project widely known as tboot, or an equivalent thereof. It should be understood that the trusted boot result in the instantiation and operating of a plurality of workspaces.

In embodiments, when one of the client systems 102 (“client computer”) is initially booted or reset, its TPM's PCRs are set to zero. Then, a Core Root of Trust Measurement (CRTM) is taken of the BIOS of the client computer. This measurement determines initial values for the PCRs. The BIOS (regardless of its integrity) may then measure a bootloader or other hardware and software on the client computer. The results of these measurements may be used to further extend the values of the PCRs that were initially established by the CRTM. In some embodiments, what is known in the art as a SHA1 cryptographic hash may be employed to extend the values in the PCRs. For example and without limitation, the TPM may append the results of the measurements may be concatenated to the PCRs values to produce new source values, each of which is then hashed and stored back into the PCRs. As subsequent stages of booting occur (e.g., first bootloader, then operating system, and so on) additional measurements (e.g., of applications, of configuration files, and so on) may be used to further extend the values in the PCRs. In this way, the PCRs may contain values that reflect a current running configuration of the client computer at each stage boot stage.

In order to ensure that booting process to be a trusted booting process, the TPM may be used to seal data into a given platform configuration. For example and without limitation, the TPM may encrypt an arbitrarily long data set along with configuration information (i.e., PCR values) so that the TPM will only unseal (i.e., decrypt and disclose) the data when the TPM's PCRs are in the specified configuration. The sealed data may be stored anywhere within the platform 100 (and perhaps at times even outside of the platform 100). Since the sealed data is encrypted, it need not be veiled within the TPM.

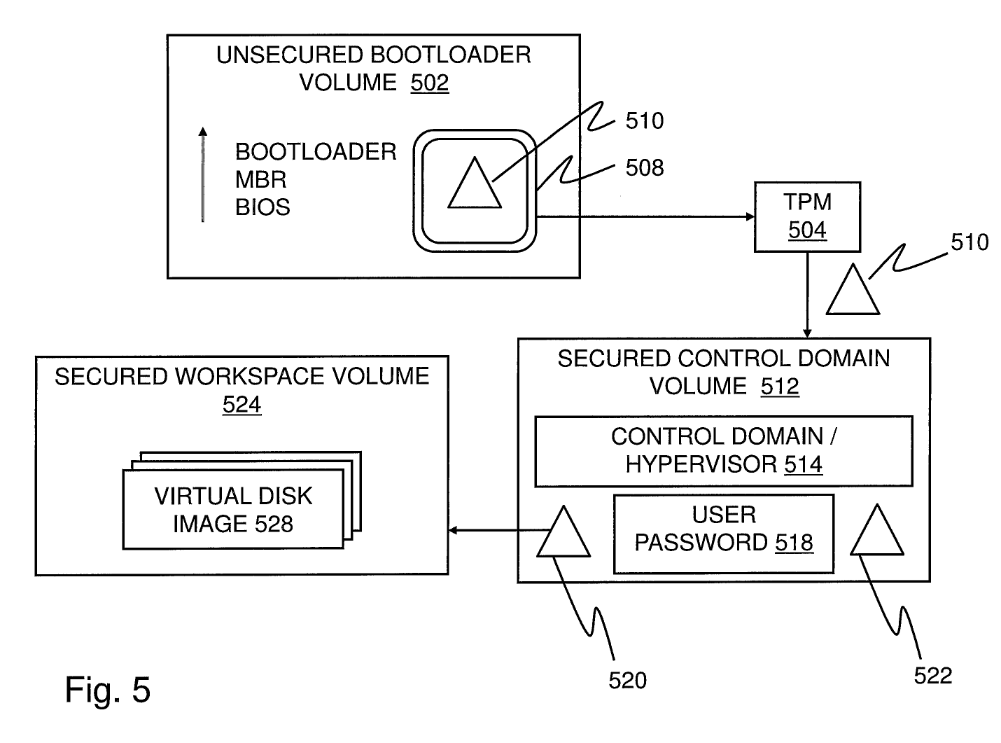

FIG. 5 depicts data volumes and a trusted boot sequence. The data volumes include an unsecured bootloader volume 502, a secured control domain volume 512, and a secured workspace volume 524. The unsecured bootloader volume 502 includes a key 510 to the secured control domain volume 512, BIOS, a Master Boot Record (MBR), and a bootloader. The key 510 is under cryptographic seal 508. The secure control domain volume 512 includes a control domain or hypervisor 514, a user password 518, a key 520 to the secured workspace volume 524, and a key 522 that is used to authenticate the management system 108. The secured workspace volume 524 includes a plurality of virtual disk images 528.

The trusted boot sequence utilizes the TPM 504 to break the seal 508 and provide the key 510 that decrypts the secured control domain volume 512. First, the data volumes are loaded into client computer. Then, various components of the unsecured bootloader volume 502 are successively invoked. These are, in order: the BIOS, the MBR, and the bootloader.

When executed, the bootloader transfers the key 510 under cryptographic seal 508 to the TPM 504, which breaks the cryptographic seal 508 to reveal, in unencrypted form, the key 510. Then, the key 510 is used to decrypt the secured control domain volume 512. Once this volume 512 is decrypted, the bootloader executed the control domain or hypervisor 514.

The control domain or hypervisor 514 then proceeds decrypt the secured workspace volume 524 using the key 520. Once that is complete, the control domain or hypervisor 514 mounts the virtual disk images 528 and boots virtual computer, in a guest domain, from a bootable one of the virtual disk images 528.

Throughout this disclosure and elsewhere the phrases “virtual machine disk image” and “virtual hard disk image” may refer to a virtual disk image 528. In embodiments the virtual disk image 528 may include a disk image. Embodiments of a virtual disk image 528 may be encoded according to Microsoft's Virtual Hard Disk Image Format Specification (i.e., “in VHD format”) or any other specification for encoding virtual hard disks. It will be understood that a variety of embodiments of the virtual disk image are possible.

In embodiments, the TPM's 504 trusted boot capability may be employed to guarantee that workspaces operate in a secure, uncompromised environment. The hypervisor 514 and secrets (e.g., key 520) that it needs to run workspaces may be secured with an encrypted volume (e.g. 512), the key 508 for which may is bound both to the client computer's TPM 504 and to the boot configuration (PCRs) of a trusted bootloader (i.e., the bootloader in the unsecured bootloader volume 502). Thus, only when the personal computer successfully boots through the trusted bootloader will the TPM's 504 PCRs be in the configuration necessary for the TPM 504 to disclose the control domain's workspace encryption key (i.e., to break the cryptographic seal 508, revealing the key 510).

In some embodiments, the key 510 may be stored on the management system 108. If the client computer's TPM 504 were to be reset, the key 510 may be re-encrypted by the management system 108 using the then current values in the TPM's 504 PCRs, which may be communicated to the management system 108. In order to authenticate communications with the management system 108, the key 522 may be employed. In some embodiments, the key 522 may include a site certificate or the like.

In some embodiments, a client computer may be shipped with its TPM 504 in a disabled state. Before a trusted software installation can be performed, the TPM 504 may need to be enabled. In some embodiments, the TPM 504 can be only be enabled from the client computer's BIOS, thus ensuring the user that enables the TPM 504 has physical possession of the client computer.

Once the TPM 504 is enabled then ownership of the TPM 504 may be established via software. In embodiments this software may provide a management function of the WEE with which the ownership is established. Establishing ownership of the TPM 504 may involve the specification of two passwords, an owner password and what is know in the art as a Storage Root Key (SRK) password.

In embodiments, knowledge of the owner password permits a user to perform certain administrator operations on the TPM 504 (for example and without limitation, migration of keys).

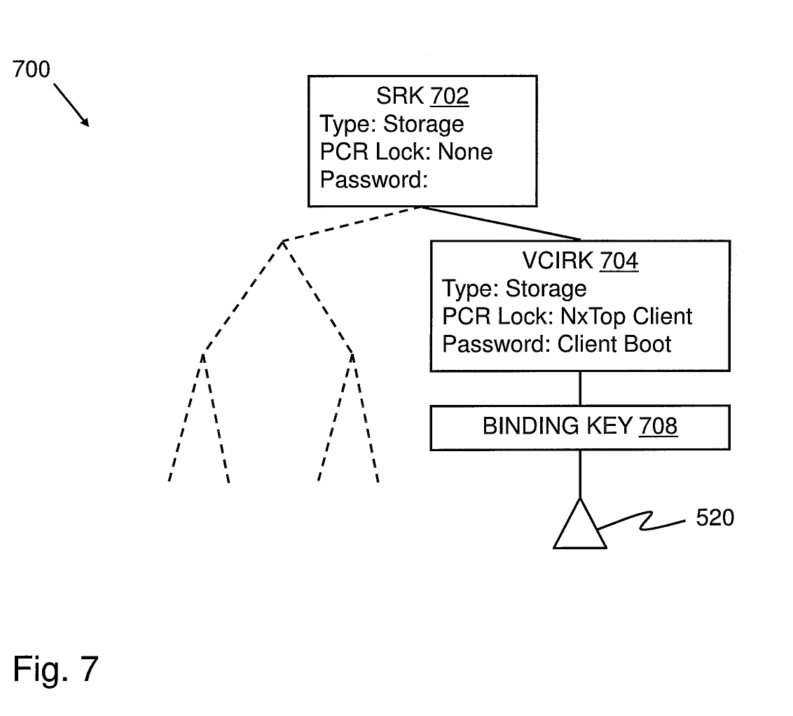

A hierarchy of keys (described in greater detail hereinafter with reference to FIG. 7) may include the SRK password at its root. Thus, the SRK password may be needed in order to access any TPM-bound keys (including without limitation the keys 510, 522, 522, and so on). In some embodiments, the SRK password may be set to a well-known value and subordinate keys (such as and without limitation the key 510 to the secured control domain volume 512) may be protected by binding them PCR values or other authentication data. In some embodiments the TPM 504 may randomly generate the SRK at the time ownership of the TPM 504 is taken. In some embodiments the TPM 504 may regenerate the SRK whenever a new owner is established. In some embodiments, the SRK may never leave the physical TPM 504.

In some embodiments, a trusted user may install the unsecured bootloader volume 502 in a client computer. The trusted computer may take physical possession of the client computer, enable the TPM 504, and take ownership of the TPM 504. The user may then install a trusted copy of the unsecured bootloader volume 502 into the client computer. Next, the trusted user may boot the client computer, thereby establishing trusted PCR values for the client computer. These are the PCR values may then be used to apply the cryptographic seal 508 to the key 510 that is used to decrypt the secured control domain volume 512. The trusted user may then, using a management function of the WEE, securely connect to the management system 108, log in to the management system 108, and register the client computer with the management system 108.

Registration credentials may be exchanged during this registration process. The registration credentials may be stored in the secured domain control volume 512. In embodiments, the registration credentials may include a globally unique identifier for the client computer and the key 522 that is needed to authenticate communications with the management system 108). In some embodiments, the registration credentials may include the TPM's 504 public endorsement key (PUBEK) and BIOS UUID as unique identifiers of the client computer.

As an alternative to a trusted user installing the unsecured bootloader volume 502 in the client computer, an attestation feature of the TPM 504 may be used by the management system 108 in order to remotely verify that a secure installation was correctly performed on a client computer. Attestation may permit a TPM 504 to certify its current configuration (i.e., PCR values) to another entity by digitally signing the TPM's 504 PCT values along with a nonce value provided by the management system 108. Here, the management system 108 may only need to verify the signature on the TPM's 504 response.

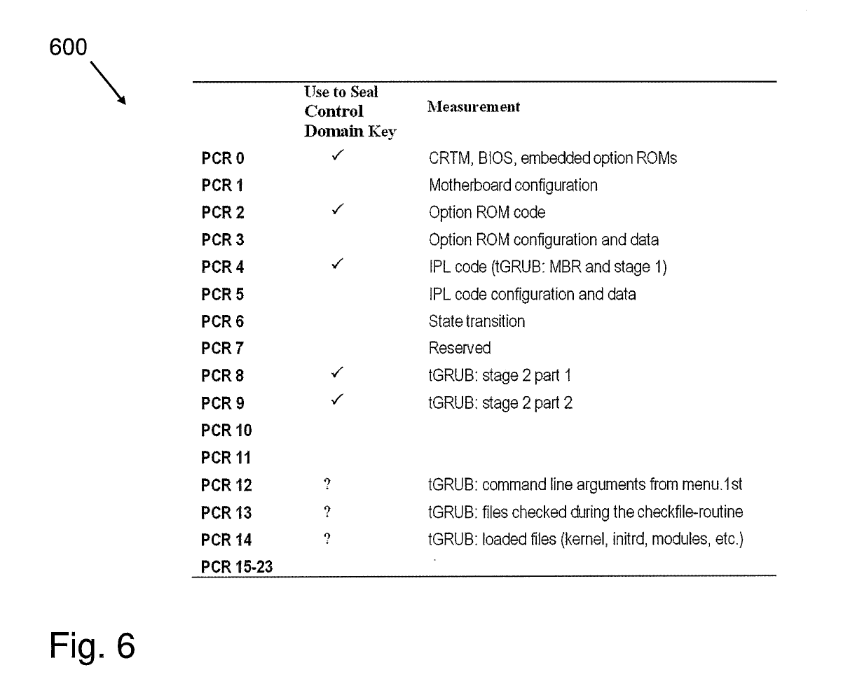

FIG. 6 depicts a set of PCRs. This set 600 of PCRs, provided for the purpose of illustration and not limitation, shows a conventional assignment of measurements to PCRs up through the execution of a bootloader. The figure depicts a subset of the PCRs, indicated by a check mark, which may be selected for use in sealing the control domain key. This subset is selected so that select changes to the client computer (e.g., the addition or removal of memory) will not affect the PCRs used in sealing the control domain volume key. In some embodiments, after the control domain volume key is retrieved, at least one of the PCRs in the subset may be extended by the bootloader to prevent further disclosure of the key by the TPM 504.

In embodiments wherein no TPM 504 exists (or wherein a TPM exists but is disabled) the control domain volume key may be stored in an alternate manner. For example and without limitation, this key may be stored on a removable memory stick, or it may be stored on the boot volume and encrypted using a user password, biometric data set, or the like.

FIG. 7 depicts a key hierarchy. The key hierarchy 700 includes an SRK 702, an intermediate root key labeled VCIRK 704, a binding key 708, and the key 520 that is used to decrypt the secured control domain volume 512. The VCIRK 704 may allow the client computer to introduce additional authentication factors on its key sub-tree without affecting the SRK 702. The binding key 708 may wrap migratable keys such as disk encryption keys.

In embodiments, the TPM 504 may distinguish between migratable and non-migratable keys. Migratable key may be exported from one TPM 504 and imported into another. Non-migratable keys may be bound to a specific TPM 504 (i.e., encrypted by its SRK 702) and thus may not be exposed outside of that TPM. In some embodiments, the control domain or hypervisor 514 may take advantage of non-migratable keys whenever possible in order to reduce the risk of inadvertent disclosure. For example and without limitation, the management server authentication key 522 may be made non-migratable so that only one client computer is capable of generating the signature necessary to authenticate this client computer to the management system 108. As depicted, the key 520 that is used to decrypt the secured workspace volume 524 and its virtual disk images 528 may be migratable. This may allow the management server 108 to cache the key 510.

In embodiments, authorization to load and use a TPM 504 key may be protected using any of a number of independent factures, including the following: (a) authorization to load and use its parent key; (b) specification of a secret (also known as authData), which may be a hash value derived from a password or some other factor (e.g., biometric or other input); and (c) specific configuration of one or more PCR values (i.e., the key may be locked into a specific boot configuration).

In embodiments, the client systems 102 may take advantage of at least factor (a) and (c). In some embodiments a client boot password may be employed, allowing factor (b) to be applied to the VCIRK 704.

Authentication between the client systems 102 and the management system 108 may take any of several forms. In some embodiments the management server 108 authenticates itself to the client through SSL using a server certificate. That certificate may be a commercially issued (e.g., by Verisign, Inc. or the like), but could be privately generated when the certificate's root is an SRK 702.

Authentication of one of the client systems 102 to the management system 108 may involve digest authentication in the case of a user-initiated action. In some embodiments of digest authentication, this one of the client systems 102 may establish an authenticated HTTP session with the management system 108 using digest authentication. Alternatively, it should be appreciate that an NTLM authentication could be used when the management server 108 includes what is known in the art as an Active Directory deployment. Protocols that provide digest authentication will be appreciated.

Authentication of one of the client systems 102 to the management system 108 may involve management end-point authentication. This authentication may involve one of the client systems 102 establishing an authenticated HTTP session with the management server 108 using public key encryption or the like. Similar to digest authentication, this one of the client systems 102 may attempt to initiate an action at the management server 108. This initial attempt may be rejected. In embodiments, such a rejection may include a 401-status message. Perhaps unlike digest authentication, the aforementioned client may transmit a response containing a header to the management server 108, the header that indicating the client's UUID or the like. In addition, the header may include a digital signature of the server's challenge key (alone with other data) using a private signing key of the client. In some embodiments, the client's TPM 504 may have generated this signing key. For example and without limitation, the following pseudo code shows how the digital signature may be generated:

Response=Sign(SHA1(server-challenge, uuid, client-nonce))

Here, Sign may be a signature function; SHA1 may be a SHA1 hash function; server-challenge may be a challenge that the management system 108 includes in the rejection; uuid may be the client's UUID; and client-nonce may be a one-time token that the management system 108 includes in the rejection. It will be understood that a variety of embodiments of the response are possible.

Having received the response, the management server 108 may use a public key (such as may be generated during the client's initial registration) to verify the authenticity of the signature. When the signature is so verified, the management server 108 may carry out the requested action, and return a new authenticated session identifier to that one of the client systems 102 that made the request.

In some embodiments, the management system 108 may include a PKI key management system. In such cases, authentication of the client systems 102 to the management system 108 may involve SSL with client certificates. Also in such cases, an administrator may enable, disable, and renew cryptographic keys. It will be understood that a variety of embodiments that authenticate the client systems 102 to the management systems 108 are possible.

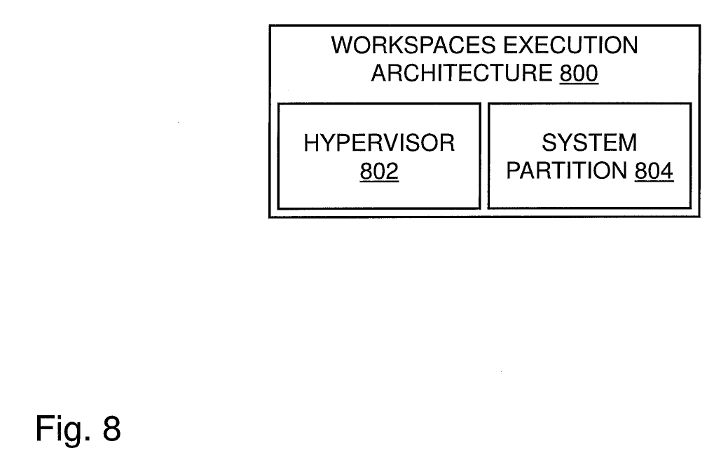

FIG. 8 depicts a Workspaces Execution Engine (WEE) architecture. The WEE architecture 800 may include a hypervisor 802 and system partition 804 containing a privileged virtual machine that has access to physical hardware and also acts as a control domain. In some embodiments, this access may be exclusive such that no other virtual machines have access to the physical hardware.

A WEE may include any and all elements of the workspace execution architecture 800. Embodiments of the WEE may be capable of running multiple virtual machines concurrently. The WEE may provide a variety of kinds of virtualization such as and without limitation the following kinds: hardware virtualization that abstracts hardware from an executing operating systems and applications; operating system virtualization that contains and isolates services for a guest operating system; application virtualization that enables an application to run virtualized on a guest operating system; and user-data virtualization. A variety of embodiments of such virtualization are described herein, and still other embodiments will be appreciated. All such embodiments are within the scope of the present disclosure.

As described hereinabove and elsewhere, embodiments may include at least two types of virtual workspaces. One type may be “user-visible” workspace while the other may be a “system services” or “control domain” workspace.

Instances of the WEE may execute a set of virtual machines. These virtual machines may have access to a user interface of the personal computer on which the instance of the WEE is operating. Each of the user-visible workspaces may run a user accessible operating system. The virtual machines in the user-visible workspaces may have access to at least one of the personal computer's peripherals or ports, such as and without limitation a USB port, a screen, a keyboard, a mouse, and so on. In embodiments, the virtual machines may reuse native, virtualizes, or paravirtualized drivers for these peripherals or ports. Some of the personal computer's devices—such as and without limitation its network interface card (NIC), disk, graphics display components, keyboard, and so on—may be fully virtualized or emulated by a device manager emulator of the WEE. In some embodiments, any and all of these devices may be accessed via a paravirtualized driver model.

The control domain workspace (or a plurality thereof) may execute substantially concurrently with the user-visible workspaces. The control domain workspaces may provide various system level services to manage and maintain user-visible workspaces running on the personal computer. These services may range from user-disks backup, to anti-virus detection, to root-kit detection and so on. It will be understood that a variety of such services are possible.

Within the WEE may exist a particular virtual machine (a “ServiceOS” or “control domain”) that executes physical drivers, runs hardware emulation software, provides virtual workspace device level management, supports security attestation of software stacks, exposes a virtual device to a user-visible virtual machine, downloads a virtual disk image 528 stored in a secured workspace volume 524 from the management system 108, runs or mounts said virtual disk image 528, and so on.

In embodiments, the virtual device may without limitation include a virtual NIC, a virtual graphics component, a virtual disk, a virtual keyboard, a virtual mouse, and so on.

In some embodiments, the hardware emulation software may include a so-called hardware independence layer, which allows a virtual disk image 528 that is tailored for a first machine architecture to run on a personal computer having a second machine architecture. For example and without limitation, machine architectures may include x86, PowerPC, and so on. It will be understood that a variety of machine architectures are possible. Similarly, it will be understood that a variety of embodiments of the hardware independence layer are possible.

The control domain may have access to the personal computer's physical devices such as network devices, disk devices, sound devices, graphics devices, and so on. It will be understood that the control domain may provide virtual versions of these devices to the user-visible workspaces.

The control domain may be capable of downloading virtual workspace images from the management system 108. The control domain may run virtual workspaces as isolated virtual machines that execute end-user visible operating systems. The control domain may maintain a more or less continuous backup of user state or system changes that are stored locally or to the data repository 118.

In embodiments, the WEE may use the TPM 504 to attest to virtual workspace image security. In light of the present disclosure, it should now be understood that the WEE may use PKI to decrypt virtual workspaces that will execute on a personal computer.

In some embodiments, the WEE may provide power management of the virtual environment and the underlying personal computer. The power management may include virtual and real aspects. The virtual activity may be limited to a virtual machine and have no affect on real power. The virtual activity may be controlled a user-visible operating system and may affect the virtual machine on which that operating system is running. For example and without limitation, virtual sleep may put a particular virtual machine into a sleep state, while other virtual machines may continue to operate. Conversely, a real power management activity may operate on physical hardware, and may cause that physical hardware to sleep, hibernate, power on, power off, or the like. In some embodiments, real sleep or standby may be executed only when all virtual machines are in sleep or standby. The WEE may reference a physical CPU's utilization in order to determine the P-state of virtual CPUs. In some embodiments, the WEE may both reference the physical CPU's utilization and the virtual system states in order to determine whether particular physical power management functions are appropriate.

For example and without limitation, the WEE may enable user-visible operating systems to put to sleep (or to hibernate) the virtual machines on which they are running. When all user-visible operating systems are asleep or in hibernation, the WEE may put the underlying personal computer to sleep or into hibernation. For another example and also without limitation, in the WEE may provide a signal (e.g., a low battery signal or some such) to the user-visible operating systems that induces the operating systems to sleep. In another example, the WEE may signal the virtual machines on which the operating systems are operating to suspend. A variety of other such examples will be understood.

In some embodiments, users may identify themselves to the WEE and provide credentials (electronic, biological, or the like) that can be used by the WEE to access the user's workspace. For example and without limitation, as part of logging in a user may enter his WEE username and password. The WEE may then use the username and password to authenticate the user to the management system 108 that stores the user's virtual workspace. Alternatively, the WEE may authenticate the user based upon local data. In any case, authenticating the user may result in the WEE receiving a PKI key pair. In some embodiments, the WEE may receive the key pair from the management system 108. In some embodiments, “receiving” the PKI pair may include using the password to decrypt a private key of the PKI pair to which the WEE already has access, thus providing the WEE with an unencrypted public/private PKI pair.

Access to storage of the management system 108 may be secured. In some embodiments, the HTTPS protocol may secure this access. Access to the storage may also support demand paging or streaming of virtual workspaces from the management system 108 to the client systems 102. In some embodiments, when a particular storage block is unavailable (e.g., due to a network time out, a network failure, or the like) the WEE may cache the block and suspend execution of the affected operating system. When the block becomes available (e.g., due to recovery of a failed network connection, or the like) the WEE may resume execution of that operating system.

Access to the storage of the management system 108 may be direct. In some embodiments, this direct access may involve an application of iSCSI, file sharing, or the like. It will be understood that a variety of embodiments that provide direct access to the storage of the management system 108 are possible.

Embodiments of the WEE may include at least two caches. One cache may be adapted for caching relatively small objects and the other may be adapted to cache copy-on-write disk blocks and the like. Small objects such as virtual machine meta-data, virtualized applications, virtual workspaces meta-data, or the like may be replicated in their entirety within the cache for small objects. Regarding the cache for copy-on-write disk blocks, snapshots of user data may be stored locally in their entirety, before being uploaded to the management system 108 for backup.

The cache for copy-on-write disk blocks may be organized to cache immutable version of disks from repositories. In some embodiments, the WEE may run a pre-fetching process to fetch virtual workspace blocks in the background. This process may check for updates to a virtual workspace that a user uses, and may populate the cache with blocks from virtual workspace when updates are available. In some embodiments, pre-fetching a complete version of a virtual workspace may support disconnected operation in which one of the client systems 102 cannot communicate with the management system 108.

It should be appreciated that storing or backing up elements of the secured workspace volume 524 to the management system 108 may provide relatively high availability of a user's workspace because the stored or backed-up elements may be downloaded to a second one of the client systems 102 in the event that a first one of the client systems 102 fails.

In some embodiments, the WEE may provide a remote-desktop access or the like to any and all of the workspaces running on a personal computer. In such embodiments, a remote client or the like may communicate with the WEE via the network 104 to provide a remote desktop user interface at the remote client. It will be understood that a variety of embodiments of the remote-desktop access and the remote desktop user interface are possible.

In some embodiments, the WEE may run on a network server that provides remote-desktop access or the any and all of the workspaces running on the network server. In such embodiments, the WEE or the workspaces may be said to be “running in the cloud.” For example and without limitation, a user may have access to a computer with a web browser but not a WEE. That user may use the web browser to connect to a suitable web server, that web server having a WEE. After verifying the user's credentials, the WEE may download and instantiate the user's workspace—perhaps just as a personal computer would, as described herein and elsewhere. Then, the WEE may redirect the user's web browser to a webpage providing a remote desktop of the user's workspace that is now running on the server. The user may interact with his workspace via the remote desktop. At the conclusion of the user's session, all modifications to the virtual disk images 528 of the user's workspace that have not already been committed to data repository 118 may be so committed. A variety of other such examples will be appreciated.

In some embodiments, the WEE may destroy the secured workspace volume 524 more or less on the fly, perhaps in response to a trigger, timeout, expiration, or the like. For example and without limitation, in a secure governmental computing environment, a user may access a secured workspace volume 524 or workspace that automatically self-destructs after a period of time. Also for example and without limitation, a temporary worker or contractor may be granted limited-time access to a secured workspace volume 524 or workspace. That limited-time access may expire at the end of the contactor's term of service. In another example, also without limitation, a traveling worker may be granted access to a secured workspace volume 524 or workspace on a mobile computer. In order to protect against theft of the mobile computer and the secured workspace volume 524 or workspace, the mobile computer may destroy the secured workspace volume 524 or workspace if a certain number of sequential login attempts fail. Still other examples will be appreciated, and all such examples are within the scope of the present disclosure.

The WEE may provide a variety management functions that provide or are related to any and all of the following tasks or modes or operation: machine lockdown; system updates; backups; system and data recovery; mobile computing; disconnected operation; web-based virtual machine management; creation of workspace policies; integration to an enterprise database application; hardware object management; and so on. Any and all of the WEE's management functions may be accessible to all users, to a particular subset or group of users, to an administrator only, and so on.

Machine lockdown may involve creating a new copy-on-write disk image, booting from that disk image, and then discarding the disk image upon shutdown.

System updates may, without limitation, include applying security patches to an operating system or application; installing new software; upgrading an operating system to a new version; reinstalling or installing an operating system; publishing a workspace; bringing a workspace into a known state (e.g., by resetting certain system settings or application settings to known values; by reverting a virtual disk image 528 to a previous, known virtual disk image 528; and so on); distributing a master virtual hard disk image to a plurality of users (as described hereinabove with reference to FIG. 1 and elsewhere); and so on.

In embodiments, creation of workspace policies may include, without limitation, any and all of the following acts: activating and authenticating policies with Microsoft Active Director Integration or another type of user database; changing passwords with Microsoft Active Directory Password Change Proxy; setting a timeout value on one of the client systems 102 or for a secured workspace volume 524; managing encryption settings; determining how long a workspace is allowed to run before requiring a call-back to the management system 108 for verification, updates, or the like; specifying data backup policies; setting wired or wireless resource privileges; defining which users have access to a USB device or USB port; setting user display privileges, such as and without limitation enabling or disabling a built in display or external display port of a personal computer; defining a default setting for workspace execution; specifying a storage location, which may without limitation include a network location of the management system 108, a network location of a network attached storage device, a network location of a network-based storage location, and so on; setting a timeout; setting an expiration; and so on.

In embodiments, integrating with an enterprise database application may include embedding the data repository 118 or a portion thereof within the enterprise database application. In such embodiments, the enterprise database application may include the management system 108.

In embodiments, the hardware object management may include tracking an active hardware configuration, editing a hardware configuration, and so on.

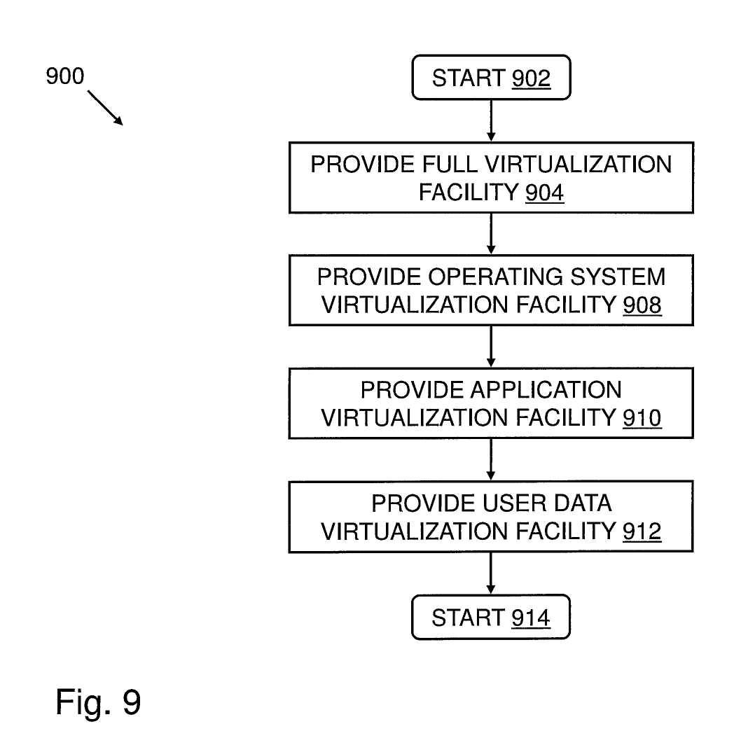

FIG. 9 depicts a method of providing a virtualized workspace. The workspace may be associated with a computer having an operating system. The method 900 begins a block 902 and continues to block 904, where the method 900 provides a full virtualization facility for abstracting the computer's hardware from the operating system and from applications running on the computer. In embodiments, the full virtualization facility may include a WEE. In some embodiments the WEE may use the hypervisor 802. At block 908, the method 900 may provide an operating system virtualization facility for containing and isolating operating system services from each other and applications. In some embodiments, the operating system virtualization facility may include the hypervisor 802. At block 910, the method 900 may provide an application virtualization facility for allowing at least one application to run virtualized on an operating system of the computer. In some embodiments, the application virtualization facility may include the virtual workspace specification 200, or any and all elements thereof. At block 912, the method 900 may provide a user data virtualization facility for containing and isolating user data from the hardware, the operating system and the applications. In some embodiments, the user data virtualization facility may include the device manager emulator of the WEE. The method may end at block 914.

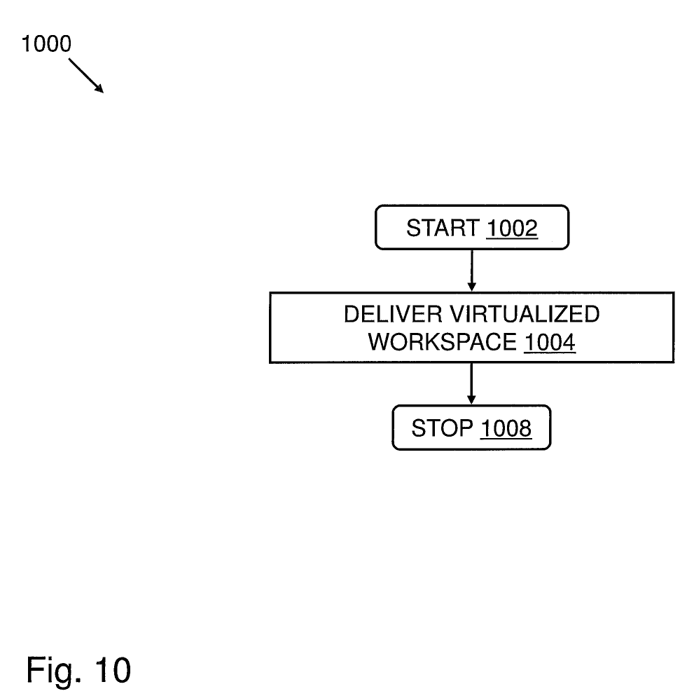

FIG. 10 depicts a method of delivering a virtualized workspace. The method 1000 begins at block 1002 and continues to block 1004, where the method 1000 delivers a virtualized workspace to a computer. The virtualized workspace may include a virtual machine disk image and the computer may be one of the client systems 102. The virtual machine disk image may include the virtual machine image 202. In some embodiments, the virtualized workspace may include an operating system, applications, and end user data encapsulated and packaged as a virtual machine, which may itself be embodied as a secured workspace volume 524. The method may end at block 1008.

In some embodiments, delivering the virtualized workspace may further comprise the following: providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications. As described hereinabove and elsewhere, the full virtualization facility may abstract a computer's hardware from software running on the computer such as an operating system and applications. As described hereinabove and elsewhere, the operating system virtualization facility may contain and isolate operating system services from each other and applications. As described hereinabove and elsewhere, the application virtualization facility may allow at least one application to run virtualized on an operating system of the computer.

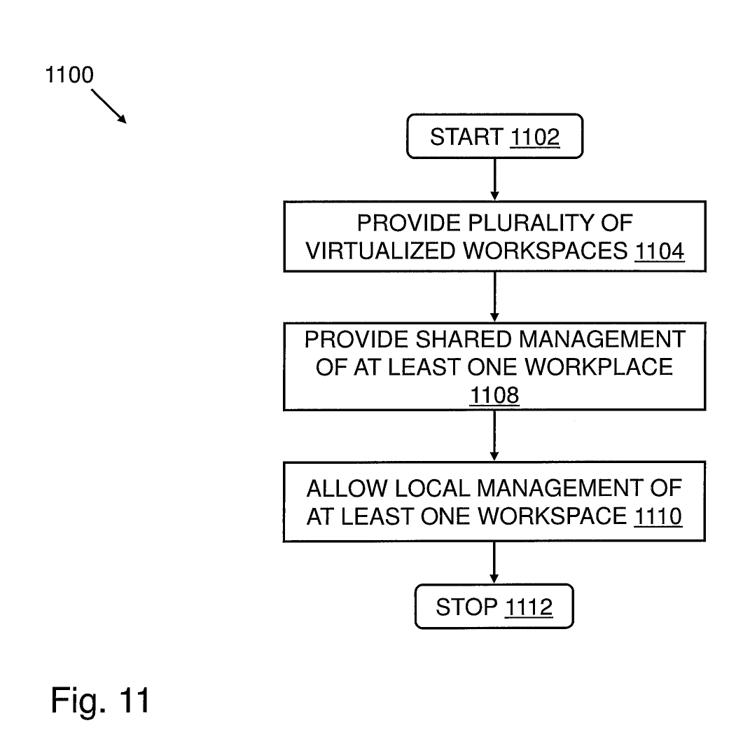

FIG. 11 depicts a method of providing security for virtualized workspaces. The method 1100 begins at block 1102 and continues to block 1104, where the method 1100 provides a plurality of virtualized workspaces for operating on the same computer, each workspace embodied in at least one virtual machine disk image. At block 1108, the method 1100 provides shared management of at least one workspace, using at least one root disk image adapted for use by a plurality of users of a plurality of centrally managed desktops. At block 1110, the method 1100 allows local management of at least one other workspace, the management of the other workspace not being subject to at least one constraint applicable to the centrally managed workspace. The method may end at block 1112.

It follows that any one of the client systems 102 may have both a centrally managed workspace and a locally managed workspace. These workspaces may co-exist and run substantially simultaneously in complete isolation from one another. It should be understood that both workspaces might have access to shared resources such as a keyboard, audio output, graphics processing unit (GPU), CPU, or the like, and that the client system's 102 WEE or other virtualization component may manage this access.

For example and without limitation, a user may have a workspace for work-related use and workspace for home-related use. An administrator at the user's place of work may centrally manage the workspace for work-related use. The administrator may apply a constraint to this workspace, the constraint limiting the user's ability to install an application into the workspace. This constraint may not apply to the home-related workspace, which the user locally manages. A variety of other such examples will be appreciated.

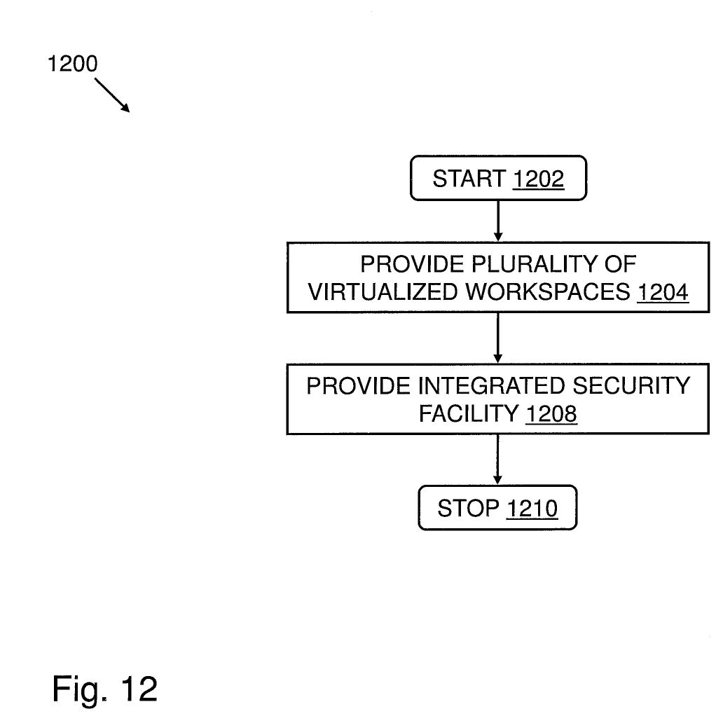

FIG. 12 depicts a method of embodying a virtualized workspace. The method 1200 begins at block 1202 and continues to block 1204, where the method 1200 provides a plurality of virtualized workspaces for operating on the same computer, each workspace embodied in at least one a virtual machine disk image. At block 1208, the method 1200 provides an integrated security facility for managing security with respect to at least a plurality of the virtualized workspaces. The method may end at block 1210.

In some embodiments the integrated security facility may allow full management of security of an operating system from outside the operating system. In some embodiments, the integrated security facility may allow management of the memory of an operating system from outside the operating system. In some embodiments, the integrated security facility may allow management of an operating system from outside the operating system using the hypervisor 802.

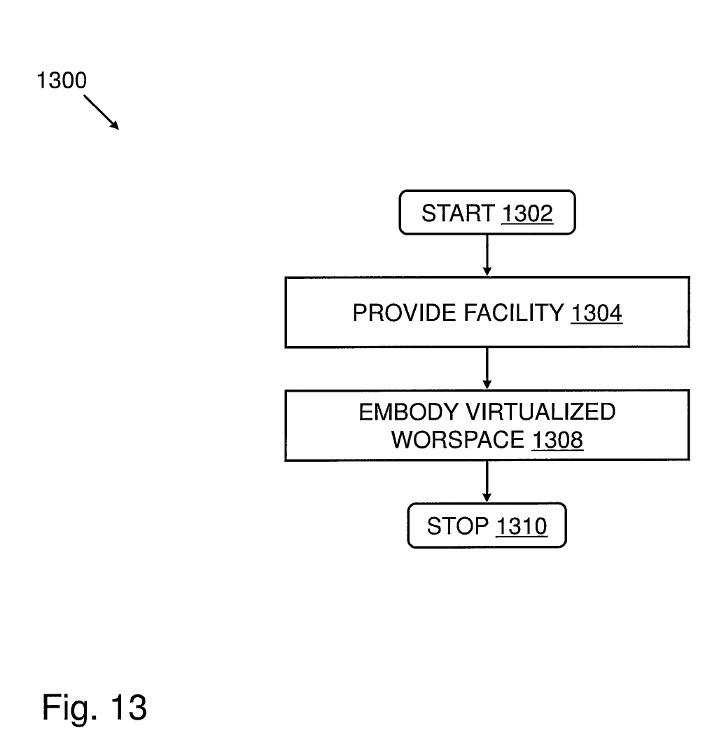

FIG. 13 depicts a method of embodying a virtualized workspace. The method 1300 begins at block 1302 and continues to block 1304, where the method 1300 provides a facility for managing a virtualized workspace adapted to operate on a computer. In embodiments, the facility for managing a virtualized workspace may include the control domain or any component thereof. At block 1308, the method 1300 embodies the virtualized workspace as a set of virtual disk images to facilitate transporting the workspace to a different computer for operation of the workspace without necessitating installation of an operating system component on the second computer. Such an embodiment of the virtualized workspace may include the secured workspace volume 524, any and all of the virtual disk images 528 therein, and so on. The method may end at block 1310.

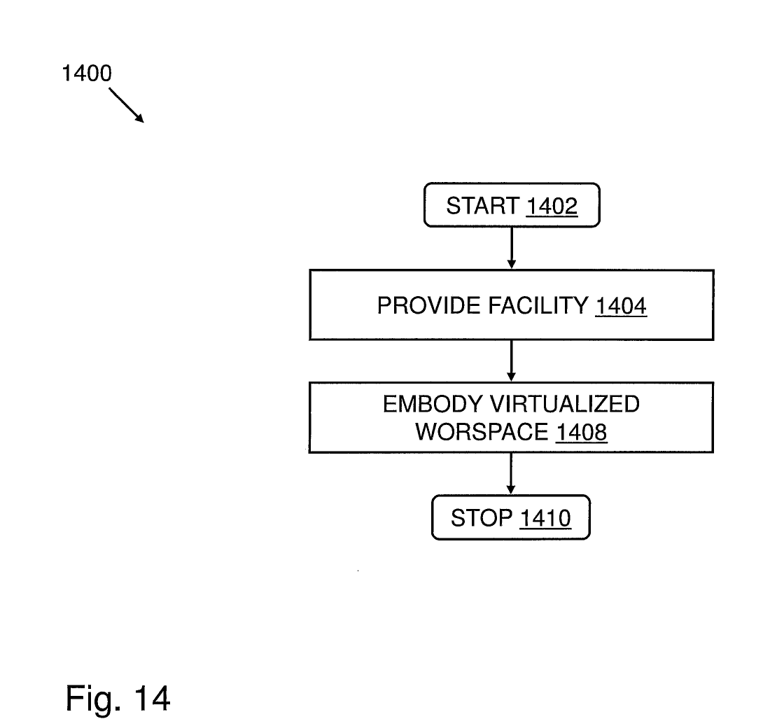

FIG. 14 depicts a method of providing a virtualized workspace. The method 1500 begins at block 1402 and continues to block 1404, where the method 1400 may provide a facility for managing a virtualized workspace adapted to operate on a computer. At block 1404, the method may embody the virtualized workspace as a set of virtual disk images to facilitate transporting the workspace to a different computer independent of the configuration of the hardware of the second computer. In some embodiments, the second computer may include a control domain 514 or the like that virtualizes the hardware of the second computer, providing a virtual hardware for which the workspace is adapted and on which the workspace may be executed. The method may end at block 1408.

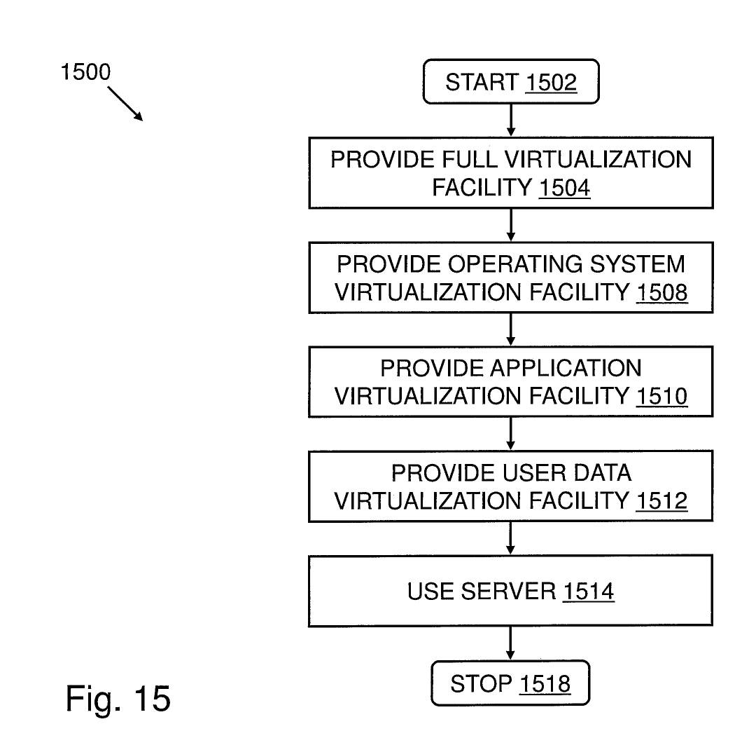

FIG. 15 depicts a method of providing a virtualized workspace. The virtualized workspace may be associated with a computer having an operating system. The method 1500 begins a block 1502 and continues to block 1504, where the method 1500 may provide a full virtualization facility for abstracting the computer's hardware from the operating system and from applications running on the computer. At block 1508, the method 1500 may provide an operating system virtualization facility for containing and isolating operating system services from each other and applications. At block 1510, the method may provide an application virtualization facility for allowing at least one application to run virtualized on an operating system of the computer. At block 1512, the method 1500 may provide a user data virtualization facility for containing and isolating user data from the hardware, the operating system and the applications. At block 1514, the method 1500 may use a server to provide remote access to a virtualized workspace on a client device. In some embodiments, the server may include the management system 108 and the client device may be one of the client systems 102. The method may end ay block 1518.

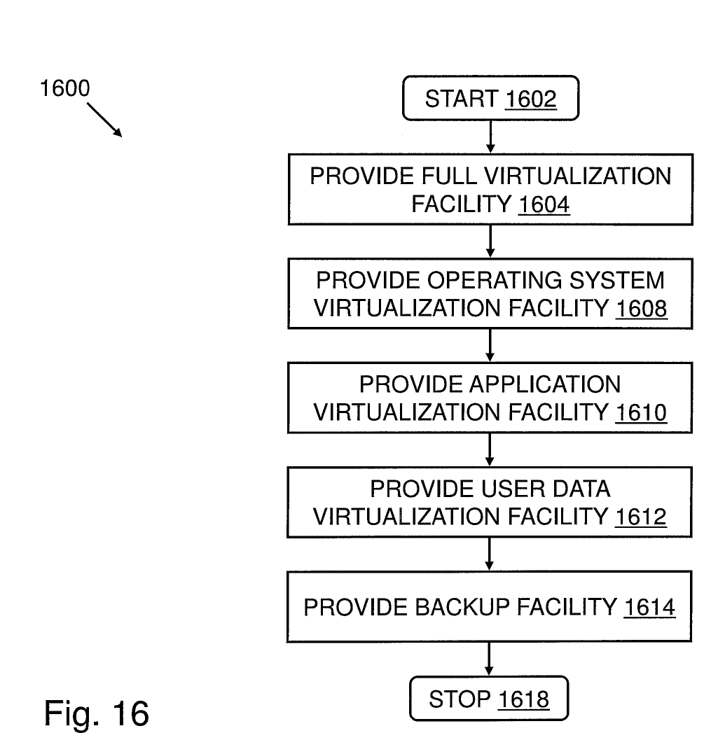

FIG. 16 depicts a method of providing virtualized workspaces. The virtual workspaces may be associated with a computer having an operating system. The method 1600 begins at block 1602 and continues to block 1604, where the method 1600 may provide a full virtualization facility for abstracting the computer's hardware from the operating system and from applications running on the computer. At block 1608, the method 1600 may provide an operating system virtualization facility for containing and isolating operating system services from each other and applications. In some embodiments the operating systems services may include a graphics display driver, an audio device driver, a peripheral driver, a process scheduler, a disk driver, and so on. It will be understood that a variety of operating system services are possible. At block 1610, the method 1600 may provide an application virtualization facility for allowing at least one application to run virtualized on an operating system of the computer. At block 1612, the method 1600 may provide a user data virtualization facility for containing and isolating user data from the hardware, the operating system and the applications. And, at block 1614, the method 1600 may provide a backup facility to allow instant, hardware-agnostic access to the virtualized workspace. In some embodiments the backup facility may include a remote backup facility, such as and without limitation the management system 108 or the data repository 118 thereof. In some embodiments the backup facility may include a local backup facility, such as and without limitation a virtual disk image 528, a storage devices attached to the computer, and so on. It will be understood that a variety of backup facilities are possible. The method 1600 may end at block 1618.

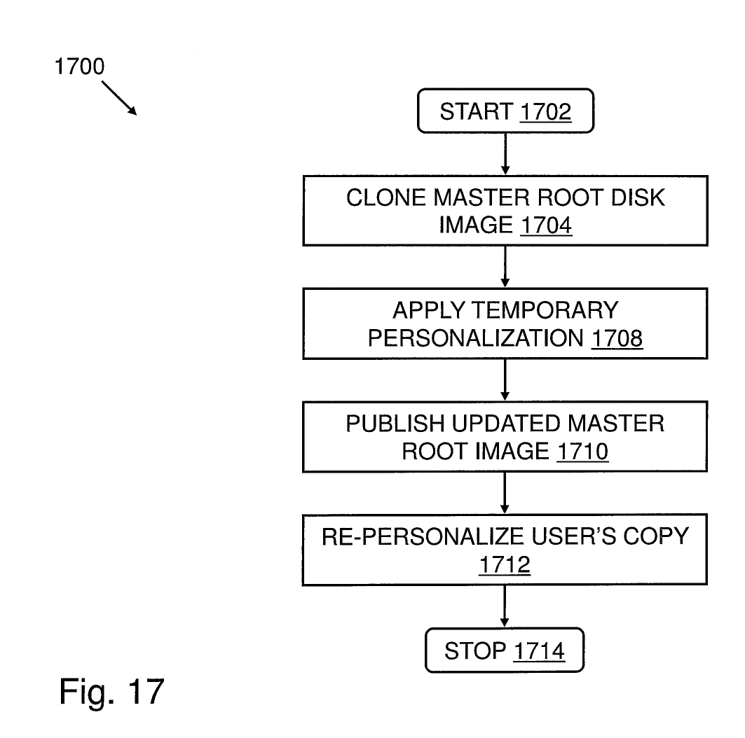

FIG. 17 depicts a method of updating a plurality of virtualized workspaces. The method 1700 begins at block 1702 and continues to block 1704, where the method 1700 clones a master root disk image. At block 1708, the method 1700 may apply temporary personalization to a clone of the master root disk image. In some embodiments, the clone of the master root disk image may include the unsecured bootloader volume 512 and the personalization may include an updated key 510. At block 1710, the method 1700 may publish the updated master root image to a plurality of users, wherein publishing omits at least a portion of the personalization applied to the clone of the master root disk image. At block 1712, the method may, based at least in part on the clone, re-personalize a user's copy of the published master root disk image for use on the user's local computer. Re-personalizing the user's copy may include modifying a parameter embodied in the master root disk image. In embodiments, the parameter may include a computer name, a user account identifier, a system identifier, a hard variable of an operating system, and so on. In some embodiments, re-personalizing the user's copy may include providing a seal 508 that is adapted, as described hereinabove and elsewhere, to be broken by the local computer's TPM 504. The method may end at block 1714.

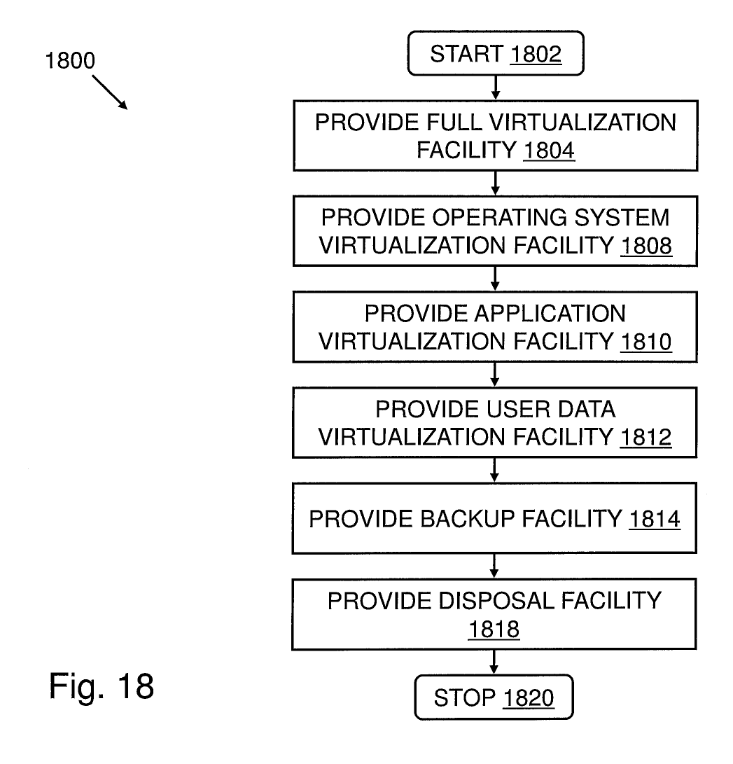

FIG. 18 depicts a method of providing a virtualized workspace. The virtualized workspace may be associated with a computer having an operating system. The method 1800 begins at block 1802 and continues to block 1804, where the method 1800 provides a full virtualization facility for abstracting the computer's hardware from the operating system and from applications running on the computer. At block 1808, the method 1800 may provide an operating system virtualization facility for containing and isolating operating system services from each other and applications. At block 1810, the method 1800 may provide an application virtualization facility for allowing at least one application to run virtualized on an operating system of the computer. At block 1812, the method may provide a user data virtualization facility for containing and isolating user data from the hardware, the operating system and the applications. At block 1814, the method 1800 may provide a backup facility to allow instant, hardware-agnostic access to the virtualized workspace. At block 1818, the method 1800 may provide a disposal facility for disposing of the entire virtualized workspace. In some embodiments, the disposing may be in response to a user action, upon expiration of a time period, based on a policy, triggered upon violation of a policy, or the like. The method may end at block 1820.

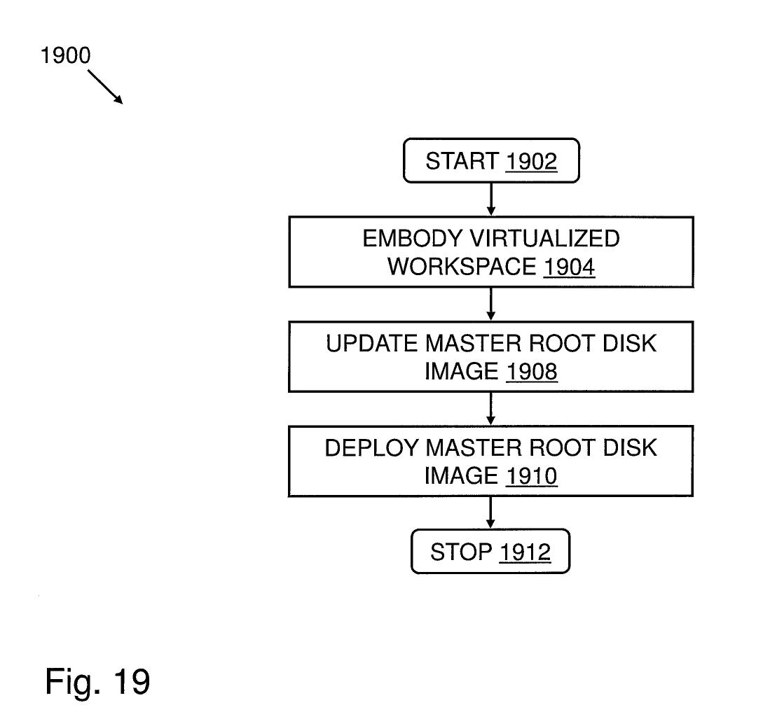

FIG. 19 depicts a method of updating a virtualized workspace. The virtualized workspace may be associated with a computer. The method 1900 begins at block 1902 and continues to block 1904, where the method 1900 embodies a virtualized workspace in a master root disk image. At block 1908, the method 1900 updates the master root disk image. At block 1910, the method 1900 deploys the master root disk image to a plurality of computers. The method may end at block 1912.

In some embodiments virtualizing the workspace may include providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications.

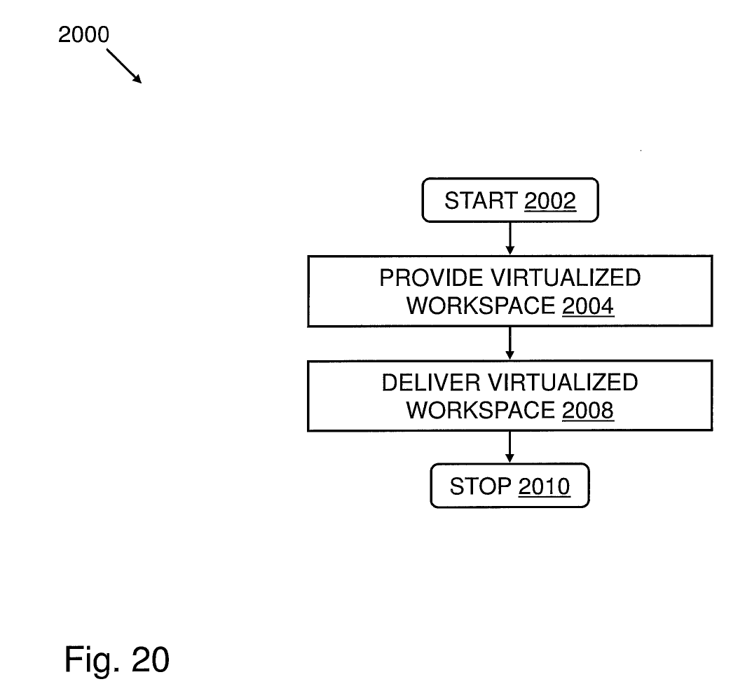

FIG. 20 depicts a method of delivering a virtualized workspace. The method 2000 begins at block 2002 and continues to block 2004, where the method 2000 provides a virtualized workspace. At block 2008, the method 2000 may deliver the virtualized workspace by streaming data from a central computer to a remote computer for use of the virtualized workspace on the remote computer. In some embodiments the central computer may include the management system 108 and the remote computer may include one of the client systems 102.

In some embodiments virtualizing the workspace may include providing a full virtualization facility for abstracting the computer's hardware from the operating system and from applications running on the computer; providing an operating system virtualization facility for containing and isolating operating system services from each other and applications; providing an application virtualization facility for allowing at least one application to run virtualized on an operating system of the computer; and providing a user data virtualization facility for containing and isolating user data from the hardware, the operating system and the applications.

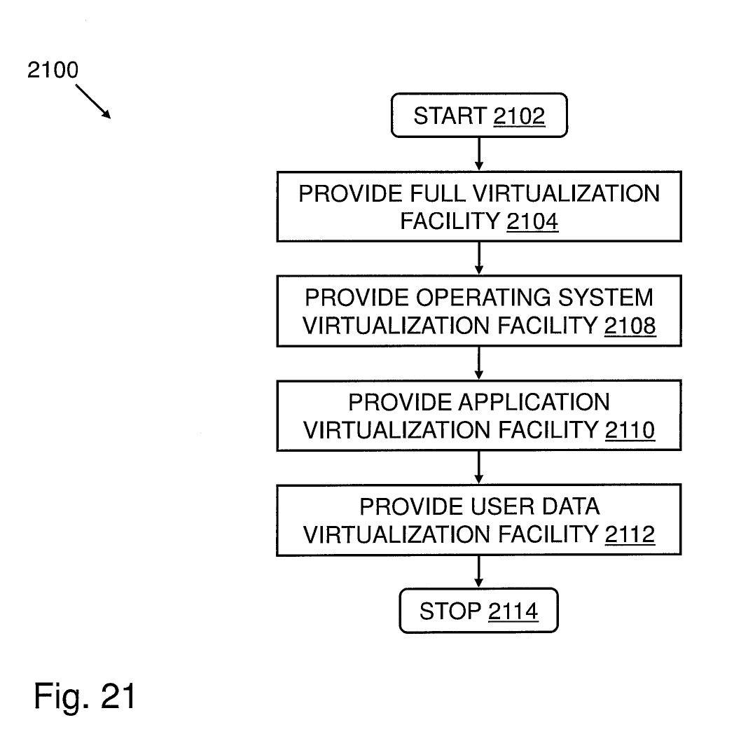

FIG. 21 depicts a method of providing a virtualized workspace. The virtual workspace may be associated with a mobile computer having an operating system. The method 2100 begins at block 2102 and continues to block 2104, where the method 2100 provides a full virtualization facility for abstracting the computer's hardware from the operating system and from applications running on the computer. At block 2108, the method 2100 provides an operating system virtualization facility for containing and isolating operating system services from each other and applications. At block 2110, the method 2100 provides an application virtualization facility for allowing at least one application to run virtualized on an operating system of the computer. At block 2112 the method provides a user data virtualization facility for containing and isolating user data from the hardware, the operating system and the applications. The method may end at block 2114.

The mobile computer may be one of client systems 102. In embodiments, the mobile computer may include a laptop computer, a handheld computer, a smart phone, a point of sale device, or the like. It will be understood that a variety of embodiments of the mobile computer are possible.

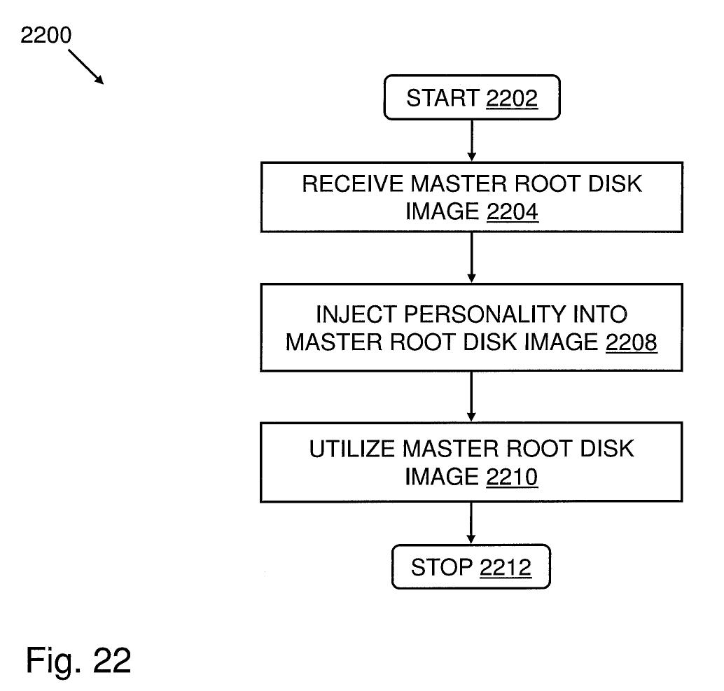

FIG. 22 depicts a method of personalizing a master root disk image. The method 2200 begins at block 2202 and continues to block 2204, where the method 2200 receives a master root disk image. Then, at block 2208 the method 2200 injects a personality into the master root disk image. This is described in detail hereinabove and elsewhere. At block 2210 the method 2200 utilizes the master root disk image. Without limitation, utilizing the master root disk image may include mounting the master root disk image, running an application on the master root disk image, booting from the master root disk image, accessing data that is stored within the master root disk image, and so on. The method may end at block 2212.

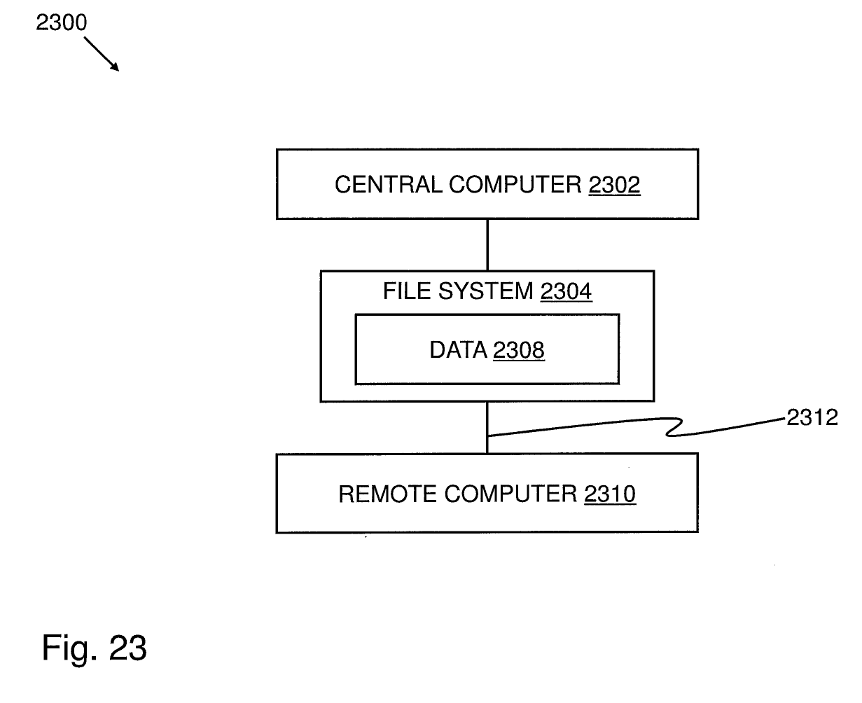

FIG. 23 depicts a system that provides a virtualized workspace. The system 2300 includes a central computer 2302, a file system 2304 that is operatively coupled to the central computer 2302, and data 2308 stored in the file system 2304. Also depicted are a remote computer 2310 and an operative coupling 2312 between the remote computer 2310 and the file system 2304.

The central computer 2302 may include the computing center 114. The file system 2304 may include the data repository 118. In embodiments, the operative coupling between the file system 2304 and the central computer 2302 may include an iSCSI connection, a Fibre Channel connection, a file sharing protocol running over an Internet Protocol network, or the like. It will be understood that a variety of operative couplings are possible.

The data 2308 may include any and all of the data described herein and elsewhere. This may include, without limitation, a workspace, user data 124, a system disk image 128, a virtual workspace specification 200 or the elements thereof, an unsecured bootloader volume 502 or the elements thereof, and so on and so forth. In embodiments, the data 2308 may be adapted to provide a virtualized workspace on the remote computer 2310 when run on the remote computer 2310.

The remote computer 2310 may be any one of the client systems 102. The operative coupling 2312 between the remote computer 2310 and the file system 2304 may include the network 104. It should be understood that the operative coupling 2312 may also include any and all suitable protocols for communicating between the remote computer 2310 and the file system 2304. Such protocols may include iSCSI, Network File System, a peer-to-peer protocol, and so on. A variety of such protocols will be appreciated.

From time to time, the remote computer 2310 may access or modify the data 2308. Also from time to time, the central computer 2302 may access or modify the data 2308.

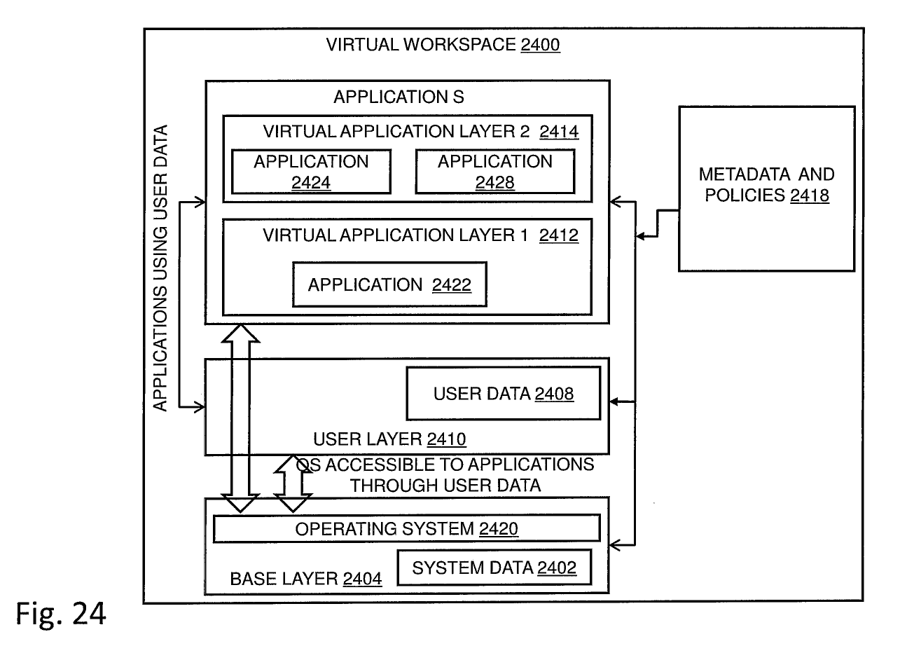

A layered virtual file system may operate cooperatively with virtualization. FIG. 24 depicts components of a virtual workspace that may be present within a computing facility, such as a desktop computer, a laptop, a Personal Digital Assistant (PDA), and other similar computing devices. The virtual workspace 2400 may be an active instance of a layered virtual file system namespace. The virtual workspace 2400 may invoke a namespace upon activation of the virtual workspace 2400. The namespace may be referred to by the virtual workspace 2400 and may include a collection of system data 2402 within a base layer 2404, user data 2408 within a user layer 2410, one or more virtualized applications such as a virtual application layer 2412 and a virtual application layer 2414, and metadata and policies 2018 that may define the layered virtual file system layer scope. The virtual workspace 2400 may include software such as an operating system 2420 and one or more applications in addition to the user data 2408. Accordingly, a virtual workspace 2400 may be aligned with the namespace so that the operating system 2420 of the virtual workspace 2400 may be accessible through the user layer 2410. Further, one or more applications executing on the operating system 2420 may be located at an upper virtual application layer. Furthermore, the user data 2408 in the virtual workspace 2400 may be found at any layer or above the user layer 2410.

Alternative relationships among virtual workspaces, operating systems, applications, user data, and a layered virtual file system file system elements such as the base layer 2404, the user layer 2410, the one or more virtual application layers 2012 and 2014, unmanaged data, and a Workspace Execution Engine may be appreciated and are included herein.

The layered virtual file system may manage access to the base layer data to ensure proper use of the data in the base layer 2404. In a way that may be similar to how a hypervisor may manage access to underlying computing facility resources such as hardware to ensure proper operation of the hardware by users and applications in a plurality of virtual workspaces, the base layer 2404 may be virtualized across a plurality of namespaces and virtual layers.

The base layer 2404 may be pertinent to the proper interoperation of the user layers and virtual application layers, so protecting it via the policies of a layered virtual file system may ensure that changes made by a user or application do not affect any other namespace.

Alternatively, the layered virtual file system may work cooperatively with virtual workspaces in many different ways. The virtual workspace may be an embodiment of one or more virtual application layers, a user layer 2410, a base layer 2404, and the like. A virtual workspace may exist for each of the base, user, and each virtual layer. Each virtual workspace may use the layered virtual file system to resolve access to data so that virtual workspaces that are aligned within a namespace may access data according to certain layered virtual file system rules and policies. At least in this way, a layered virtual file system may allow virtual workspaces to share data.

Although a layered virtual file system may include unmanaged namespaces, a hypervisor may manage these namespaces or portions thereof, such as paging files, registry hives, layered virtual file system metadata and control information, and the like. Alternatively, a hypervisor may provide a virtual workspace in which an instance of the layered virtual file system may operate.

An instance of a layered virtual file system may be associated with an instance of a virtual operating system as described herein to provide file and registry management, and access for the various users and applications executing within the virtual operating system. In this way, a namespace may be associated with each user of the operating system, with each application that starts automatically when the operating system starts, print drivers, communication drivers, and the like.

Embodiments deliver an operating system and software applications to a personal computer. The operating system and software applications may be managed and configured at a central location prior to delivery. User data or a system disk image that is created or modified on the personal computer by the operating system or applications may, from time to time, be stored at the central location. When a user switches from one personal computer to another, the user's data may be transferred from the central location to the user's current computer. Additionally, the user's current computer may receive suitable versions of the operating system and applications from the central location. In any case, the operating system and software applications may run with a domain of execution that is provided by a hypervisor. Thus, the operating system and software applications may operate within a virtualized machine, perhaps alongside and in isolation from other operating systems and software applications.

Throughout this disclosure, a “workspace”, “virtual workspace” or “virtualized workspace” may refer to a collection of system data, user data, and virtualized applications, metadata, and policies. In some cases, the workspace, virtual workspace or virtualized workspace may be characterized by an environment definition (i.e., an execution environment meeting software requirement of a user) and a resource allocation that includes CPU, memory, and network bandwidth allocation parameters. In embodiments the workspace, virtual workspace or virtualized workspace may include software such as an operating system and one or more applications, in addition to user data, any number of policies, and so on. In embodiments, the operating systems may be configured for use and fully updated with patches, bug fixes, and the like. Since the workspace may contain a pre-installed operating system, execution of the workspace on a personal computer may proceed without performing an operating system installation process on the personal computer. In embodiments, the policies may be pre-configured and may include security policies, usage policies, application and system preferences, and the like. In some embodiments, the operating system may include any and all versions of the following operating systems, including, without limitation, equivalents or derivatives thereof: Microsoft Windows, Unix, Linux, Mac OS X, and so on.

When a copy of a workspace is run on a suitable personal computer, that copy of the workspace may produce a user experience. In some embodiments, the user experience may be a substantially conventional user experience. For example, the user experience may be one in which a user runs the applications within a windowed, graphical user interface that is provided by the operating system. For another example, the user experience may be one in which a user runs applications from a command-line or console within a textual user interface that is provided by the operating system.

The suitable personal computer (herein, “personal computer”) may be a computer having within it a virtualization software framework, which includes a hypervisor and a privileged virtual machine that runs a Workspaces Execution Engine (WEE). In embodiments, the WEE may download, cache, and run a copy of a workspace in addition to backing up copies of the workspace's user data or system disk image to a network repository or the like. The privileged virtual machine may run within privileged domain of execution, which may be variously referred to in the art as a “control domain” or “DOM zero.”

In some embodiments, the WEE may utilize what is known in the art as a Trusted Platform Module (TPM) or the like to attest to the security or authenticity of the WEE software, of the workspace, and so on.

In some embodiments, the WEE may provide a suite of management functions including, without limitation, disk imaging, machine lockdown, software updates, backups, systems and data recovery, mobile computing functions (e.g., for energy saver functions, network roaming functions, and so on), caching, pre-fetching, streaming, and so on. Additional management functions may be described herein, and still others will be appreciated. All such management functions are within the scope of the present disclosure.

It should be understood that the hypervisor may manage the execution of the privileged domain and any number of non-privileged domains (referred to in the art as “guest domains”) It should also be understood that the hypervisor may provide total isolation between the domains while also providing each domain with access to the common underlying resource. Without limitation such resources may include disk, CPU, network, and so on. In some embodiments, all or part of the hypervisor may be implemented in hardware, or may rely on built-in hardware virtualization functions. In some embodiments, the hypervisor may be software-based and may depend upon some or all of the operating systems being patched to support virtualization. It will be understood that a variety of embodiments of the hypervisor are possible. All such embodiments are within the scope of the present disclosure.

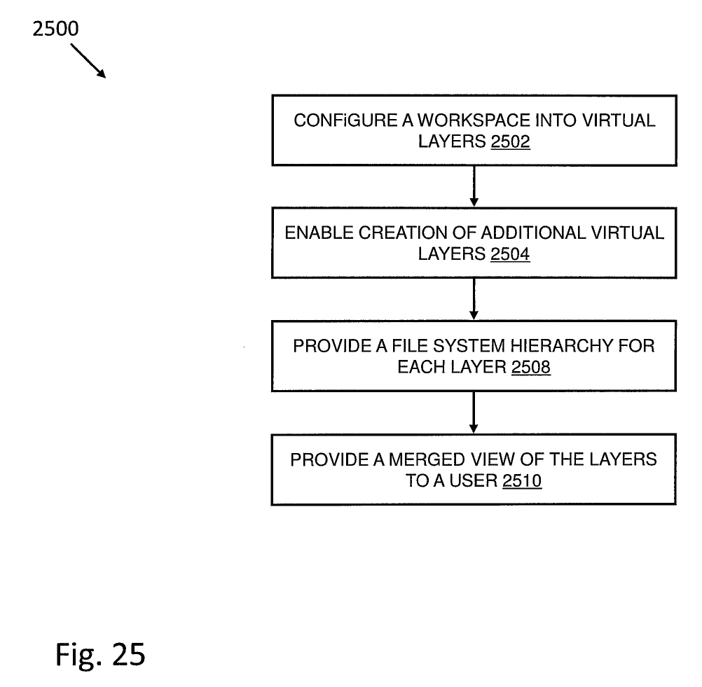

FIG. 25 depicts a method 2500 of providing a virtualized workspace. The method 2500 begins at block 2502 and continues to block 2504, where the method 2500 may configure a workspace of a computing facility into a plurality of virtual layers (hereafter referred as ‘virtual layers’). The virtual layers may include a base layer and/or a user layer. The base layer may be configured as the bottom most layer of the virtual layers. The base layer may be defined as a layer that may consist of the operating system, and applications and utilities as determined by an administrator. The base layer may be untainted by any user customization. The base layer may be the lowest virtual layer and may be isolated from all changes by the virtual layers above. In an embodiment, the base layer may be configured by the server administrator.

In an embodiment, the user layer may consist of user documents and settings, applications and any other customization installed by the user at the computing facility. The folders and files in the base layer, and the user layer may be determined dynamically based on how and by whom (administrator or user) they are created.

At block 2504, the method 2500 may enable the creation of additional virtual layers. In an embodiment, an administrator may create virtual application packages on a server. Creating such a package may be done by installing an application and capturing a resulting virtual file system and registry changes. The package may be pushed down on the computing facility. The package may be referred as a virtual application layer. In another embodiment, an administrator may create other packages or layers of data, such as virus checker packages or signature update packages. As with virtual application layers, these layers may be pushed down to the computing facility.

At block 2508, the method 2500 may provide each of the virtual layers with a corresponding file system hierarchy. In an embodiment, file system hierarchies of the virtual layers may be transparently overlaid such that a file system hierarchy (referred as ‘first file system hierarchy’) in a first virtual layer may be configured above a file system hierarchy (referred as ‘second file system hierarchy’) in a second virtual layer. The first file system hierarchy may have priority over the second file system hierarchy. In an embodiment, each layer may also correspond to a hierarchical New Technology File System (NTFS) and a hierarchical registry of keys and values. Registry keys may be analogous to file system folders and registry values may be analogous to file system files.

At block 2510, the method 2500 may provide a merged view of the virtual layers overlaid on one another to a user of the computing facility. In an embodiment, the merged view may provide a view of the virtual file system such that the presence of the virtual layers and overlaid prioritized file system hierarchy may be transparent to the user. In addition to the merged view being transparent to the user, the merged view may also be transparent to a software application, an operating system, a network, a user interface, and any other software to which the merged view may be accessible.

Accordingly, the resulting merged view may appear as a single coherent file system. In an embodiment, directories in each layer with the same path name may have their contents merged in the merged view. Further, files in an upper layer, such as a virtual application layer may have priority over files with the same path name in a lower layer, such as the user layer so that these upper layer ‘same named’ files are accessible in the merged view. Because changes to upper layer files do not change the content of identically named lower layer files, a state of a virtual workspace may be restored simply by removing the upper layer so that the lower layer files are accessible in the merged view.

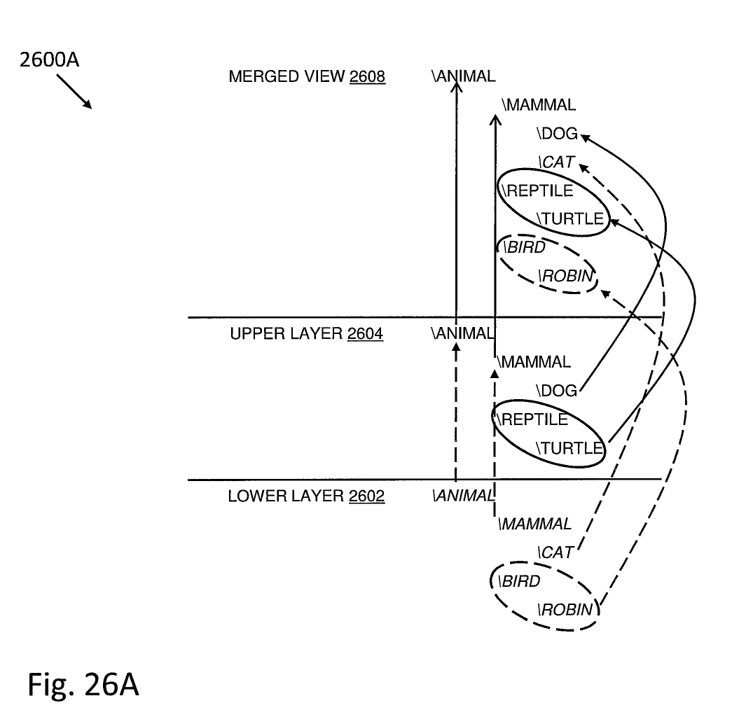

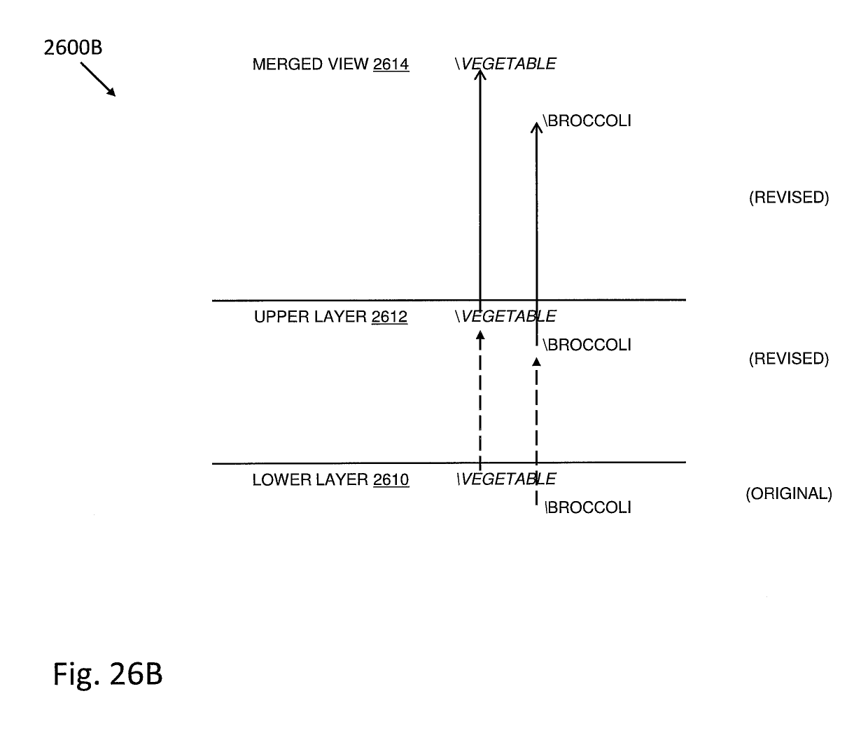

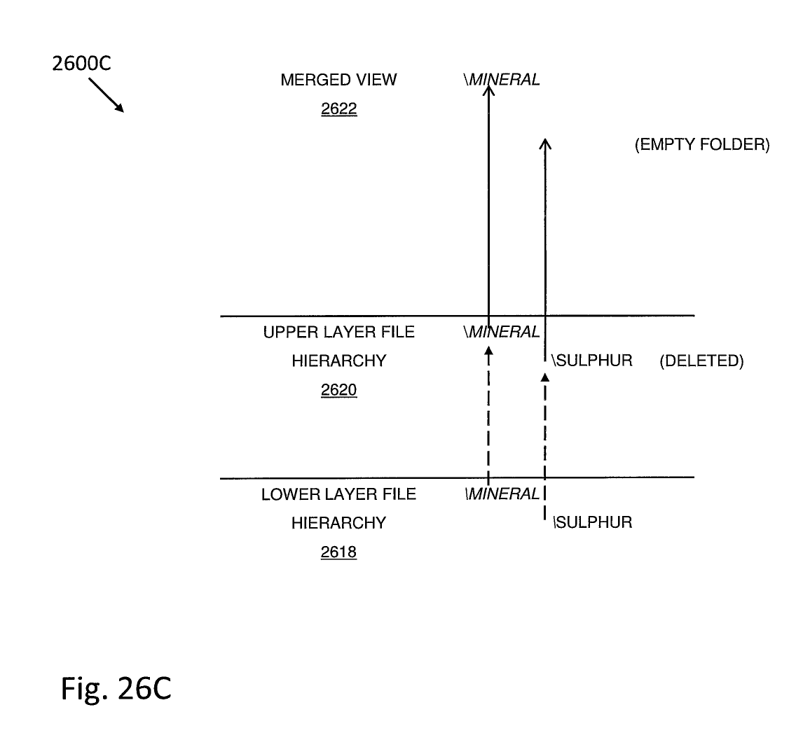

FIG. 26A depicts how a merged view may be constructed from two layers of a virtual file system. FIG. 26A includes a lower layer 2602 with a layer-specific file system hierarchy, an upper layer 2604 with a layer-specific file system hierarchy, and a merged view 2608 with a merged view file system hierarchy. The merged view 508 may contain a union of the upper and lower layers that conforms to layer hierarchy rules of the layered virtual file system.

The upper layer-specific file system hierarchy and the lower layer-specific file system hierarchy each include a file with the same name. The merged view file system hierarchy depicts a file in the upper layer 2604 that may obscure the file with the same name in the lower layer 2602. Rules associated with the layered virtual file system may determine that files in the upper layer 2604 may take precedence over files in the lower layer 2602 when the two layers are combined in a merged view.

Referring now to FIG. 26B, which depicts virtual layers of a layered virtual file system to demonstrate how a file that is resident in both an exemplary lower layer 2610 and an exemplary upper layer 2612 may be only changed in the upper layer 2612. Prior to a user making any changes to the /vegetable/broccoli file, the file was only resident in the lower layer 2610. However, when a user attempts to change the \vegetable\brocolli file, for example by saving a changed copy of the file, the changed file may be stored in the upper layer 2612. Further changes may be made to the copy of the file that is stored in the upper layer 2612 and the user may see only the changed file as stored and updated in the upper layer 2612. The original file in the lower layer 2610 may be obscured in the merged view 2614. By enforcing the upper layer priority, changes to a file may be backed out of an instance of the virtual file system by copying the file from the lower layer 2610 to the upper layer 2612.

Referring now to FIG. 26C, virtual layers of a layered virtual file system are depicted to demonstrate how a file that exists in an exemplary lower layer 2618 and is logically deleted from an exemplary upper layer 2620 may not appear in a merged view 2622 of the upper and lower layers. The \mineral\sulphur file may be logically deleted from the upper layer 2620. The lower layer 2618 may have a file named \mineral\sulphur. However, the \mineral\sulphur file in the lower layer 2610 may be obscured in the merged view 2622. By enforcing the upper layer priority, logical deletion of a file in the upper layer 2620 may obscure the \mineral\sulphur in the lower layer 2618.

In an embodiment, all changes may be made in the virtual application layer with the user layer being constant. In another embodiment, if the virtual application layer is discarded, the system may be restored to the point in time before the virtual application layer was created. It will be apparent to a person skilled in the art that though only two layers have been used in the above-mentioned examples, the same principles may be applied when there are more virtual layers.

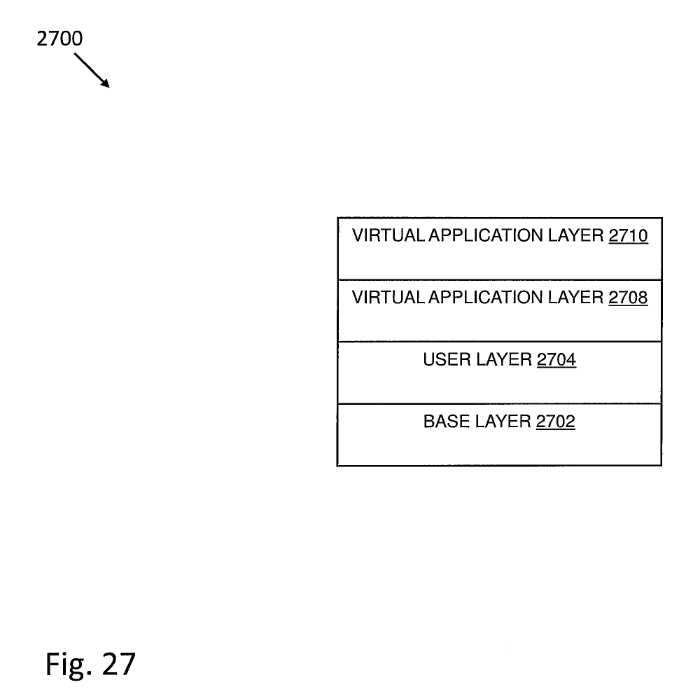

FIG. 27 depicts a virtual file system 2700 in accordance with an embodiment of the invention. The virtual file system 2700 may include a base layer 2702 at the bottom, a user layer 2704 on top of the base layer 2702, and one or more virtual application layers, such as a virtual application layer 2708 and a virtual application layer 2710, on top of the user layer 2704. A virtual layer may be a collection of data identified by a GUID and may include a file system, a hierarchy of folders and files, a registry, a hierarchy of keys and values, a scope, a list of folder paths, and registry keys. Multiple layers may be merged together to form the virtual file system 2700. The base layer 2702 may consist of the operating system and applications and utilities as determined by the administrator and untainted by any user customization. The base layer 2702 may be the lowest layer. Typically, the base layer 2702 may be isolated from all changes by the layers above.

In an embodiment, files and folders in all layers other than the base layer 2702 may be decorated with metadata. In an implementation of the base layer 2702, which uses NTFS as the underlying file system, these decorations may be implemented using an Alternate Data Stream. The metadata may be used by the virtual file system, but may be invisible to any application program. The metadata may contain the file (or folder) metastate. Further, the metadata may contain version and timestamp information that may be used in conflict handling.

In an embodiment, the metadata may be created and updated incrementally as files are created and modified in various non-base layers.

In an embodiment, a design of the virtual file system may eliminate the need for storing the metadata in the base Layer 2702. Decorating each file and folder in the base layer 2702 with the metadata may be prohibitively expensive in time and storage since such a base layer may be vastly larger than the other layers.

The user layer 2704 may contain a user's documents, settings and any other personal customizations. Typically, the user layer 2704 may lie directly above the base layer 2702. The user layer 2704 may encompass a namespace. This implies that any change not captured by a higher level may be captured by the user layer 2704. Except for the base layer 2702, a layer may include added files, changed files, and deleted files. An added file may be defined as a file in a layer that is new to the virtual file system and not simply a modification of another file in a lower layer. Added files that exist in an upper layer may be visible to a user but may not exist in a lower layer. Files that exist in a lower layer may be deleted from an upper layer to result in the lower layer file not being visible to a user.

A changed file may be defined as files that may be created when a program tries to change some file at a lower layer. If the change affects the file's data, the virtual file system may create a changed file in an owner layer and may copy up the file data from the lower layer file. The owner layer may be defined as the top-most layer whose scope contains a portion of the file. In an embodiment, changes to a file may affect the owner layer. Further, the change to the file may affect some other file properties. Such properties may include file attributes, time stamps, file name, and security descriptor. Not every change to a file may result in it being copied up. For example, it would be a waste to copy a large file simply because its “read-only” attribute has changed. Instead, a change file may be created in the owner layer, one that contains only the modified attribute. Such a change file that does not contain the file's data is called a change stub. A change stub may be defined as a changed file that does not contain its own file data. Instead, the change stub may contain a reference to a lower layer file which the change stub may have modified. The lower layer file may contain the file data. Change stubs may be created when some property of a file other than its data is modified.

A deleted file may be defined as a file at a lower level that has been logically deleted. The virtual file system may create a whiteout stub in the owner layer. A whiteout stub may obscure a logically deleted file at a lower layer. The obscured file may be inaccessible owing to deletion of the file or due to a renaming of the file. In the latter case, a change stub may also be created in the owner layer using the file's new name. The change stub may contain a reference to the obscured file.

In an embodiment, a file may be both a whiteout stub and an added file. This may happen when a lower layer file is deleted and then another file with the same name is created in the owner layer. In this case, the whiteout stub may be termed as sticky. Even if the added file is deleted or renamed, the whiteout stub may remain. Without the whiteout stub, the lower layer file may not be obscured. For example, suppose \mineral\salt exists only at the lower layer; in this case, a set of instructions to delete contents of the above-mentioned file may create a whiteout stub in the owner layer named \mineral\salt. Thereafter, the user may create an added file in the owner layer with the same name as the whiteout stub that is \mineral\salt. Thereafter, the user may delete the newly added file named \mineral\salt. This operation may delete the newly added file with the whiteout stub remaining in the owner layer. This whiteout stub may be capable of obscuring a same named filed in the lower layer.

In another embodiment, a file might be both a whiteout stub and a change stub. This may happen when a lower layer file is deleted and then a second lower layer file is renamed to the first file's name. The whiteout may be sticky. If the second file is deleted or renamed again, the whiteout stub may remain. Without the whiteout stub, the first file may not be obscured as illustrated in the example above.

In yet another embodiment, two stubs may be created in the owner layer when a lower layer file is renamed. A whiteout stub may be created in the owner layer using the old name of the lower layer file. This may obscure the lower layer file, thereby making the lower layer file inaccessible through the old name. Further, a change stub may be created in the owner layer using the new name. This stub may contain only a reference to the lower layer name. When the file's data or attributes may be read, the file system may access the lower layer file. The file may be obscured from the user. However, the file may be accessible to the file system.

In an embodiment, there may be a file in an upper layer which may obscure the same-named file in another lower layer. In an example, from the user's perspective, the file may get deleted; however, it may not be simply physically deleted. The deletion of file from the upper layer may reveal the no-longer-obscured file in the lower layer. The file may be marked as logically deleted. This may be done by creating an empty file with the same name as the deleted file, and decorating it with a metastate of deleted. In an embodiment, there may be several metastates such as normal metastate, copied up metastate, change stub metastate, shadow and deleted metastate. The normal metastate may be associated with a file or folder that is not obscuring a same-named file in a lower layer. If the user attempts to delete such a file, it may be physically deleted. The copied up metastate may be associated with a file or folder that is obscuring a same-named file in a lower level. If the user attempts to delete such a file, it may be replaced with an empty file marked as deleted. The change stub metastate may be a variation of the copied up metastate. The change stub metastate may be associated with a file that is partially obscuring the same-named file in the base layer. In particular, the file's data streams may not be obscured; they may be still accessed by user applications directly from the base layer file. But the file's other attributes such as file attributes, time stamps, and security descriptors may have been copied to the file marked as change stub and any change which may have been made there. The shadow metastate may be associated with folders that may have been created to simply fill out missing components of the file system hierarchy. For example, if a layer contains some file named \A\B\C, then there may be a folder named \A and a folder \A\B. Such folders may be created to provide connectivity between the root directory and file C and then they may be marked with a metastate of shadow. Such folders may not have any attribute and may not obscure the same-named folder in some underlying layer. The deleted metastate may be associated with an empty file that may serve to obscure some same-named file in a lower level, denoting it as logically deleted. Such a file may be sometimes called a “whiteout”. A whiteout may not be visible to user applications. For example, if a new file is created in a layer that would overwrite a deleted file, that file may be marked copied up and not normal, thus indicating that the new file also obscures some same-named file in a lower layer. Thus, once a file in a lower layer has been obscured, either by being deleted or by being modified, it may remain obscured forever or until the obscuring layer is deleted.

In an embodiment, file rename operations may be permitted. In an example, if a copied up or change stub file is renamed, an empty file marked deleted may be created with the original name, thus ensuring that the obscured lower-layer file remains obscured. In another example, if the rename operation's destination name is in use in some lower layer, then the renamed file may be marked as copied up; thus, obscuring the same-name file in the lower level. Otherwise, the renamed files may be marked as normal, indicating that there may not be a condition of the lower-layer file being obscured. In yet another example, if the original file was marked as change stub, then it meant that the data streams were still held in the same-named base file. Since the destination file may have a different name from the old underlying base file, the change stub optimization becomes too complex to retain. So the file data streams from the partially obscured base file may be copied up into the destination name. The effect is that after renaming, the destination file may be marked as normal or copied up.

In an embodiment, the virtual file system may support a File Identifier (ID) feature to be compatible with NTFS. Every file within a volume may have a unique 64-bit file M. This may be queried for any open file and it may be used to open a file rather than specifying the file name. A file's ID may be determined when the file is created and it persists until the deletion of the file. Thereafter, the ID may be re-used and assigned to any other new file. The virtual file system's support of file IDs may be complicated by the fact: while virtual file system may present itself as a single logical volume, in its implementation a file may be represented in multiple layers, layers that may exist on various physical volumes. For example, a file \A\B\C might exist in the Base layer and in several other layers too. Each representation of a file may have its own file ID. Yet the virtual file system may present a single file ID for \A\B\C, and when presented with the ID during file open, may open \A\B\C. The virtual file system may perform this by designating the ID from the file in the base layer as the virtual file system's file ID. In an embodiment, if a file does not exist in the Base layer, a unique file ID is generated upon demand, i.e., when a user application first queries the file for its ID. The generated file ID may be taken from a range of numbers that are not used by any file in the Base layer, so such IDs may not conflict with the IDs for files that exist in the Base layer. The assignment of file IDs is persistent; i.e., it remains the same after reboot. To support this, virtual file system may maintain a file that may provide a correspondence between every generated file ID and the file's layer-specific file IDs.

In an embodiment, the virtual file system may support the Short Name feature to be compatible with NTFS. Every file within a folder has two names, a long name and a short name, which may be unique within the folder. Long names may be many characters long and the characters may be taken from a large set of characters. Short name may be compatible with the old DOS naming restrictions; they are often called 8 dot 3 names, which may describe their naming limitation: up to 8 characters from a restricted character set, a period, and up to 3 more characters. In an embodiment, if a file's long name meets the restrictions imposed on short names, then the file may have no separate short name. The virtual file system's support of short names is complicated by the fact: while virtual file system may appear to user programs as a single file, in its implementation a file may be represented as a separate file in each of multiple layers. When a virtual file system file is created, it may be assigned a short name that is unique within each of the folders in each of the layers where the file may be represented. In an embodiment, if a file is deleted or renamed and a whiteout may be required, the whiteout may have both the long name and the short name, so a file in some lower layer may be obscured if it has either the same long name or the same short name. The whiteout may remain until both the long and the short names have been re-used by new files. For example, suppose a whiteout is created with the names Philadelphia and PHILAD˜1. Now suppose a new file is created with the name Philadonis. It may re-use the short name PHILAD˜1. The whiteout must remain to obscure the name Philadelphia, but it would be modified to cease obscuring the short name PHILAD˜1.

In an embodiment, the virtual file system may support renaming across layers. Like most file system, the virtual file system may support renaming files and folders. Windows does not support renaming a file across volumes; i.e., renaming C:\A\B\C to U:\A\B\C is not supported. If the user attempts such an operation, it is implemented by copying the file from the source volume to the destination volume and then deleting the file from the source volume. The virtual file system's support of renaming may be complicated by the fact: while the virtual file system may present itself as a single logical volume, in its implementation a file may be represented in multiple layers, layers that exist on various physical volumes. So a rename operation that may appear to operate on a single file on some specific volume may, in fact, be implemented by the virtual file system as a copy and delete across multiple volumes. Similarly, a rename operation appearing to operate on a single folder on some specific volume may find its source files scattered across multiple volumes and the destination for those files also scattered across multiple volumes. The virtual file system optimizes rename operations by performing actual rename operations when the source and destination volumes are identical, and only performing copy and delete when they differ. The optimization may be straight forward when the rename operation affects a single file, but may be more complex when it affects a folder; i.e., an entire subtree of the file hierarchy. The virtual file system may look for subtrees that may be wholly within one volume and where the source and destination volume are the same. Such subtrees may be simply renamed. Otherwise, the virtual file system may operate on the subtrees using copy and delete, descending recursively down the subtree. When it encounters a subtree that can be simply renamed, it may do so or else it may perform copy and delete operations on the individual files and folders.

In an embodiment, layers in the virtual file system 2700 may be managed with a set of operations. An operation for adding a virtual application layer has been explained above. Some of the other operations may include freezing a layer, merging layers, deleting a layer, and importing/exporting layers.

In an embodiment, an operation for freezing the virtual application layer may imply that the scope of the virtual application layer is fixed, i.e., the scope may no longer grow dynamically. The scope may define how the virtual application layer may be modified. In an embodiment, changes to a file may only occur in the virtual application layer if the file is within the scope of the virtual application layer. For example, when a file is added to the virtual file system 2700, the file may be placed in the top-most virtual application layer whose scope may contain the new file's name.

In an embodiment, an operation for merging virtual application layers may be provided. Two or more virtual application layers may be merged to reduce overhead caused by additional virtual layers. A user may wish to consolidate a layer, such as the virtual application layer 220 with the layer beneath, such as the virtual application layer 212. The user may specify GUIDs of the layers to be merged. Consequently, added files in the upper layer may be moved to the lower layer.

In another embodiment, if a whiteout in an upper layer logically deletes a file in a lower layer, the file may be deleted, i.e., a logical delete may become a hard delete. If a change stub in an upper layer refers to an obscured file in the lower layer, the changes in the change stub may be applied to the obscured file, i.e., a change may be made to the real data. Once the contents of the upper layer have been merged with contents of the lower layer, the upper layer may be deleted. This operation may be irreversible. In an embodiment, if changes are merged into the base layer, they may be lost when the base layer is next updated.

In another embodiment, an operation for deleting a layer may be provided. The user may specify the GUID of the layer to be deleted. If the layer to be deleted is not the top layer, then some higher layer may have stubs that refer to the chosen layer. These stubs may need to be resolved. Whiteout stubs in the top layer may be deleted since the whiteout stubs obscure a file in the layer that is to be deleted. Change stubs in the top layer may have their data copied from the layer to be deleted. Thereafter, the chosen layer may be deleted. Any added files, change stubs or whiteout stubs that the deleted layer contains may be discarded. Files that the deleted layer previously obscured in lower layers may be made visible again.

In yet another embodiment, an operation for exporting or importing a layer may be provided. A utility may exist to export layers from a server to clients, and imported from clients as added or replacement layers.

In an embodiment, a layer in the virtual file system 2700 may be associated with rules that govern the scope of the layer, i.e., which files and folders should be placed in that layer. The rules may change over time. In an embodiment, the rules may be determined at boot time. Any change to the rules may require a reboot. It will be apparent to a person skilled in the art that in an enhancement to the present virtual file system, rules may be changed dynamically.

In an embodiment, a rule may have a path name prefix. The rule may apply to all files whose path name starts with the rule's path name prefix. The path name prefix may be distinct for a layer's several rules. Further, duplicates may not be allowed.

In another embodiment, the set of rules for all layers may be aggregated to form a master set of rules. This master set of rules may partition the file system namespace. Accordingly, for a file name, the layer that is an owner layer of that file may be determined. This determination may be made by matching the file's path name against each rule in turn. The rule that best matches the file's path name may be the controlling rule. The term ‘best matches’ implies that the rule may have a path name prefix longer than or at least as long as any other rule that applies to the file. If two rules have the same path name prefix, then the controlling rule may be from the upper-most layer.

In an embodiment, the controlling rule may affect file system operations that may change data storage. Such changes may be made to the file's owner layer, i.e., the layer of the controlling rule. If a file is found in some layer below its owner layer, any attempt to change the file may cause the file to be copied to its owner layer and changed there. The copied file in the owner layer may obscure the same-named file found in the lower layer.

In an embodiment, apart from the base layer 2702 and the user layer 2704, an additional layer that may be referred as the local layer may be present. The local layer may be distinguished from the user layer in the way the local layer may be treated by a backup facility. Only files in the user layer may be backed up. In an embodiment, the rules may be created such that files that are generated automatically or may otherwise be derived or reproduced may be placed in the local layer. This may help reduce the size of backup images.

In another embodiment, an additional layer that may be referred to as Copy on Write (CoW) layer may be present. The CoW layer may own a portion of the file namespace that may not be owned by any other layer. If an application attempts to modify some file whose name does not match any rule's path name prefix, then the change may be made to the CoW layer. The goal of the CoW layer may be to minimize changes made to the base layer. Another goal of the CoW layer may be to tightly control changes made to the system volume and to provide a mechanism for identifying missing rules. By examining the files placed in the CoW layer, a user or administrator may determine whether some additional rules need to be created.

In another embodiment, the additional layer may be referred to as foreign layer. The foreign layer may be an abstract layer which may own a portion of the namespace, but may direct the virtual file system 2700 to ignore those files and folders altogether. In an aspect, operations on certain operating system files and special files, such as system paging file, may by-pass the virtual file system and may be directed to the underlying native file system.

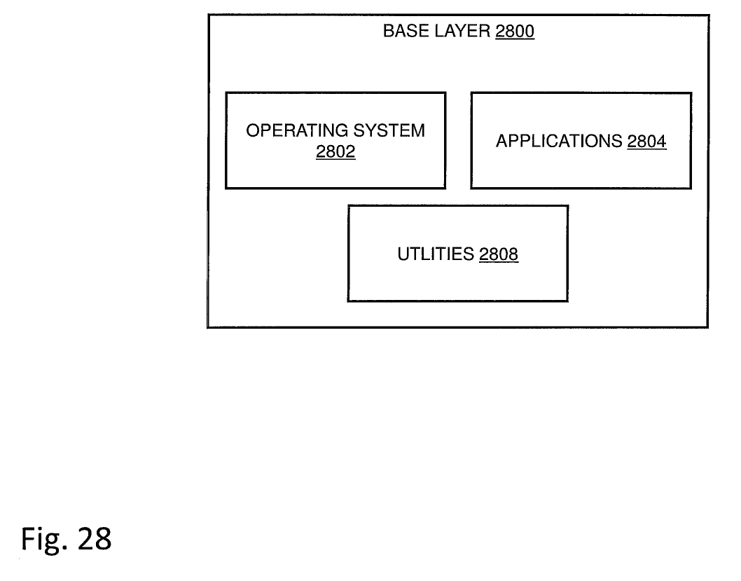

FIG. 28 depicts a base layer 2800 of the virtual file system in accordance with an embodiment of the invention. The base layer 2800 may include an operating system 2802 for the computing facility, and applications 2804 and utilities 2808, which may be installed by the administrator. In an embodiment, when the base layer 2800 is free from change stubs, whiteout stubs, and the like, the base layer 2800 may contain native New Technology File System (NTFS) and registry. When the virtual file system driver is installed, there may be no need for the driver to scan or process the virtual file system. The driver may simply create an empty user layer.

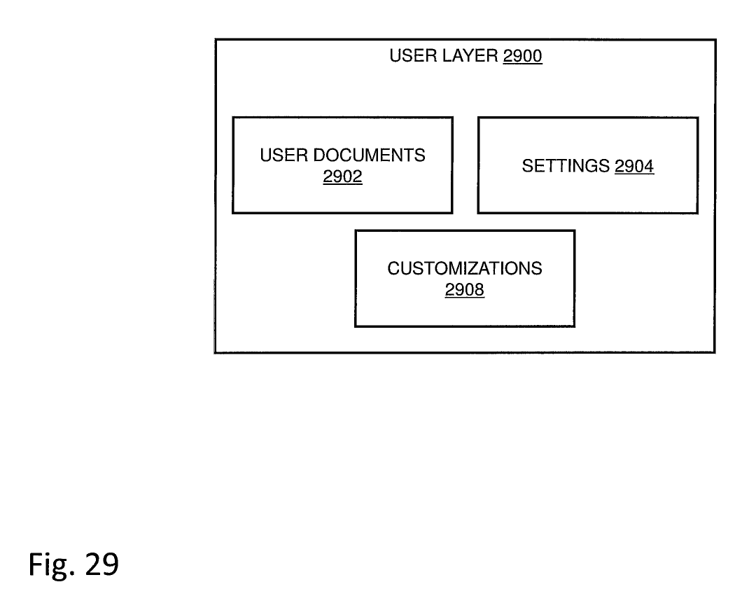

FIG. 29 depicts a user layer 2900 of the virtual file system in accordance with an embodiment of the invention. The user layer 2900 may include one or more user documents 2902, settings 2904 installed by the user, and customizations 2908 installed by the user. In an embodiment, additional virtual layers may be created by the user or an administrator. In an embodiment, the creation of an addition virtual layer may partition contents of the additional virtual layer from the existing virtual layers. Also, the partitioning may protect the existing virtual layers from the additional virtual layer. The partitioning may improve the ease with which the content of the additional virtual layer may be deleted. Alternatively, the partitioning may package the contents of the additional virtual layer.

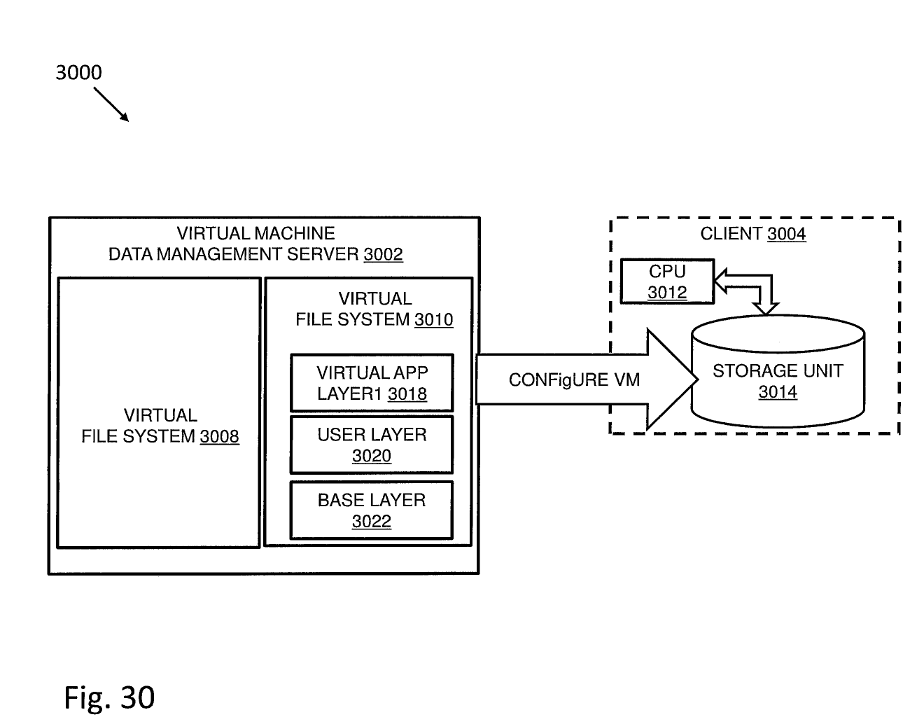

FIG. 30 depicts an initial condition of a virtual machine data management server 3002 (also referred as ‘server 3002’) and a client 3004 in a client server scenario 3000. The server 3002 may include virtual file system 3008 and virtual file system 3010. In an embodiment, these virtual file systems may correspond to clients that use the server 3002 for sharing purposes. The initial condition of the client 3004 may involve configuring the virtual file system 3010 on the client 3004. Specifically, the virtual file system 3008 may be configured on components of the client 3004 that may include a Central Processing Unit 3012 (CPU 3012) and a storage unit 3014.

In an embodiment, the virtual file system 3010 may include a virtual application layer 3018, a user layer 3020 and a base layer 3022.

Since virtual workspaces are centrally managed on the server 3002, changes made at the server 3002 may be pushed to the client 3004 from time to time. Files and folders that existed in the previous version may have been deleted or modified, and new files and folders may have been added. These changes may appear as changes in the base layer 3022.

In an embodiment, a version of virtual file system on the client 3004 may detect whether such changes conflict with changes that may have been made on the virtual file system 3010.

In an embodiment, a virtual file system may modify files in its base layer by copying the files from the base layer to some higher layer as determined by the rules, and modifying the files in the higher layer. The virtual file system may delete files in the base layer by creating a whiteout file in some higher layer as may be determined by the rules. A whiteout file is a file that may be marked with a metastate of deleted. The metafile may obscure any same-named file in a lower level, such as the base layer, and it may not be visible to user applications.

In an embodiment, the virtual file system may determine that a conflict exists if a file has been added, changed or deleted in the revised base layer on the server and the same file was also added, changed or deleted by the virtual file system operating on some previous revision of the base layer on the client. For example, a conflict may exist if some new revision of the base layer contains a file \A\B\C that was not present in a previous revision of the base layer, and if the virtual file system independently created a file \A\B\C. The new file found in the revised base layer may be referred as server version. The file created by the virtual file system on the client may be referred as client version.

In an embodiment, such a conflict may be handled by the virtual file system by determining which version of \A\B\C, i.e., client version or server version should dominate or trump. The rules may provide the answer. In an embodiment, a rule that owns the name \A\B\C may specify whether the server version trumps or the client version trumps.

In an embodiment, if the client version trumps, then the revised version of \A\B\C in the base layer may be ignored. In another embodiment, if the server version trumps, then the client version may be copied into a conflict bin and may be replaced in the owner layer with the server copy.

In another embodiment, the user may have an opportunity to salvage any valuable content by copying the client file from the conflict bin. The content would be lost if the virtual file system deleted the client version. The conflict bin may be referred as \NxTop\ConflictBin so the file in the conflict bin may have the name \NxTop\ConflictBin\A\B\C.

It will be apparent to a person skilled in the art that the conflict described above, where a file may be added at both client and server, may be one of many possible types of conflicts.

In another embodiment, if the file \A\B\C is added or modified on the server (the server version) and a same named file is added or modified on the client (the client version) and if the rule for conflict determines that the server version should trump, then the client version of the file may be moved to the conflict bin and the server version may be copied onto the owner layer.

In yet another embodiment, if the server version is added or modified and the client version is also added or modified and if the rule for conflict determines that the client version trumps, then server version may be obscured by the client version.

In still another embodiment, if the server version is added or modified and the client version is deleted and if the rule for conflict determines that the server version should trump, then the server version may be copied into the owner layer.

In yet another embodiment, if the server version is added or modified, and the client version is deleted and if the rule for conflict determines that the client version should trump, then server version may be obscured by the client whiteout.

In still another embodiment, if the server version is deleted and the client version is added or modified and if the rule for conflict determines that the server version should trump, then the client version may be moved to the conflict bin and a whiteout may be created in the owner layer.

In yet another embodiment, if the server version is deleted and the client version is added or modified and if the rule for conflict determines that the client version should trump, then the server version deletion may be ignored and the client version may be visible.

In still another embodiment, if the server version is deleted and the client version is also deleted, then the whiteout may remain in effect.

It will be apparent to a person skilled in the art that other types of conflicts, such as a file \A\B\C being replaced by a folder of the same name, or vice versa may also be handled by the virtual file system.

In an embodiment, a conflict detection mechanism may be present to detect various types of conflicts. In an aspect, there may exist a base layer version number which may be incremented each time the base layer is revised. The virtual file system may check the number at boot time in order to detect such a revision.

In another embodiment, whenever a file is copied up from the base layer to some other layer, the current base layer version number may be saved in the copied file's metadata. If subsequently the base layer version number may be determined to be greater than the number saved in the file's metadata then the possibility of a conflict may exist.

In still another embodiment, the virtual file system may rely on timestamp information to determine if a conflict actually exists. When creating a file's metadata, the virtual file system may save the base file's last-write time and its change time. The last-write time may indicate when the file's stream data was last modified. The change time may indicate when the file's attributes were last modified.

In yet another embodiment, the virtual file system may determine if a file's stream data has been modified on the server, if there is a difference between the last-write time of the file in the base layer and the saved last-write time held in the file's metadata. The virtual file system may use a similar comparison using change time to detect a change in file attributes.

In still another embodiment, the virtual file system may determine if a file's stream data has been modified on the client, if there is a difference between the last-write time of the file in its current layer and the saved last-write time held in the file's metadata. The virtual file system may use a similar comparison using change time to detect a change in the file attributes.

Accordingly, using these indicators in the metadata, the virtual file system may be able to determine whether there are server changes and client changes, and whether those changes are in conflict.

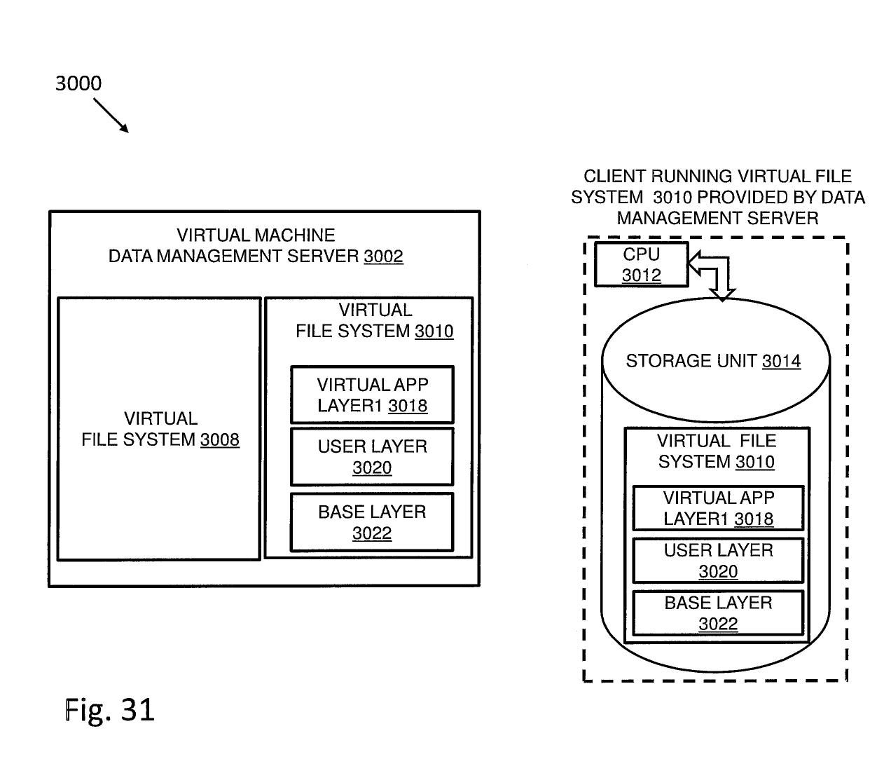

FIG. 31 depicts a client-based instance of the virtual file system 3010. The client 3004 may utilize the virtual file system 3010 during execution.

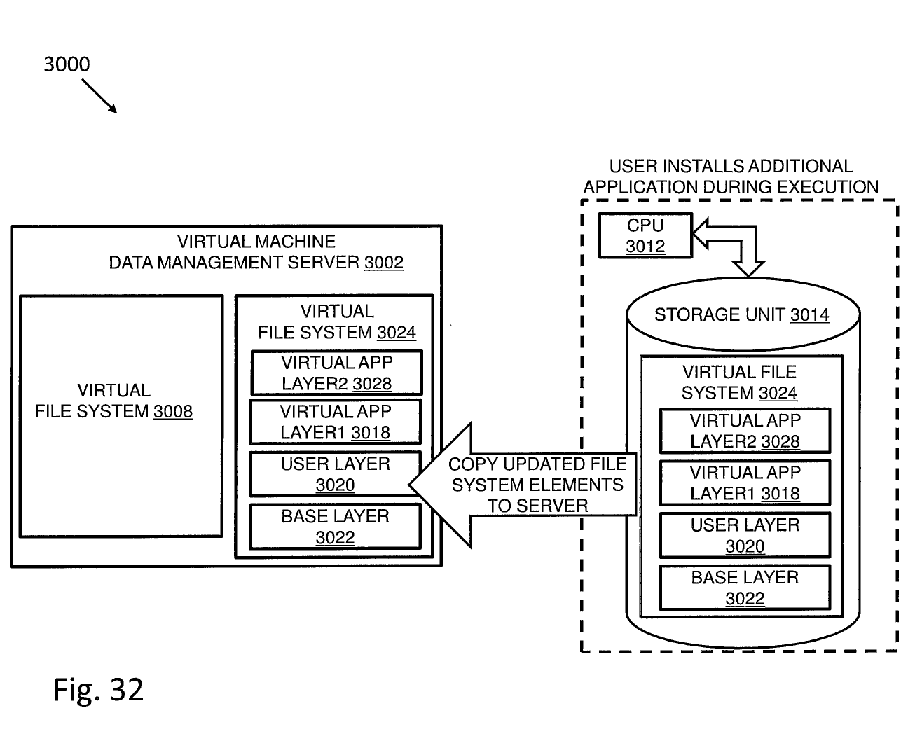

FIG. 32 depicts a result of changes to the virtual file system 3010 of FIG. 31 to form a virtual file system instance 3024 that may be applied to the server 3002. A virtual application layer 3028 may be an addition to the virtual file system 3028. The user may add the virtual application layer 3028 to capture changes made during installation of an application. Alternatively, the user may add the virtual application layer 3028 before undertaking a risky activity such as installing a downloaded application. In an embodiment, the user may provide an informational description while adding the virtual application layer 3028. The virtual file system 3024 may create the virtual application layer 3028 and may generate a corresponding Globally Unique Identifier (GUID) for the virtual application layer 3028.

The virtual application layer 3028 may be added as the top layer. Further, the virtual application layer 3028 may capture all subsequent changes made to the client 3004. In a case, if the installation is faulty, the user may discard the virtual application layer 3028 without affecting an earlier environment of the client 3004. In another case, if the installation is successful, the virtual application layer 3028 may be isolated and published. In an embodiment, the virtual application layer 3028 may be merged with the underlying virtual application layer 3018. Because the distinction of virtual application layer 3028 may be lost when it is merged with virtual application layer 3018, the merging may irreversibly incorporate the application and related configuration, execution, and data files that were associated with the virtual application layer 3028 into the user's environment.

In an embodiment, addition of the virtual application layer 3028 may involve two stages. In the first stage, an application, such as a text editing application, may be packaged. Packaging the application may imply creation of the virtual application layer 3028, naming of the virtual application layer 3028, and pushing the virtual application layer 3028 onto a stack of layers in the virtual file system 3010. During this stage the virtual application layer 3028 may capture all folders added to the virtual file system 3010. Typically the application may create a small number of folders and write data to files in those folders. Those folders may dynamically define a scope of the virtual application layer 3028. The scope of a layer may be defined as a set of folders that binds how the layer may be modified. The scope may or may not be frozen. A layer may accept addition of new folders to the layer when the scope is not frozen. As folders are added to the layer, the scope of the layer may grow to include the folders. In an embodiment, when the scope is frozen, only changes to files within the folders (or their sub-folders) may be permitted. Changes to other files may affect some other layer. In an embodiment, if a changed file is within the scope of several virtual layers, the top-most virtual layer may be affected.

In the second stage, after the application has been installed, the scope of the virtual application layer 3028 may be frozen. This may imply that the virtual application layer 3028 may be modified by subsequent changes to files within its scope. However, changes to files outside the scope of the virtual application layer 3028 may affect some other layer, typically the user layer 3020. Using Winword as an example, changes to \ProgramData\Microsoft\Office may modify the virtual application layer 3028, but changes to the user's documents may modify the user layer 3020.

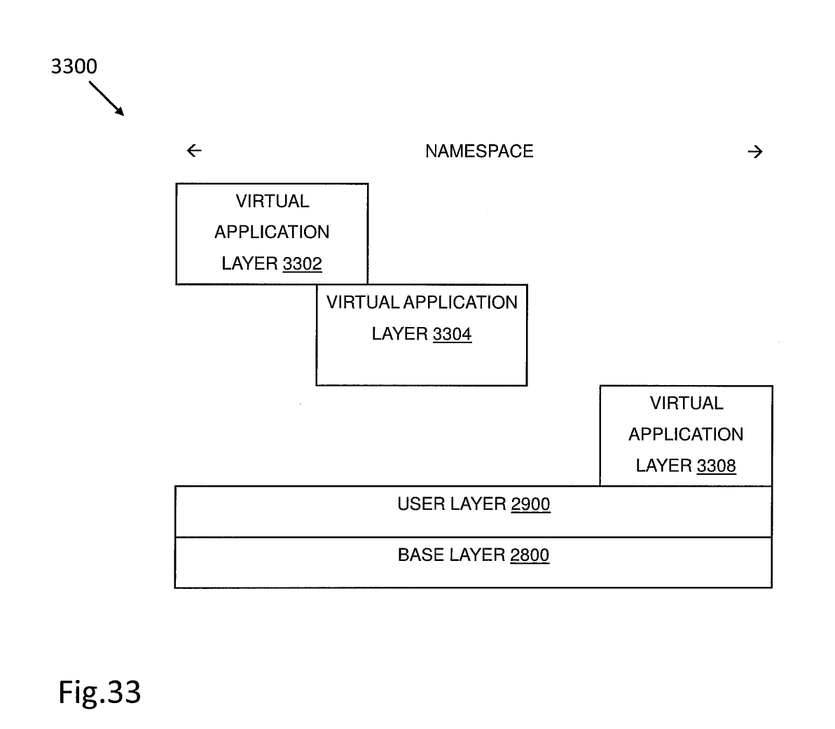

FIG. 33 depicts an embodiment of layers of an inventive virtual file system within a namespace 3300 corresponding to a computing facility, according to an embodiment of the invention. The computing facility or the client may have one or more virtual application layers installed, such as a virtual application layer 3302, a virtual application layer 3304, and a virtual application layer 3308. Each of the one or more virtual application layers may own some portion of the namespace. The user layer 2900 may encompass the entire namespace and may accept changes not accepted by a higher layer. The user layer 2900 may own the rest of the namespace not owned by the virtual application layers. In an embodiment, several virtual application layers may overlap, such as the virtual application layer 3302 and the virtual application layer 3304. The top most layer, i.e., the virtual application layer 3302 may own the overlapping region. If changes are made within layers having overlapping scope, the top layer may be modified by the changes. In an embodiment, a fixed set of folders may not be managed by the virtual file system, which may include the registry hives or the paging files. Paging operations maybe passed down and may affect the base layer. The virtual file system may not manage the folders containing its own metadata and control information.

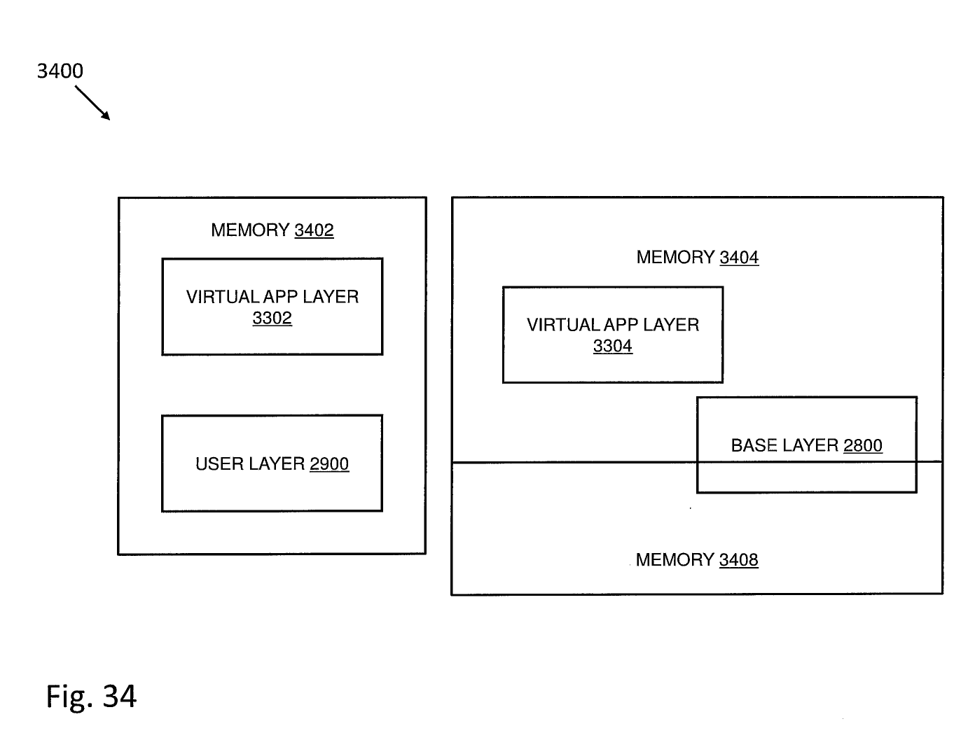

FIG. 34 depicts exemplary storage of different virtual file system layers in one or more data storage units, in accordance with an embodiment of the invention. In an embodiment, the one or more data storage units may include a data storage unit 3402, a data storage unit 3404, and a data storage unit 3408. The data storage units may be at a single location within various disks in a server or distributed across various servers. Further, the virtual layers of the virtual file system may be distributed across the data storage units. For example, a virtual application layer 3302 and the user layer 2900 may be stored on the data storage unit 2402 that may be at a server or spread across various disks on the server. Further, a virtual application layer 3304 and the base layer 2800 may be stored on the data storage unit 3404 and the data storage unit 3408. As shown, the base layer 2800 may be distributed across more than one data storage unit. The one or more data storage units may be referred as a physical workspace of the computing facility, i.e., the client.

In an embodiment, the virtual file system described herein may be implemented as a minifilter file system driver. It will be apparent to a person skilled in the art that minifilter refers to the Microsoft technology, and not the driver's size or complexity. This implies that the file system driver may get first crack at file operations. Further, the file system driver may translate file names, provide merged views of directories and perform other necessary jobs.

In an embodiment, the virtual file system may be implemented by using native NTFS files and folders. All file properties, such as file names, timestamps, file attributes, and security descriptors may use their native representation.

In an embodiment, no per-file metadata may be stored in the virtual file system. These files may be used in-situ and may not be renamed or moved.

In another embodiment, for non-base layers, the virtual file system may use NTFS files to represent change stubs. For such stubs, the virtual file system may store a small amount of additional information such as file ID of the obscured file. This data may be stored in the file in an alternate data stream, such as a virtual channel interface (VCI) that may include a customization policy.

In another embodiment, logically deleted files and folders may be marked with a whiteout stub. This mark may be stored in the file or folder in a VCI alternate data stream that supports customization policies as described herein.

In an embodiment, the virtual file system may store its control files and data in the folder C:\NxTopCP, denoted symbolically below as % NxTopCP %. Since the virtual file system may be controlled by files in this folder, the folder and its files may not be managed by the virtual file system. File system operations that access files in that folder operate on it directly rather than being filtered through the virtual file system. To determine the current set of layers, virtual file system maintains a control file % NxTopCP %\Layers. It lists the properties of the layers (GUID, description, etc.) and their ordering.

In an embodiment, the virtual file system base layer may use native file system naming. For example, if a user executes C:\Windows\Regedit.exe, virtual file system will do a lookup on that name and, unless the user has meddled with that file, virtual file system will resolve it to C:\Windows\Regedit.exe.

In an embodiment, files in other layers are stored in % NxTopCP %\Layer\{GUID}\FileData. For example, suppose the user replaced Regedit.exe and that change was captured in the user layer. The virtual file system would resolve the name C:\Windows\Regedit.exe to % NxTopCP %\Layer\{user layer's GUID} \FileData\Mindows\Regedit.exe. For consistency in dealing with the base layer, there may be a mount point from % NxTopCP %\Layer\ {base layer's GUID}\FileData to C:\. The virtual file system can manage volumes in addition to the system drive. A common set of layers extends across all managed volumes but each volume has its own set of \Onion\Layer\{GUID}\FileData folders.

Prior to Vista it was not possible to write a simple filter driver for the registry. A driver might snoop registry changes but it could not properly virtualize them by blocking or redirecting them to some other registry key. In an embodiment, the virtual file system may present a merged view of the various layers. At run time the various layers may be “added” to form the merged view. If a layer is removed, the merged view may automatically reflect that. The approach may not be possible with the registry. All changes to the registry may affect it directly. So, if a layer is removed, the registry may be updated by “subtracting” the layer's registry values. To make this possible the registry changes for each layer may be bookkept. The principle may be the same as for the file system. The layer's registry may have a hierarchical structure of keys and values, and it may have a scope. It may also store additional metadata as discussed below. Each registry change made to the registry proper for example the live registry, may also result in change to the layer-specific shadow registry. If a new value is added to the live registry, it may be added to the shadow registry and may be marked as a new value. Removing the layer may involve deleting the value from the live registry. If a value is changed in the live registry, the old value may be added to the shadow registry and may be marked as a changed value. The change only happens the first time a value is changed in the registry. Subsequent changes may not have any effect on the shadow registry value. Removing the layer may involve resetting the value to the original old value. For example, if a value is deleted from the live registry, it may be added to the shadow registry and marked as a deleted (or whiteout) value. Removing the layer may involve re-adding the value to the live registry. If a changed value for example, one for which there may already be an entry in the shadow registry is deleted, the shadow entry may be re-marked from “changed” to “deleted”. If renaming a registry value is treated in the shadow registry as a delete and an add operation, then removing the layer may involve deleting the new-named value and adding the old-named value. If a key is added, changed, deleted or renamed, similar entries are made in the shadow registry.

In an embodiment, the virtual file system may include some common file operations. A lookup operation as described herein may facilitate locating a file in the virtual file system given its full name. The lookup operation may look through the layers in order until it either finds the file or unsuccessfully searches all layers. Each layer may have a pathname prefix. The virtual file system may prepend the prefix to the file's full name. The virtual file system may use that name to perform a lookup in the native file system. In an embodiment, if the file does not exist then the next lower layer may be searched. In another embodiment, if the file exists then the search may be over. In an embodiment, if the file is not a whiteout stub then the operation may succeed otherwise it may fail. If all layers are unsuccessfully searched then the operation may fail.

In an embodiment, the virtual file system may provide provision for folder enumeration. The operation may return a list of files within a specified folder, say Folder-F. The operation may iterate through the layers, looking up the folder in each, and compiling a merged list of the folder contents. Duplicates may be eliminated: say if both Folder-F-Layer-A and Folder-F-Layer-B contain Name-X, the merged list may contain Name-X only once.

The folders may disagree on Name-X's type or attributes. For example, Folder-F-Layer-A may include a file Name-X, while Folder-F-Layer-B may include a folder Name-X. The higher layer may win. The enumeration may not return the name of a logically-deleted file. Before a name may be added to the merged list, it may be determined if the name refers to a whiteout stub. The file may be opened and the virtual file system metadata may be read. If there is a whiteout stub it may be added to the merged list but may be annotated as logically-deleted. This may be necessary because, when processing a lower layer folder, the same file name may be encountered, i.e., the file that the whiteout is supposed to obscure. The file may not be required to appear in the enumeration.

It may be expensive to open and read the metadata for every file before adding it to the merge list. This may be avoided most of the time with a simple optimization. All whiteout stubs may be marked as ‘hidden’. If a file is not hidden it may be added to the merge list. Only if the file is hidden additional open and read necessary. Care may be taken with two special cases related to whiteout stubs. For example, if a file exists in Folder-F-Layer-A and that same-named file is a whiteout stub in some lower Folder-F-Layer-B then, in summary, the file exists and should appear in the merged list. The whiteout stub may obscure only the file in some even lower Folder-F-Layer-C, not in the higher Folder-F-Layer-A. This may occurs when a file is logically deleted in Folder-F-Layer-B but later, when Folder-F-Layer-A is added, another file may be created with the same name. An added file may co-exist with a whiteout stub in Folder-F-Layer-B. The whiteout stub may obscure the file in some lower Folder-F-Layer-C. Then another file with the same name may be added to Folder-F-Layer-B.

In an embodiment, the virtual file system may provide provision for file creation. A plurality of functionalities may be associated with create file operation. A create file may fail if the file already exists. In an embodiment, a supersede file operation may replace any existing file with a new file. In another embodiment, an open file operation may fail if the file does not already exist. A conditional file open operation may open the existing file, if any; otherwise it may create a new file. A conditional file overwrite operation may open and truncate the existing file, if any, otherwise it may create a new file.

In an embodiment, a lookup operation may be performed to determine if the file already exists and, if so, in which layer. In an embodiment, if the file exists and the create disposition is the file open operation or the conditional file open operation then the existing file may be used. But if the create disposition is a file create operation, then the operation may fail. In another embodiment, if the file does not exist then the file may be created in the layer that owns the new file's name. The virtual layers may be searched until a layer is found whose scope contains the new file's name. The new file may be created there. In another embodiment, the file may exist but a new file may need to be created. If the existing file is in the layer that owns the new file's name then the new file may be created there. In another embodiment, if the file exists but not in a layer where a new file may be created, then the old file may need to be obscured and the new file may need to be created. The layer that owns the new file's name may be determined and a whiteout stub may be created there. Thereafter, the new file may be created there. Folders may also need to be created to make a path to the file.

In an embodiment, a minor change to a file may cause a change stub to be created rather than the entire file to be copied up. The change stub may contain the file ID of the original file in some lower layer. This may allow a read file operation to be redirected to the original file.

In an embodiment, the virtual file system may need to copy up a file's data from a lower layer to the current layer whenever a program modifies it. However, the virtual file system should not copy it up unnecessarily. At file open time, a program may request all the permissions that the virtual file system may need for the operations it intends to perform on the file. In particular, if a program intends to modify a file's data it may need to request a file write data access at open time. However many programs may request write access but may never actually write anything. For this reason, copy up may not be performed just because a program requests write access. The copy up may be performed only when the program actually modifies the file. Then the layer that owns the file's name may be determined. Thereafter, the file may be created there and the data may be copied up to the file.

In yet another embodiment, if the file is an added file in the owner layer, the virtual file system may simply delete it. In an embodiment, the virtual file system may create a whiteout stub in the owner layer.

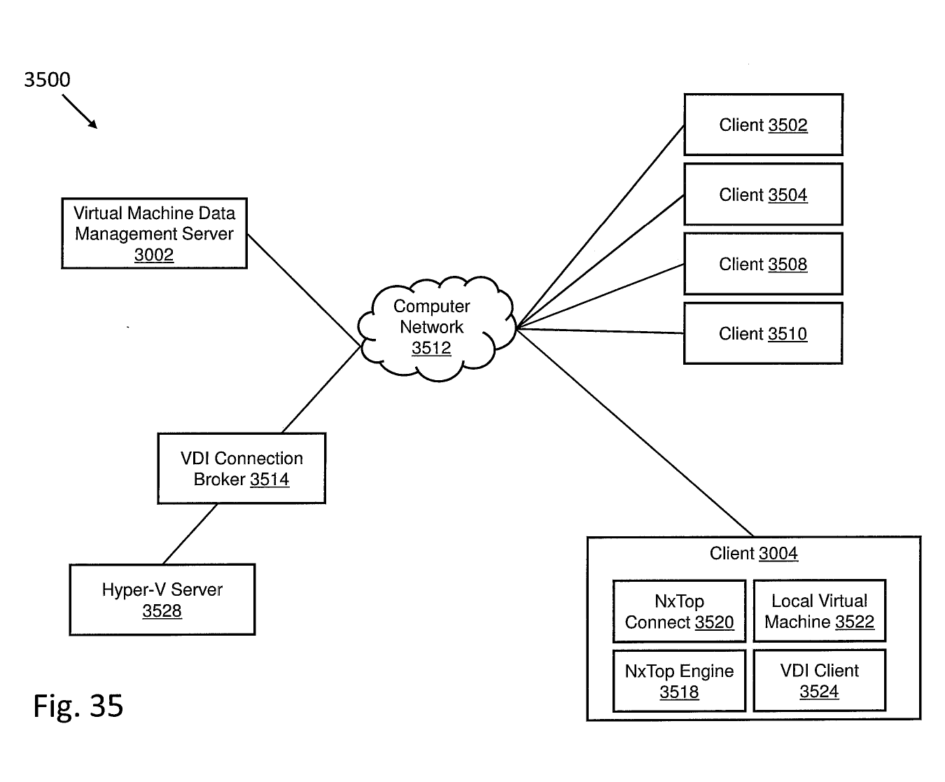

FIG. 35 depicts a client-server interaction 3500 for synchronizing instances of a virtual machine on multiple computing facilities. FIG. 35 depicts the server 3002 interacting with the client 3004 through a Virtual Desktop Interface (VDI) client 3524 and a computer network 3512. The server 3002 may interact with a plurality of clients, such as a client 3004, a client 3502, a client 3504, a client 3508, and a client 3510 to configure a local virtual machine on the client. The local virtual machine may be accessed on the client 3004 through a VDI connection broker 3514 and a Hyper V server 3528 connected to the computer network 3512. The client-server interaction 3500 may enable use of the virtualization capabilities provided by a virtual computer to facilitate a user to switch from one client to another and to access his personal computing environment. The client such as the client 3004, from which the user accesses his personal computing environment, may include an NxTop Engine 3518, an NxTop Connect 3520, a local virtual machine 3522, and the VDI client 3524. The personal computing environment of the user may be referred as a patched system.

In an embodiment, actions and capabilities for synchronizing patched systems may be built on existing virtualization ideas that were described in conjunction with the virtual file system. A goal of patched systems may be to allow a user to run his personalized virtual machine at different locations on different hardware at different times. In other words, patched systems may support a user in accessing his desktop from another computer located anywhere in the world. The invention may involve running an actual virtual machine, i.e., a virtual OS, virtual programs, and virtual data storage on separate clients or computers.

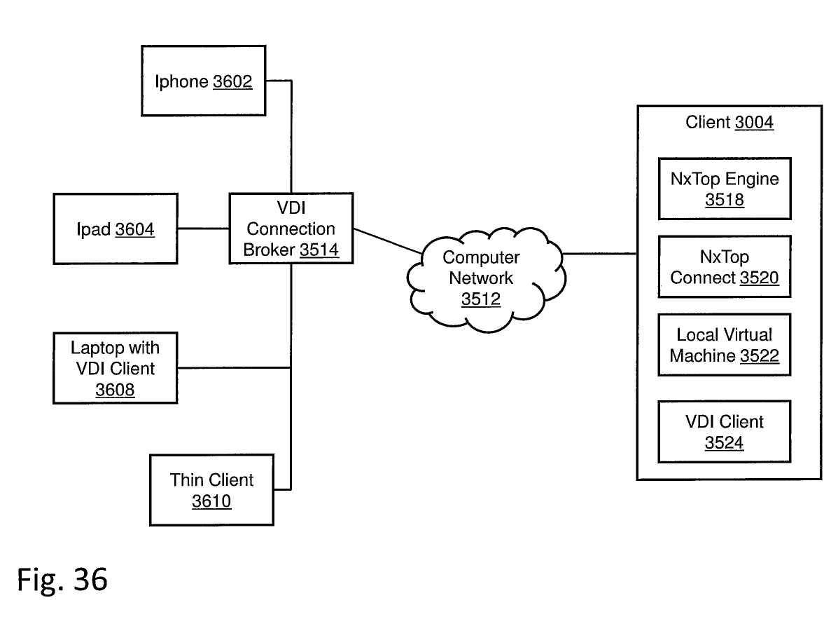

Referring to FIG. 36, interaction between a client and the VDI connection broker 3514 is depicted. In an embodiment, this configuration may allow a user to use a desktop at his office and a laptop on the road. These clients may be configured to run the same virtual machine and access the same data using the virtual computer's existing virtualization techniques. Further, the capability to continuously synchronize the user data across all computers on which the user runs his virtual machine may be added.

In an embodiment, the local virtual machine 3522 that executes on each separate client may be configured at the time it is run based on the user's most recent use of a copy of the local virtual machine 3522 on another client. Accordingly, the invention may enable a user to access user files through the virtualization capabilities and features available through virtual computing.

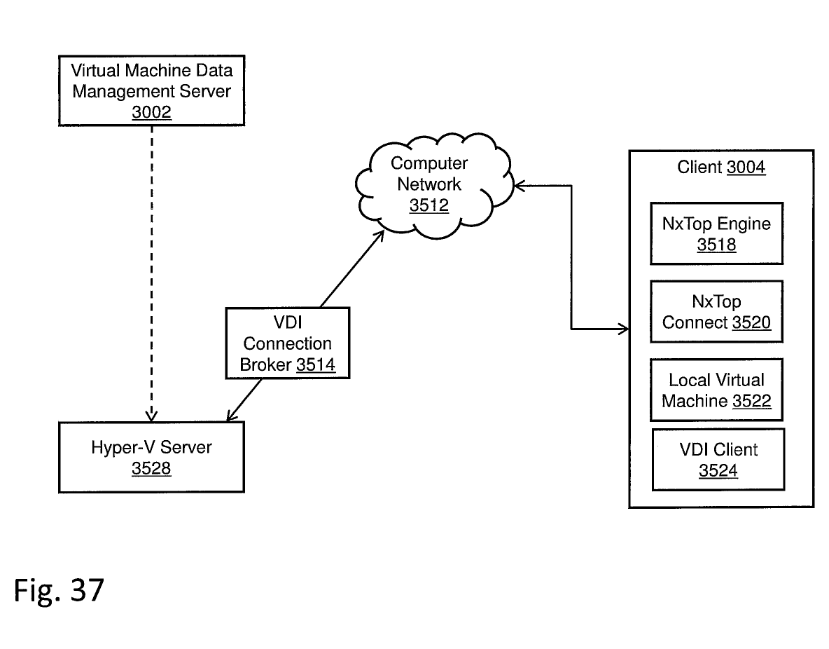

FIG. 37 depicts the VDI connection broker 3514 and the server 3002 enabling configuration of a local virtual machine on the client. The VDI connection broker 3514 may communicate with the server 3002 to prepare a copy of the local virtual machine to run on the Hyper-V server 3528. In an embodiment, the Hyper-V server 3528 may access a VDI session on the client 3004. The VDI session may be controlled by the VDI connection broker 3514.

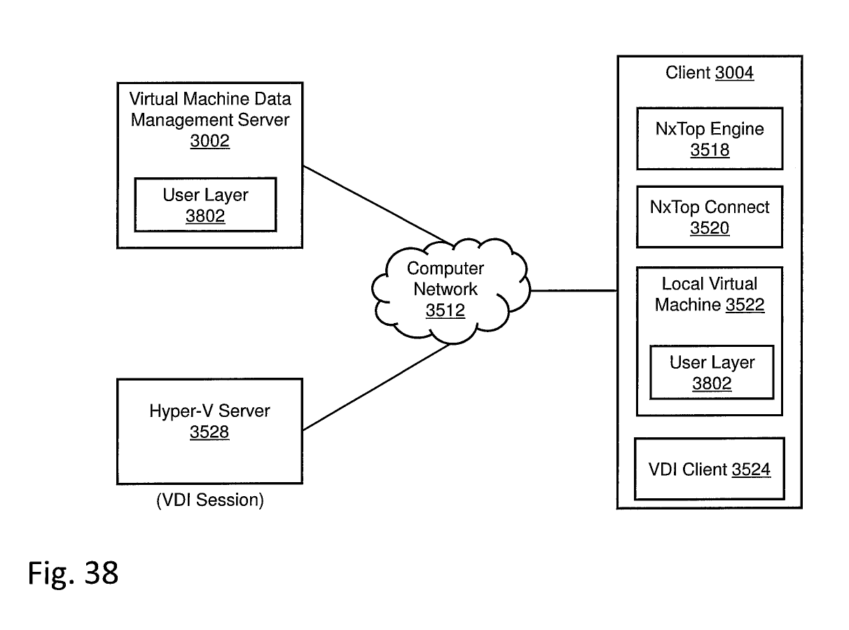

FIG. 38 depicts an update routine of user metadata on the server 3002 for maintaining synchronization.

In an embodiment, synchronizing data with a virtual machine instance may be done any time a virtual machine instance is running and connected to the Internet. However, even when a user is running a copy of the local virtual machine on a computer that is not connected to the Internet, all the changes to the user data may be preserved and optimized to allow super-efficient synchronization once the computer connects to the Internet.

In an embodiment, the synchronization may be applied to off-line instances as well. In an example, a user may have more than one client on which an operating instance of the user's local virtual machine may be running. The changes that the user may make to his user files, for example: editing a document, may be made on only one client, such as the client 3004. In such a case, the continuous synchronization of the local virtual machine running on the client 3004 may ensure that the client, such as the client 3504, which the user is not using, is updated as the user makes changes on the client 3004.

In one scenario, the user may make changes on an offline client. There may be a possibility that the user may make the changes on the offline client and also on an on-line client before the off-line client is brought back on-line and synchronized with the server 3002. In an embodiment, changes made in two locations to the same user data may be synchronized. In another embodiment, multiple changes made at different clients by the user may require arbitration of changes to the server 3002. Layering capabilities of the virtual file system may allow determination of clients at which the changes were made and the order of the changes. The determination may facilitate automated and user directed arbitration.

However, it may be evident that since the purpose of a virtual machine is to be available to a single user, it is unlikely that a user will modify data in two locations simultaneously. Although a computer running a virtual machine is always making some changes to the state of its local virtual machine, the user documents, such as WORD, instant search indexes, Internet cache, etc., may only be changed by the user.

In an embodiment, continuous synchronization of a user's virtual machine on multiple clients may be provided by utilizing a feature of the existing virtual file system. Specifically, the existing virtual file system includes a user layer that separates the user-specific files, such as user documents from other data such as system files. The synchronization of the user's virtual machine primarily involves synchronization of the user-specific files.

In an embodiment, some of the key virtualization features of the local virtual machine explained above may be applied to ensure that the user data is properly synchronized. The benefits of doing this may include easy movement of the user data and real-time synchronization of the user data.

As mentioned previously, a user can execute his virtual machine on any network-connected client and have access to the most recent instance of the local virtual machine independent of the client that was last used to modify the user data. Further, synchronization of the user data with the clients that have instances of the user's virtual machine may be required in order to operate the virtual machine. It will be evident to a person skilled in the art that this invention may rely on the server 3002 for storing backups of the user data. Further, a tree of deltas may be maintained that may hold the changes made by the user on various clients where the user runs the local virtual machine. The server 3002 may also mediate reconciliation of these disparate trees of deltas into a single stack.

As mentioned previously, since the user data has been separated from the applications and the temporary data and stored in the user layer of the virtual file system, capabilities of the underlying virtualization environment may be used to store the user data changes as deltas using a virtual hard drive (VHD) differencing disks technology. In an embodiment, the deltas may be transmitted over the computer network 3512, which may be a Wide Area Network (WAN), to the server 3002 very efficiently using commonly available data transmission and compression techniques.

In an embodiment, utilizing the VHD differencing disks technology may provide a linked stack of VHD disks that start with the base layer and layering on top of the base layer may be a series of deltas. All the user data changes made by the user may go into the top most differencing disk or differencing layer. In an embodiment, to support backup of the user data and synchronizing features, the virtual machine may be paused very briefly on a regular basis so that a new empty differencing disk may be pushed on top of the stack. Subsequent modifications made by the user may be captured in this new differencing disk and, the synchronizing software may take the layer which contains the most recently changed dataset and may send the layer to the server 3002 for continuously synchronizing with the other instances of the users' virtual machine.

In an embodiment, block level user data differences, such as byte by byte may be captured through the VHD disk differencing features of the underlying virtual machine system. It will be apparent that the stack may be a virtual image of the user data of the user's disk. In a top view of the VHD differencing disk stack, a layer that holds the block that the user is trying to read/write, i.e. the user layer, may be found. Briefly, the virtual file system may provide separation of data into layers that may be assigned to different VHD chains based on a rule set. The VHD differencing disk chain may capture snapshots of changes stored in the different virtual layers of the virtual file system and that may be assigned to the VHD chain. These snapshots may be synchronized via the server 3002.

In an embodiment, the virtual structure of the user's data disk image may be accessed by accessing the user layer from the virtual file system and metadata may be used to describe which block's (down to the sector 512 byte) level has changed. Accordingly, identification of the changed blocks that need to be synchronized may be easy and a smaller amount of data may need to be sent to the server 3002. In an embodiment, changes to the user data may be compressed into binary patches based on the metadata stored with the user data and standards based mechanisms to give better performance. Use of the binary patches may provide a better performance than a performance provided by just a compression technique, both in terms of CPU and network bandwidth.

With the virtual file system layering technology, when data is created, the storage of the data depends on the type of data. Data may be stored on one of three different disks system disk, user disk, or local disk. In an embodiment, since only the user data needs to be synchronized, only data in the VHD user disk stack may be sent to the server 3002 on a regular basis for the synchronization. This may also reduce the amount of data to be sent. Further, in an embodiment, use of the metadata may further reduce the amount of user data needed for effective synchronizing. Accordingly, in an embodiment, three levels of data reduction may be included for synchronization of the user data. The three levels of data reduction may include separation of the user data on the user disk, compression of the user data and creation of the metadata of the changes made by the user.

In an embodiment, the synchronization of data may be done in the background on clients that may be currently running an instance of the user's virtual machine. The data synchronization may be done even when the user has logged off from the virtual machine or the user has moved away from the client machine. In the background, the changes made at a remote device may be pushed through the server 3002 to the user's desktop of the local virtual machine. The local virtual machine may run on the desktop or any other machine where the user has a copy of the virtual machine running.

In an embodiment, the changes made to the data may be pushed onto the VHD differencing disk which is a common ancestor of a disk chain running on the local client and a remote system. The changes pushed on to the VHD differencing disk may recreate the tree of VHD differencing disks maintained at the server 3002. Further, consistency in the virtual file system that appears on the remote system, as well as, on the local client may be achieved by performing reconciliation of changes at a file level. In an embodiment, the changes made at the remote client and the local client may be merged on a local copy of the virtual file system within a new VHD differencing disk that is pushed onto the top of the local file system at the local client.

In another embodiment, remote updates of changes made at different remote clients may be merged using a three-way merge. In an embodiment, the three-way merge may be based on the virtual file system in the common ancestor of both the local client and the remote clients, the virtual file system on the remote system at the time of the snapshot, and the current virtual file system on the local client.

In an embodiment, the three-way merge may be based on data that may include the virtual file system contents, and the metadata of the changes. As explained previously, the virtual file system may maintain the metadata about the files or the user data when changes are made and new files are created. The metadata may be used to more easily determine aspects of the VHD differencing disks, especially file deletion. It will be evident to a person that files that are present may be compared. However, when a file is not present in the common ancestor and one of the clients, it may be difficult to determine whether the user intended to delete the file.

In an embodiment of the invention, when there is no conflict between changes made on the local client and changes made on the remote client, changes may be made automatically to the virtual machine. In an embodiment, the deleted files may always be deleted to the recycle bin so they may be recovered if necessary.

In an embodiment, conflicts in different virtual machines may be handled by saving a remote client version of a file and providing a user interface to enable the user to perform manual merging of the changes in the file. Such a scenario may not occur often since the data belongs to a single person. The merging done by this mechanism is at the file level and the conflict handling mechanism may not make an attempt to merge contents of the file.

In an embodiment, a user interface for conflict resolution may allow the user to open conflicting files, such as text files, using a standard application associated with the file type, such as a text editing application. Further, the user interface may enable the user to manually merge the contents of the files or indicate a version of the file that may be retained. If the user decided to retain a version of the file on the local client (that is a local version), which is the default action, then the version of the file on the remote client (that is a remote version) may be deleted and sent to the recycle bin. Conversely, if the remote version is chosen, the local version may be deleted to the recycle bin and the remote version may be copied to the local file system on the local virtual machine.

An existing solution for accessing virtual machines from multiple locations includes ‘virtual desktop’ software that allows the user using a client to view the screen of another client. Another existing solution includes allowing the user to connect to a server through the Internet. The server may be connected to the user's remote desktop through the Internet and may allow the user to see his remote desktop screen. Another solution is VDI implementation which runs the user's desktop on a server, so any client may be able to connect to the desktop running on the server from anywhere. In this case, all the processing is done on the server. The present invention enables the user to access his virtual machine from multiple locations through the server 3002.

In the virtual machine of the present invention, processing is done on the current physical client that the user works on; for example, a desktop. In an embodiment of the invention, means to connect to the desktop may be provided using a VDI session via the server 3002. Existing solutions, such as log-me-in, operate in a similar manner but do not rely on the server 3002.

In embodiments, multiple users may log into a particular client at different times. The virtual file system may allow hot switching from one user to another on a particular client. The user may have one or more virtual machines and may select one of the one or more virtual machines at any time. The virtual file system may allow multiple users to run the same virtual machine; for example, the same system disk. Each user may get an individual customized version of that common system disk by tracking just the changes that personalize the machine for each user and by making the changes accessible to the virtual operating system through a user log-in process. In an embodiment, the VHD differencing technology may be used to allow and track the personalized changes for each user.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

The invention claimed is:

1. A method for updating an operating system of a client computer, the method comprising:
installing a computer operating system into a new base layer that is suitable for use as a base layer in a layered virtual file system and storing the new base layer in a memory accessible to a data management server;
transmitting the new base layer from the data management server to a client computer to be stored in a memory accessible to the client computer; and
directing an instance of the layered virtual file system that is resident on the client computer to use the new base layer.

2. The method of claim 1, wherein directing includes logically positioning the new base layer above an existing base layer of the instance of the layered virtual file system.

3. The method of claim 1, wherein directing includes replacing references to an existing base layer in the layered virtual file system with references to the new base layer.

4. The method of claim 1, wherein transmitting includes transmitting an instance of the layered virtual file system from the server to the client.

5. The method of claim 1, further including creating a check point associated with the instance of the layered virtual file system that facilitates restoring an existing base layer.

6. A method for deploying a virtualized operating system for use by a plurality of users, the method comprising:
providing a base layer of a layered virtual file system that facilitates access to an operating system;
storing the base layer in a memory accessible to a central data management server;
receiving a request to provide a virtualized workspace on any one of a plurality of client computing facilities;
deploying the base layer from the server to the one of the plurality of client computing facilities for use as a bottom most layer in a layered virtual file system that comprises a plurality of virtual layers in the virtualized workspace; and
providing a merged view of the plurality of layers in the virtualized workspace for accessing the operating system in the deployed base layer.

7. A method of managing changes to operating system data in an instance of a virtual workspace, the method comprising:
providing a layered virtual file system comprising a plurality of virtual layers that include at least one of a base layer and a user layer, wherein the base layer is configured as the bottom most layer of the plurality of virtual layers;
providing each of the plurality of virtual layers with its own file system hierarchy, wherein the file system hierarchy of the plurality of virtual layers are transparently overlaid such that a file system hierarchy in the user layer is configured above the base layer and has priority;
configuring the operating system and associated data in the file system hierarchy of the base layer; and
recording changes to operating system data in the file system hierarchy of the user layer, wherein the changed operating system data is visible in a merged view of the user layer and base layer file system hierarchies even though the base layer file system hierarchy data is unchanged.
